(19) United States
(12) Patent Application Publication
(10) Pub. No.: US 2006/0212541 A1
(43) Pub. Date: Sep. 21, 2006

(54) Data delivering system, data acquisition device, writing device, data acquisition program, data acquisition method, recordable medium, data delivering device and content delivering system

(75) Inventors: Hiromu Ueshima, Shiga (JP); Katsuya Nakagawa, Shiga (JP)

Correspondence Address: OSHA LIANG L.L.P., 1221 MCKINNEY STREET, SUITE 2800, HOUSTON, TX, 77010, US

(73) Assignee: SSD Company Limited, Shiga (JP)

(21) Appl. No.: 10/552,154

(22) PCT Filed: Jul. 2, 2004
(86) PCT No.: PCT/JP04/09763

§ 371 Date: Oct. 11, 2005

(30) Foreign Application Priority Data
Jul. 4, 2003 (JP) 2003-270850

(51) Int. Cl. G06F 15/16

(52) U.S. Cl. 709/219

(57) ABSTRACT

A user terminal (5-N: FIG. 1) receives karaoke data from a Web server (1: FIG. 1). A writer (7-N: FIG. 1) writes the karaoke data as received by the user terminal (5-N) to a memory cartridge (13: FIG. 2). In this case, the writer (7-N) can only be written once in an area of the storage areas of the memory cartridge (13) in which data is not written yet. The system program is initially stored in the memory cartridge (13). Accordingly, a data delivery system can be realized with a high degree of security and with ease, but without resort to the prepaid system.

### TECHNICAL FIELD

The present invention relates to a data delivery system for delivering of data through a network and the related techniques thereof.

### BACKGROUND ART

Jpn. unexamined patent publication No. 2001-60286 discloses a prepaid recording medium. In this prepaid recording medium, a prepaid information storage area and a content data storage area are allocated.

The user pays the purchase price of content data to be downloaded from a delivery center when he wants to purchase a prepaid recording medium. The information about the prepaid amount of money is recorded in the prepaid information storage area.

On the other hand, the content data that the user downloaded is written to the content data storage area. However, the content data is written in the content data storage area only when the content price is confirmed to be no higher than the prepaid amount of money by comparing the information about the content price as transmitted from the delivery center with the prepaid amount of money as stored in the prepaid information storage area. Then, the balance of the prepaid amount after subtraction of the content price is recorded to the prepaid information storage area.

The transmission of a bank account or a credit card number to the content delivery center from the user is no longer required by making use of such a prepaid recording medium, and therefore it is possible to prevent the leak of these numbers.

An encryption key is contained in the information about the prepaid amount of money and the balance recorded in the prepaid information storage area in order to prevent the data from being tampered by the user, so that the information about the prepaid amount of money and the balance can be rewritten only when this encryption key matches the encryption key delivered from the delivery center.

However, while the encryption key can be leaked, a sufficient security may not be provided for content providers maintaining delivery centers. In other words, when the encryption key is leaked, there is the possibility that the balance of the prepaid amount is rewritten on the prepaid recording medium to enable content data to be stored in the prepaid recording medium without authorization, resulting in substantial economic losses to the content providers. This problem is attributable to the adoption of the prepaid system. In general, the prepaid system is a system in which users are responsible for prepaying all charges for purchasing goods and/or using service while the remainder of the prepaid money is reduced when purchasing a good and/or using service.

### DISCLOSURE OF INVENTION

Thus, it is an object of the present invention to provide a data delivery system and the related techniques thereof with a high degree of security and with ease, but without resort to the prepaid system.

In accordance with a first embodiment of the present invention, data delivery system comprises: a server that delivers data through a network; a client terminal that receives said data as delivered; and a writer unit that writes said data received by said client terminal to a recordable medium, wherein said writer unit that writes data in an area of the storage areas of said recordable medium, in which data is not written, under a once only restriction.

By this configuration, since the transmission of a bank account or a credit card number is no longer required for downloading data, even those feeling insecure about the transmission of such information can make use of the data delivery service without anxiety. Furthermore, since no charge is incurred when delivering data, even those who do not have a bank account or a credit card number (for example, minors and children) can make use of the data delivery service. As described above, it is possible to deliver data to more people and therefore acquire a broad range of customers.

Also, since the prepaid system is not employed, the recordable medium contains no prepaid information and therefore user's fraud can be prevented as much as possible.

Furthermore, since no charge is incurred when delivering data, the process of accounting and charging can be omitted in the server. Accordingly, while the load on the server can be lessened, it is easy to implement security measures.

Furthermore, since no charge is incurred when delivering data, the user does not have to transmit a bank account or a credit card number. Accordingly, it is possible to prevent such important information from leaking and unauthorized use.

Still further, as compared with online charging, the user is requested to input little information and can acquire desired data from the server by a simple procedure.

Still further, since no charge is incurred when delivering data, it is possible to reduce the frequency of exchanging signals between the server and the client terminal, dispense with a complicated communication procedure, and therefore deliver data by a simple procedure.

Still further, the writer unit performs once only writing in an area of the storage areas of the recordable medium in which data is not written yet. In other words, it is impossible to rewrite other data to the recordable medium. Accordingly, the user has to purchase another one of the recordable medium anew when there is no free space in the recordable medium. Since no charge is incurred when delivering data, it is expected that the user downloads desired data one after another and that the sales volume of the recordable medium increases. Accordingly, the manufacturer or seller of the recordable medium can benefit from growing sales.

In the above data delivery system, said writer unit writes data in the area of the storage areas of said recordable medium in which data is not written yet in units of a predetermined size under the once only restriction.

By this configuration, since data is written to the recordable medium in units of a predetermined size, it becomes easy to manage the data as delivered and written to the recordable medium and to perform the process of reading the data as written.

In the above data delivery system, said client terminal transmits predetermined information to said server when the write operation to said recordable medium is successfully completed.

By this configuration, the service provider can confirm through the server that the data as delivered is completely written without error. For example, in the case where the data as delivered is music data, picture data and the like subject to copyright, by notifying the server of the normal completion of writing data, it is possible to enable the service provider to appropriately calculate copyright fees payable to the copyright holders.

In the above data delivery system, said server transmits said data to said client terminal when information about said recordable medium indicates a free space having a size larger than that of said data as requested for delivery.

By this configuration, since when the information about said recordable medium indicates the free space is smaller than that of said data as requested for delivery said data is not transmitted to the client terminal, the purchased amount of the recordable medium furthermore increases to bring strong sales to the manufacturer or seller of the recordable medium.

In the above data delivery system, said client terminal erases said data which is temporarily saved for writing when the write operation to said recordable medium is successfully completed.

By this configuration, since the data is erased from the client terminal after completing the writing of data to the recordable medium without error, it is possible to appropriately calculate copyright fees payable to the copyright holders for example in the case where the data as delivered is music data, picture data and the like subject to copyright. On the other hand, if data were left in the client terminal, the treatment of the copyright thereof would become uncertain, and therefore it would be difficult to calculate appropriate copyright fees.

In the above data delivery system, said client terminal transmits identification information of said recordable medium to said server.

By this configuration, it is possible to take an appropriate action when a falsified memory cartridge is used.

In the above data delivery system, said client terminal transmits user information to said server.

By this configuration, the service provider can acquire various information of the user through the server and reflect the information in the way of providing services.

In the above data delivery system, said client terminal displays information about the data already written to said recordable medium and the maximum size of data which can be written to the free space of said recordable medium.

By this configuration, it is possible to substantially lower the possibility of such a disadvantage of the user that the same data is redundantly written in separate areas of the recordable medium resulting in the decrease in the free space of the recordable medium. In addition to this, since the user is informed of the current state of the recordable medium, it is possible to improve convenience when selecting data to be downloaded.

In the above data delivery system, said client terminal displays a message that the data which is about to be written to said memory cartridge matches data which has already been written to said memory cartridge when such a match occurs.

By this configuration, since the user is directly informed that he is about to redundantly write the same data as already written, it is possible to provide a more user-friendly service.

In the above data delivery system, said client terminal and said writer unit are separately provided and connected to each other by a wired or wireless link.

By this configuration, in the case where a widespread type terminal can be used as the client terminal, a person possessing such a widespread type terminal can enjoy the data delivery service from the server only by purchasing the writer unit without need for purchasing both the client terminal and the writer unit. Also, in the case where a widespread type terminal can be used as the client terminal, a person who does not possess a terminal connectable to the writer unit can enjoy the data delivery service only by purchasing the writer unit and making use of such a widespread type terminal of somebody connectable to the writer unit as the client terminal.

In the data delivery system as described in the previous paragraph, said client terminal displays a first predetermined indication when said writer unit is not connected to said client terminal and a second predetermined indication when said recordable medium is not connected to said writer unit.

By this configuration, the user can be given appropriate attention to enable smooth delivery of data.

In the data delivery system as described in the previous paragraph, when said writer unit is not connected to said client terminal said client terminal transmits to said server information that said writer unit is not connected, and when said recordable medium is not connected to said writer unit said client terminal transmits to said server information that said recordable medium is not connected.

By this configuration, the server can be informed of the situation that the writer unit is not connected and that the recordable medium is not inserted, and take an appropriate procedure to deal therewith. For example, the server can be configured not to deliver data in such a situation.

In the above data delivery system, said writer unit is implemented within a microphone type karaoke device.

By this configuration, it is possible to write data to the recordable medium by the microphone type karaoke device and then enjoy karaoke by reading the data by the same microphone type karaoke device. As discussed above, the convenience of the user is improved since writing and using data can be done by the same device.

In the above data delivery system, said client terminal and said writer unit are integrally provided.

By this configuration, the connecting work of the client terminal with the writer unit can be dispensed with to improve the convenience of the user. In addition, the writer unit can be prevented from being lost or stolen.

In the data delivery system as described in the previous paragraph, when said recordable medium is not connected to said writer unit said client terminal displays a predetermined indication.

By this configuration, the user can be given appropriate attention to enable smooth delivery of data.

In the data delivery system as described in the previous paragraph, when said recordable medium is not connected to said writer unit said client terminal transmits to said server information that said recordable medium is not connected.

By this configuration, the server can be informed of the situation that the recordable medium is not inserted, and therefore can take an appropriate procedure to deal therewith. For example, the server can be configured not to deliver data in such a situation.

In the above data delivery system, said data requested by said client terminal to said server is music data.

By this configuration, the user can use the delivery service of data with ease and security by selecting his favorite music pieces from among various types of music. In other words, while users tend to like to get only favorite music pieces, their desire can be satisfied. Incidentally, if the recordable medium were provided with a plurality of music pieces stored in advance, it would be unlikely that all the music pieces as stored would meet user's preferences. In this case, the satisfaction level of the user purchasing such a recordable medium would not always be high.

In the above data delivery system, said data requested by said client terminal to said server is music data, and said client terminal displays information about the music pieces already written to said recordable medium and the number of music pieces which can be written to the free space of said recordable medium.

By this configuration, it is possible to substantially lower the possibility of such a disadvantage of the user that the same music piece is redundantly written in separate areas of the recordable medium resulting in the decrease in the free space of the recordable medium. In addition to this, since the user is informed of the writable number of additional music pieces which can be further written to the recordable medium, it is possible to improve convenience when selecting music pieces to be downloaded.

In the above data delivery system, said data requested by said client terminal to said server is music data and image data of karaoke.

By this configuration, the user can use the delivery service of karaoke data with ease and security by selecting his favorite music pieces from among various types of music. In other words, while users tend to like to get only favorite music pieces, their desire can be satisfied. Incidentally, if the recordable medium were provided with a plurality of music pieces stored in advance, it would be unlikely that all the music pieces as stored would meet user's preferences. In this case, the satisfaction level of the user purchasing such a recordable medium would not always be high.

In the above data delivery system, said data requested by said client terminal to said server is game data.

By this configuration, the user can use the data delivery service with ease and security by selecting his favorite game from among a variety of games (game programs, game image data, game music data and the like). In other words, while users tend to like to get only favorite games, their desire can be satisfied. Incidentally, if the recordable medium were provided with a plurality of games stored in advance, it would be unlikely that all the games as stored would meet user's preferences. In this case, the satisfaction level of the user purchasing such a recordable medium would not always be high.

In the above data delivery system, said recordable medium is a recordable medium to which data can only be written once in an area in which no data is written yet.

In the above data delivery system, data for use in processing the data that is delivered and written to said recordable medium is initially written to said recordable medium.

By this configuration, since predetermined data (data for use in processing the data that is delivered and written to said recordable medium) is written in advance, it is possible to perform the process making use of the recordable medium only by writing data as delivered to the recordable medium.

In accordance with a second aspect of the present invention, a data acquisition device comprises: a client terminal that receives data delivered by a server through a network; a writer unit that writes said data received by said client terminal to a recordable medium, wherein said writer unit that writes data in an area of the storage areas of said recordable medium, in which data is not written, under a once only restriction. In the second aspect of the present invention, there are the same advantages as in the first aspect of the present invention.

In accordance with a third aspect of the present invention, a writing device that writes data delivered by a server through a network to a recordable medium, said writing device comprising: a receptacle device that receives said recordable medium; and a writer unit that writes data in an area of the storage areas of said recordable medium in which data is not written under a once only restriction. In the third aspect of the present invention, there are the same advantages as in the first aspect of the present invention.

In accordance with a fourth aspect of the present invention, data acquisition program which makes a computer perform processing comprises: a step of receiving data delivered by a server through a network; and a step of writing said data as received to a recordable medium, wherein, in said writing step, writing data by said computer is possible under a once only restriction in an area of the storage areas of said recordable medium in which data is not written yet. In the fourth aspect of the present invention, there are the same advantages as in the first aspect of the present invention.

In accordance with a fifth aspect of the present invention, a data acquisition method comprises: a step of receiving data delivered by a server through a network; and a step of writing said data as received to a recordable medium, wherein said writing step is performed under a once only restriction in an area of the storage areas of said recordable medium in which data is not written yet. In the fifth aspect of the present invention, there are the same advantages as in the first aspect of the present invention.

In accordance with a sixth aspect of the present invention, a recordable medium to which data delivered by a server through a network is written by the writing device according to the third aspect, wherein the storage space of said recordable medium is divided into a predetermined number of storage areas, and wherein writing data is possible under a once only restriction in a free area from among said predetermined number of storage areas. In the sixth aspect of the present invention, there are the same advantages as in the first aspect of the present invention.

In accordance with a seventh aspect of the present invention, a server that delivers data to be written to the recordable medium through a network, wherein said data is delivered in units of a predetermined storage area of said recordable medium.

By this configuration, since data is written to the recordable medium in units of a predetermined size, it becomes easy to manage the data as delivered and written to the recordable medium and to perform the process of reading the data as written.

In accordance with an eighth aspect of the present invention, a karaoke data delivery system comprises: a memory cartridge having a first proprietary interface for accessing data contained therein; a karaoke playback system which is distributed to a user who wants to play karaoke and provided with a second proprietary interface compatible with and connectable to said first proprietary interface of said memory cartridge for reading karaoke data therefrom and playing back the karaoke data; a karaoke data server connected to the Internet and providing a karaoke data delivery service on the Internet; and a writer unit having a data communication facility for downloading karaoke data from said karaoke data server through the Internet, provided with a third proprietary interface compatible with and connectable to said first proprietary interface, and configured to write the karaoke data to said memory cartridge.

By this configuration, the copyright issues relating to the network delivery of karaoke data can be cleared by making effective use of a proprietary interface.

In accordance with a ninth aspect of the present invention, a content delivery system comprises: a memory cartridge having a first proprietary interface for accessing data contained therein; a content using system which is distributed to a user of said content and provided with a second proprietary interface compatible with and connectable to said first proprietary interface of said memory cartridge for reading content therefrom and using the content; a content server connected to the Internet and providing a content delivery service on the Internet; and a writer having a data communication facility for downloading content from said content server through the Internet, provided with a third proprietary interface compatible with and connectable to said first proprietary interface, and configured to write the content to said memory cartridge.

By this configuration, the copyright issues relating to the network delivery of content can be cleared by making effective use of a proprietary interface.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a schematic diagram showing the overall configuration of the karaoke data delivery system in accordance with an embodiment 1 of the present invention;

FIG. 2 is a view showing an example of the user terminal and an example of the writer of FIG. 1;

FIG. 3 is a view showing an example of the writing service terminal of FIG. 1;

FIG. 4 is an illustrative view for explaining the initial memory map of the OTPROM of FIG. 2 in advance of usage;

FIG. 5 is an illustrative view for explaining the memory map of the OTPROM as shown in FIG. 2 after writing music data;

FIG. 6 is a view showing an example of the electric configuration of the client terminal and the writer which are shown in FIG. 1;

FIG. 7 is a view showing an example of showing the electric configuration of the writing service terminal shown in FIG. 1;

FIG. 8 is a schematic diagram showing the general outline of the communication procedure of the user terminal with the writer and the Web server shown in FIG. 1;

FIG. 9 is a schematic diagram showing the general outline of the communication procedure between the writing service terminal and the Web server shown in FIG. 1;

FIG. 10 is a view for explaining the attachment and detachment mechanism of the memory cartridge to/from the writer shown in FIG. 2;

FIG. 11 is a view for explaining the mechanism of detaching the memory cartridge from the writer of FIG. 10;

FIG. 12 is a flowchart showing the process flow of downloading the writer program from the Web server to the user terminal shown in FIG. 1;

FIG. 13 is a flowchart showing the process flow in which the user terminal shown in FIG. 1 sets up the writer program as received from the Web server;

FIG. 14 is a view showing an example of the web page displayed on the display device of the user terminal shown in FIG. 2;

FIG. 15 is a view showing an example of the screen for searching the singer's names for a desired music piece;

FIG. 16 is a view showing an example of the screen for searching the music titles for the desired music title;

FIG. 17 is a flowchart showing the process flow of downloading and writing karaoke data by the user terminal shown in FIG. 1;

FIG. 18 is a flowchart showing the process flow when it is determined that a title selection button is pressed in step S51 of FIG. 17,

FIG. 19 is a flowchart showing the process flow when it is determined that the write button is pressed in step S52 of FIG. 17;

FIG. 20 is a flowchart showing the process flow when it is determined that the writable number of additional music pieces is “0” in step S94 of FIG. 19;

FIG. 21 is a flowchart showing the process flow when it is determined that the write operation is erroneously performed in step S100 of FIG. 19;

FIG. 22 is a flowchart showing the process flow when it is determined that a link button is pressed in step S54 of FIG. 17;

FIG. 23 is a flowchart showing the flow of the writer/cartridge check process in step S42 of FIG. 17;

FIG. 24 is a flowchart showing the process flow when it is determined that the writer is not connected to the user terminal in step S182 of FIG. 23;

FIG. 25 is a flowchart showing the process flow when it is determined that a title selection button is pressed in step S197 of FIG. 24;

FIG. 26 is a flowchart showing the process flow when it is determined that a link button is pressed in step S199 of FIG. 24;

FIG. 27 is a flowchart showing the process flow when it is determined that the memory cartridge is not inserted to the writer in step S184 of FIG. 23;

FIG. 28 is a flowchart showing the process flow when it is determined that the memory cartridge is inserted into step S221 of FIG. 27;

FIG. 29 is a flowchart showing the process flow when it is determined that a title selection button is pressed in step S223 of FIG. 27;

FIG. 30 is a flowchart showing the process flow when it is determined that a link button is pressed in step S225 of FIG. 27;

FIG. 31 is a flowchart showing the process flow of downloading and writing karaoke data by the writing service terminal of FIG. 1;

FIG. 32 is a flowchart showing the process flow of the cartridge check process in step S542 of FIG. 31;

FIG. 33(a) is a front view showing an example of a microphone type karaoke device in accordance with the present embodiment; FIG. 33(b) is a rear view showing an example of a microphone type karaoke device as shown in FIG. 33(a);

FIG. 34 is a view showing the electric configuration of the microphone type karaoke device of FIG. 33;

FIG. 35 is a schematic representation of a program and data stored in the ROM of FIG. 34;

FIG. 36 is an illustrative view for explaining the memory map of the OTPROM 17 in accordance with an embodiment 2;

FIG. 37 is a view showing an example of the status table of FIG. 36;

FIG. 38 is an illustrative view for explaining the state of OTPROM of FIG. 2 after writing in accordance with the embodiment 2;

FIG. 39 is a flowchart showing the general outline of the process by the user terminal 5-N in accordance with the embodiment 2 of the present invention;

FIG. 40 is a view showing an example of the entry screen of the ID of the writer in accordance with the embodiment 2;

FIG. 41 is a view showing an example of the check process indicating screen of the memory cartridge 13 in accordance with the embodiment 2;

FIG. 42 is a view showing an example of the web page for downloading karaoke data in accordance with the embodiment 2;

FIG. 43 is a view showing an example of the search top page 332 in accordance with the embodiment 2;

FIG. 44 is a view showing an example of the music title search page 344 in accordance with the embodiment 2;

FIG. 45 is a view showing an example of the download page 356 in accordance with the embodiment 2;

FIG. 46 is a view showing an example of the write process indicating screen in accordance with the embodiment 2;

FIG. 47 is a view showing an example of the artist name search page 355 in accordance with the embodiment 2;

FIG. 48 is a flowchart showing part of the process by the user terminal 5-N (the process of checking the writer 7-N) in accordance with the embodiment 2 of the present invention;

FIG. 49 is a flowchart showing the first half of the cartridge check process by the user terminal 5-N in accordance with the embodiment 2;

FIG. 50 is a flowchart showing the latter half of the cartridge check process by the user terminal 5-N in accordance with the embodiment 2;

FIG. 51 is a flowchart showing the process flow of displaying an error message in step S728 of FIG. 49;

FIG. 52 is a flowchart showing the process flow of the retry writing process in step S744 of FIG. 50;

FIG. 53 is a flowchart showing the process flow of the error handling of step S771 of FIG. 52;

FIG. 54 is a flowchart showing the process flow of the write control process by the user terminal 5-N in accordance with the embodiment 2;

FIG. 55 is a flowchart showing the process flow after a selection button is pressed in step S903 of FIG. 54;

FIG. 56 is a flowchart showing the process flow after the “YES” button (download button) is pressed in step S904 of FIG. 54;

FIG. 57 is a flowchart showing the process flow of the karaoke data check process of step S928 of FIG. 56;

FIG. 58 is a flowchart showing an example of the karaoke data writing process of step S929 of FIG. 56;

FIG. 59 is a flowchart showing the process flow after it is determined that the write operation is erroneously performed in step S1031 of FIG. 58;

FIG. 60 is a flowchart showing the process flow after it is determined that the write operation is erroneously performed in step S1033 of FIG. 58;

FIG. 61 is a flowchart showing the process flow of writing data in an unused area in step S979 of FIG. 60;

FIG. 62 is a flowchart showing the process flow after it is determined that the write operation is erroneously performed in step S994 of FIG. 61;

FIG. 63 is a flowchart showing the process flow after a link button is pressed in step S906 of FIG. 54;

FIG. 64 is a flowchart showing the process flow after it is determined that the read operation is erroneously performed in step S922 of FIG. 56.

### BEST MODE FOR CARRYING OUT THE INVENTION

In what follows, several embodiments of the present invention will be explained in conjunction with the accompanying drawings. Meanwhile, like references indicate the same or functionally similar elements throughout the respective drawings, and therefore redundant explanation is not repeated.

### Embodiment 1

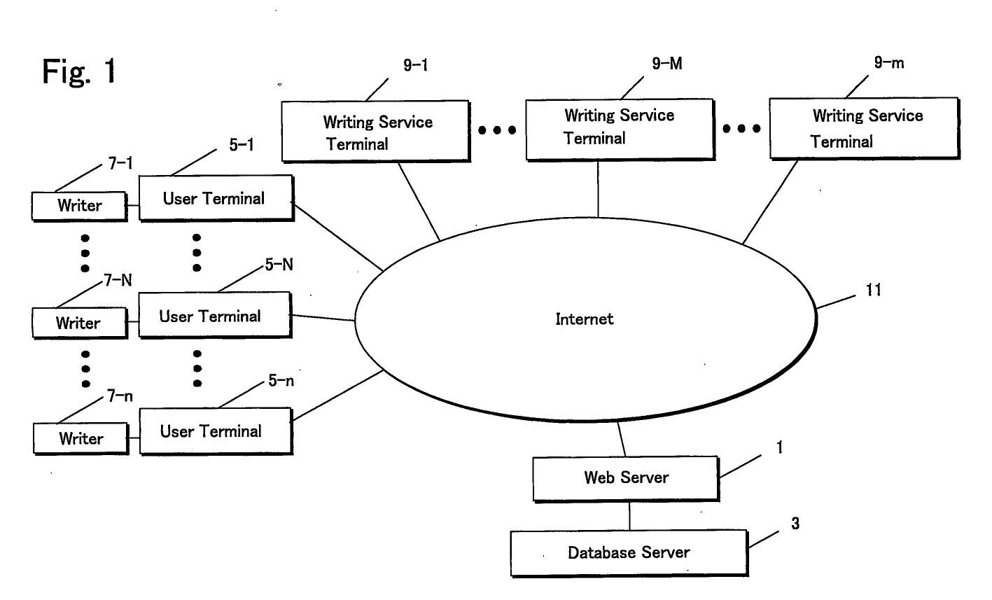

FIG. 1 is a schematic diagram showing the overall configuration of the karaoke data delivery system in accordance with the embodiment 1 of the present invention. As shown in FIG. 1, this karaoke data delivery system includes a Web server 1, a database server 3, user terminals 5-1 to 5-n (n is a natural number), writers 7-1 to 7-n, and writing service terminals 9-1 to 9-m. In the following description, the term “user terminal 5-N” is used to generally represent the user terminals 5-1 to 5-n. Also, the term “writing service terminal 9-M” is used to generally represent the writing service terminals 9-1 to 9-m. Furthermore, the term “client terminal” is generic to the user terminal 5-N and the writing service terminal 9-M. Still further, the term “writer 7-N” is used to generally represent the writers 7-1 to 7-n.

The Web server 1, the user terminal 5-N and the writing service terminal 9-M are connected to the Internet 11. The writer 7-N is connected to the user terminal 5-N corresponding thereto. The database server 3 is connected to the Web server 1.

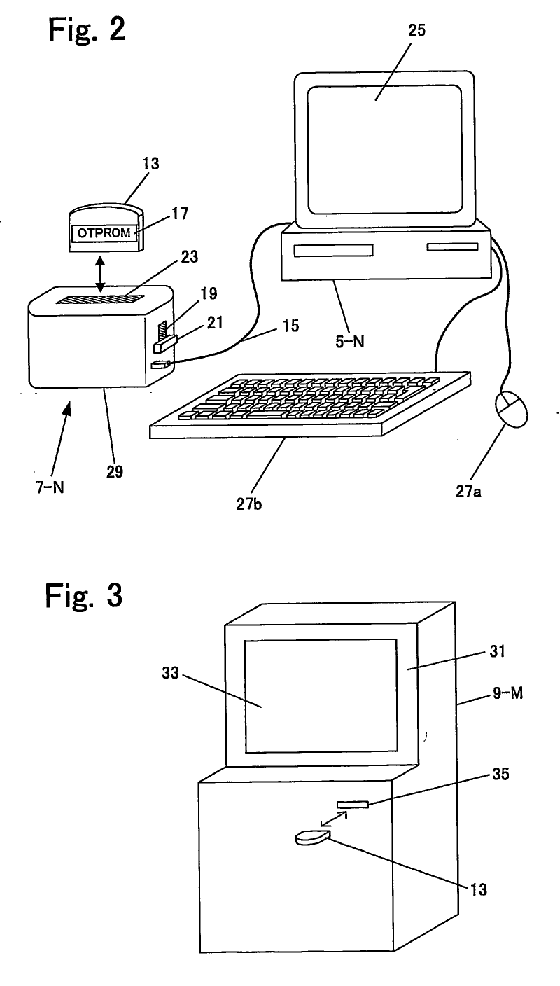

FIG. 2 is a view showing an example of the user terminal 5-N and an example of the writer 7-N of FIG. 1. As shown in FIG. 2, the user terminal 5-N includes a display device 25, a mouse 27a and a keyboard 27b.

The writer 7-N is provided with an insertion slot 23 in the upper surface of a housing 29 for inserting a memory cartridge 13. Furthermore, a guide slot 19 is formed in the side surface of the housing 29 in order to allow the vertical motion of a manipulation tab 21.

The memory cartridge 13 contains an OTPROM (one time programmable read only memory) 17. The OTPROM 17 is a ROM that can only be written once. However, it is possible to write the same data to the same area. The OTPROM will be briefly explained here. In an unused OTPROM, “1” (high level) data is written over the entire storage areas. Namely, this is the initial state of the OTPROM. While it is possible (in a write operation) to invert a “1” (high level) to a “0” (low level), the “0” cannot be inverted to a “1” (in a rewrite operation). Accordingly, it is possible to write the same data to the same area.

The user terminal 5-N and the writer 7-N are connected by a cable 15. This cable 15 is, for example, a USB (universal serial bus) cable. Also, the memory cartridge 13 can be attached to the writer 7-N by inserting the memory cartridge 13 through the insertion slot 23. By this insertion, the manipulation tab 21 is moved upwardly along the guide slot 19. On the other hand, the memory cartridge 13 as inserted can be detached by pressing down the manipulation tab 21.

FIG. 3 is a view showing an example of the writing service terminal 9-M of FIG. 1. As shown in FIG. 3, the writing service terminal 9-M includes a display device 31, a touch panel 33 and a connector 35 for accepting the memory cartridge 13. In FIG. 3, a touchscreen is formed by attaching the touch panel 33 to the screen of the display device 31.

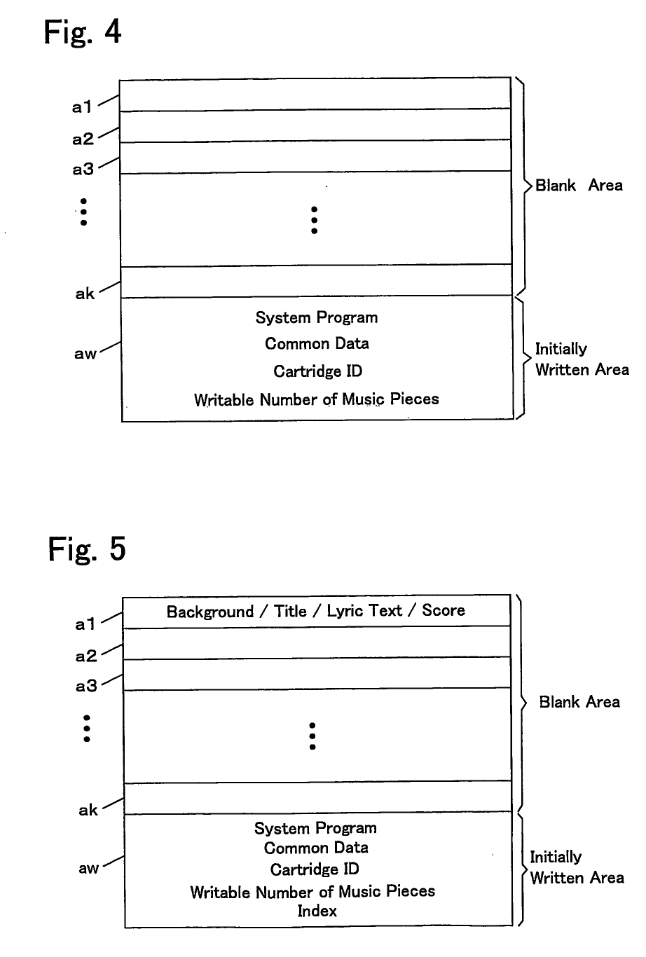

FIG. 4 is an illustrative view for explaining the initial memory map of the OTPROM 17 of FIG. 2 in advance of usage. As shown in FIG. 4, the OTPROM 17 includes blank areas a1 to ak (k is a natural number) and an initially written area aw in advance of usage. In the following description, the term “blank area aK” is used to generally represent the blank areas a1 to ak. The blank area aK is an area in which no data is written yet before the user purchases the OTPROM 17 (before shipment from a factory).

Usually, one music piece of karaoke data is written in one blank area aK. However, it is possible to write one music piece of karaoke data over a predetermined number of the blank areas ak. For example, in the case where one music piece of karaoke data has a size exceeding the blank area ak, the data has to be written over a plurality of the blank areas ak. Alternatively, even in the case where one music piece of karaoke data has a size up to the the blank area ak, two or more blank areas ak may be consumed (for example, by providing a field in the index information to indicate the use of each blank area ak and setting the field entries corresponding to the consumed blank areas ak, or making use of state flags as explained in conjunction with the embodiment 2 to be described below), if the value of the music piece is twice or more times that of a usual music piece. Karaoke data is written in units of the blank area ak in this manner. In addition, because of the use of the OTPROM 17, karaoke data is written only in unused blank area(s) ak. That is, once karaoke data is written in a blank area aK, the same blank area aK cannot be used again for writing karaoke data. In other words, it is possible to write data only once.

In the initially written area aw, a system program, common data, the identification information (ID) of the memory cartridge 13, and the number of music pieces which can be written thereto are already written before the user purchases the OTPROM 17 (before shipment). The system program is a program for system initialization, sequential control, image display control, A/D conversion, voice processing, music playback control and the like. The common data contains image data which is commonly used irrespective of the kind of music, music data which is commonly used irrespective of the kind of music, and the like.

FIG. 5 is an illustrative view for explaining the memory map of the OTPROM 17 as shown in FIG. 2 after writing music data. In the case of the example shown in FIG. 5, karaoke data is written in the blank area a1. This karaoke data contains background image data, title image data, lyric text data, and score data.

When karaoke data are written in the blank area aK, index information is written in the free space of the initially written area aw. The index information includes the information indicating, for each blank area aK, whether or not the area is used, the information about the storage location of background image data, the information about the storage location of title image data, the information about the storage location of lyric text data, the information about the storage location of score data and the like.

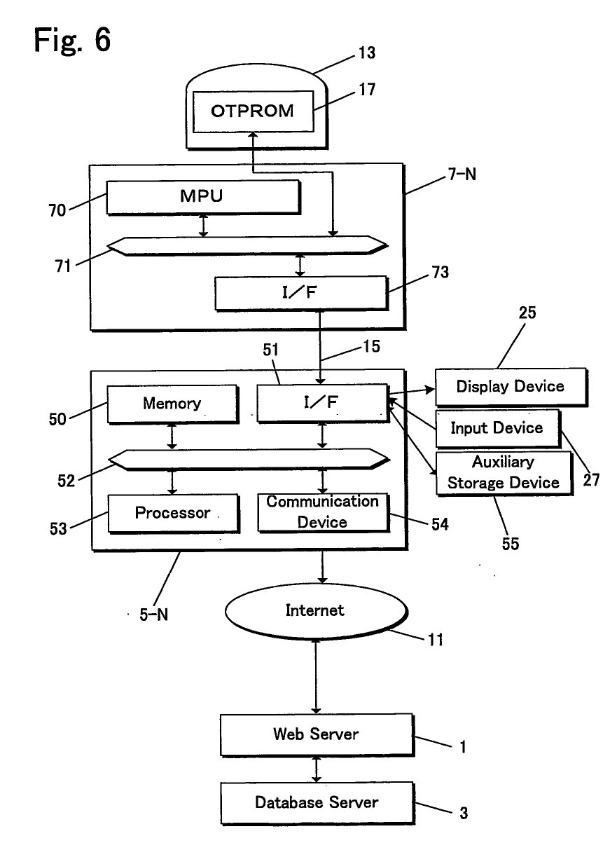

FIG. 6 is a view showing an example of the electric configuration of the client terminal 5-N and the writer 7-N which are shown in FIG. 1. As shown in FIG. 6, the client terminal 5-N includes a processor 53, a memory 50, a bus 52, a communication device 54, an auxiliary storage device 55, an interface (I/F) 51, a display device 25 and an input device 27.

For example, the auxiliary storage device 55 is a hard disk drive or the like. On the other hand, the input device 27 is the keyboard 27b and the mouse 27a shown in FIG. 2. However, the input device 27 is not limited thereto. Another example of the input device 27 includes a track ball, a light pen, a joystick, a touch panel, a tablet or the like which can be employed for the same purpose.

The writer 7-N includes an MPU (microprocessing unit) 70, a bus 71, and an interface (I/F) 73. In the case where a USB cable is used as the cable 15, for example, the interface 73 and the interface 51 include a USB controller respectively.

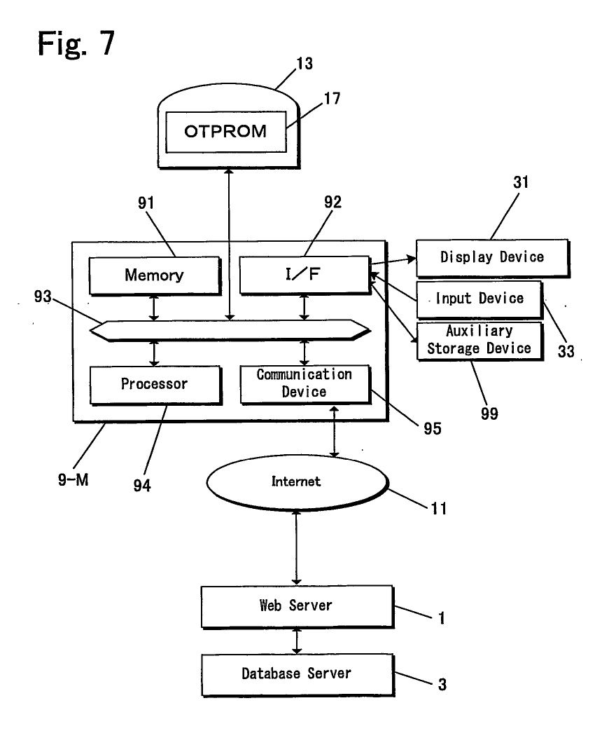

FIG. 7 is a view showing an example of showing the electric configuration of the writing service terminal 9-M shown in FIG. 1. As shown in FIG. 7, the writing service terminal 9-M includes a processor 94, a bus 93, a memory 91, a communication device 95, an interface (I/F) 92, a display device 31, an input device 33 and an auxiliary storage device 99. Incidentally, the auxiliary storage device 99 is for example a hard disk drive or the like. Furthermore, the input device 33 is the touch panel 33 in the case of the example of FIG. 3. However, the input device 33 is not limited to this example in the same manner as the input device 27.

Next, the general outline of the process of the karaoke data delivery system in accordance with the present embodiment will be explained.

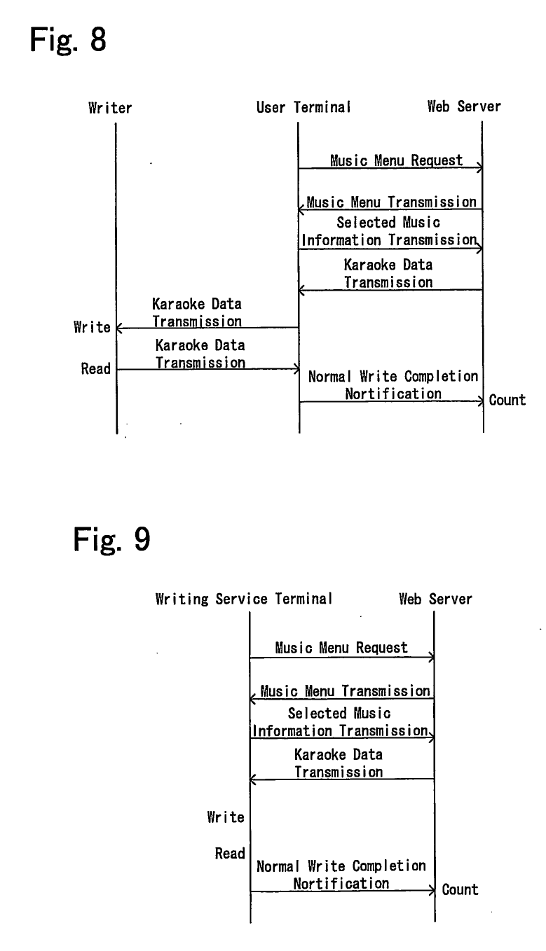

FIG. 8 is a schematic diagram showing the general outline of the communication procedure of the user terminal 5-N with the writer 7-N and the Web server 1 shown in FIG. 1.

In response to the input from the user through the input device 27, the processor 53 of the user terminal 5-N sends a request for the transmission of a music title menu to the Web server 1 through the communication device 54 and the Internet 11.

After receiving this transmission request, the Web server 1 transmits the music title menu to the user terminal 5-N through the Internet 11.

When the user selects a music piece through the input device 27, the processor 53 of the user terminal 5-N transmits the information about the music piece as selected (selected music information) to the Web server 1 through the communication device 54 and the Internet 11.

The WEB server 1 acquires from the database server 3 the karaoke data corresponding to the selected music information as transmitted from the user terminal 5-N, and transmits the karaoke data to the user terminal 5-N through the Internet 11.

The processor 53 of the user terminal 5-N temporarily stores the karaoke data as received in the auxiliary storage device 55. Then, the processor 53 transfers the karaoke data from the auxiliary storage device 55 to the memory 50, and transmits the karaoke data to the writer 7-N through the bus 52, the interface 51, and the cable 15.

The MPU 70 of the writer 7-N transfers the karaoke data, as transmitted by the processor 53 of the user terminal 5-N, to the inner memory (not shown in the figure) of the MPU 70 through the interface 73 and the bus 71 and writes the karaoke data to the OTPROM 17 connected to the bus 71.

Furthermore, the MPU 70 of the writer 7-N reads the karaoke data as written from the OTPROM 17, and transmits the karaoke data as read to the user terminal 5-N through the bus 71, the interface 73 and the cable 15.

The processor 53 of the user terminal 5-N stores the karaoke data, which is read and transmitted by the MPU 70 of the writer 7-N, in the auxiliary storage device 55. Then, the processor 53 verifies the write operation to the OTPROM 17 by comparing the karaoke data transmitted by the Web server 1 with the karaoke data transmitted by the writer 7-N.

When it is confirmed that the write operation has been finished without error, the processor 53 of the user terminal 5-N sends, to the Web server 1 through the communication device 54 and the Internet 11, notification (successful write operation notification) that the karaoke data is written to the OTPROM 17 without error.

The Web server 1 receives the successful write operation notification from the user terminal 5-N. In response to the successful write operation notification as received, the Web server 1 counts, for each of the respective music pieces, the number of times the karaoke data has been successfully written to the OTPROM 17. The copyright fee payable by the service provider can be calculated on the basis of this count value.

FIG. 9 is a schematic diagram showing the general outline of the communication procedure between the writing service terminal 9-M and the Web server 1 shown in FIG. 1. At first, after receiving the input of the user through the input device 33, the processor 94 of the writing service terminal 9-M sends a request for the transmission of a music title menu through the communication device 95 and the Internet 11.

After receiving this transmission request, the Web server 1 transmits the music title menu to the writing service terminal 9-M through the Internet 11.

When the user selects a music piece through the input device 33, the processor 94 of the writing service terminal 9-M transmits the information about the music piece as selected (selected music information) to the Web server 1 through the communication device 95 and the Internet 11.

The WEB server 1 acquires from the database server 3 the karaoke data corresponding to the selected music information as transmitted from the writing service terminal 9-M, and transmits the karaoke data to the writing service terminal 9-M through the Internet 11.

The processor 94 of the writing service terminal 9-M temporarily stores the karaoke data as received in the auxiliary storage device 99. Then, the processor 94 transfers the karaoke data from the auxiliary storage device 99 to the memory 91, and transmits the karaoke data to the OTPROM 17 connected to the bus 93.

Furthermore, the processor 94 reads the karaoke data as written from the OTPROM 17, transmits the karaoke data as read to the auxiliary storage device 99. Then, the processor 94 verifies the write operation to the OTPROM 17 by comparing the karaoke data transmitted by the Web server 1 with the karaoke data transmitted from the OTPROM 17.

When it is confirmed that the write operation has been finished without error, the processor 94 sends, to the Web server 1 through the communication device 95 and the Internet 11, notification (successful write operation notification) that the karaoke data is written to the OTPROM 17 without error.

The Web server 1 receives the successful write operation notification from the writing service terminal 9-M. In response to the successful write operation notification as received, the Web server 1 counts, for each of the respective music pieces, the number of times the karaoke data has been successfully written to the OTPROM 17. The copyright fee payable by the service provider can be calculated on the basis of this count value.

Incidentally, in the case of the present embodiment as discussed with reference to FIGS. 8 and 9, the OTPROM 17 is an exemplary recordable medium that can only be written once. Since this type of the recordable medium is used, once data is written to an area, no data can be written to the same area again. Thus, the user can write only the number of music pieces (the karaoke data) corresponding to the number of the blank areas ak of the OTPROM 17. For example, if the number of the blank areas ak is 8, only 8 music pieces of the karaoke data can be written. In this particular example, if the user writes 8 music pieces of the karaoke data, it is necessary to purchase another one of the memory cartridge 13 anew since the current memory cartridge 13 is no longer used for writing.

While the recordable medium itself in which data can be written only one time is used to establish the once only restriction on the recordable medium as has been discussed above, the technique is not limited to this. Even if the recordable medium (i.e., the memory device contained in the memory cartridge 13) itself is rewritable, it is possible to establish the once only restriction on the memory cartridge 13 by means of a particular writing restriction mechanism (hardware, software or a combination thereof).

The implementation of the once only restriction will be explained in more detail hereinbelow. The OTPROM used in this embodiment is, for example, a UV-EPROM with no quartz glass window in the package for erasing the contents. This memory device can be erased with X-rays in principle for rewriting. However, it is impossible to erase the OTPROM at least by user-level operations. The term “once only restriction” is defined here to generally represent the function to inhibit rewriting data at least by user-level operations.

More specifically, the following implementations are also possible. A cheaper semiconductor chip of a mass-marketed flash memory module is put into a proprietary package which is not compatible with the standard package of the mass-marketed flash memory module to provide a proprietary interface. In a simple implementation, the proprietary package is designed by functionally swapping terminals, changing the design of terminals, or the like, as compared with the compatible package. In this case, the writer 7-N is also designed by functionally swapping terminals, changing the design of terminals, and so forth, as compared with the compatible writer of the mass-marketed flash memory module. Accordingly, a commercially available memory chip of the mass-marketed flash memory module and a commercially available memory controller chip can be used and therefore it is possible to implement the system with ease at a low cost.

A higher security level can be implemented by making use of a mass-marketed flash memory and slightly modifying the protocol of the interface controller thereof. The interface controller of the writer 7-N is modified in the same manner as the interface controller of the flash memory. Accordingly, while the chip of the flash memory and the interface controller of the writer 7-N are manufactured specific in order not to allow user level rewriting, the packages and other parts thereof can be mass-marketed products broadly distributed for the flash memory.

Alternatively, in the case of a commercial flash memory which doesn't have an on-board controller, a proprietary file system can be implemented within the flash memory only by designing the controller of the writer 7-N for the proprietary file system. In this case, the memory cartridge 13 can be manufactured only by formatting a cheaper product of the commercial flash memory in accordance with the proprietary file system for used in the system of the present invention. Needless to say, the conventional writers for the commercial flash memory which doesn't have an on-board controller cannot access the proprietary file system.

Next, the attachment and detachment mechanism of the memory cartridge 13 to/from the writer 7-N will be explained.

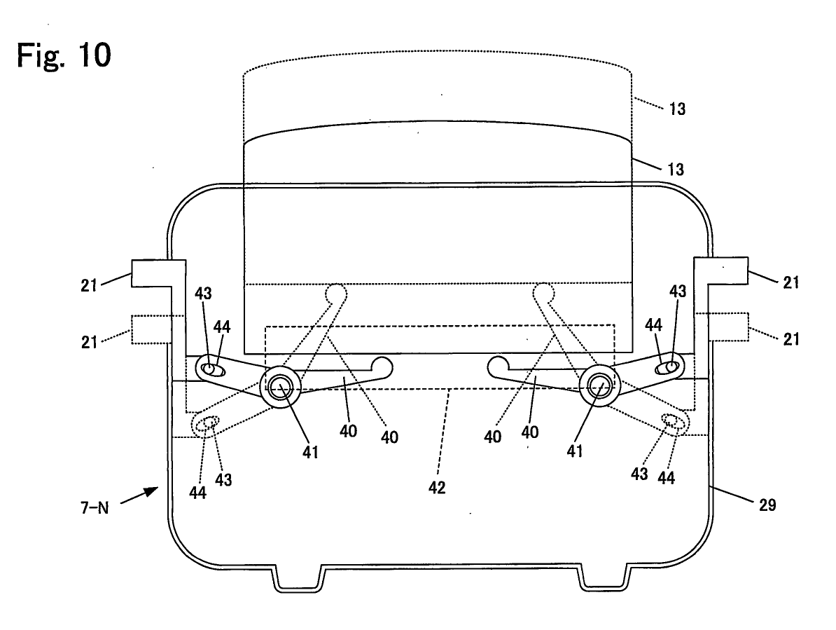

FIG. 10 is a view for explaining the attachment and detachment mechanism of the memory cartridge 13 to/from the writer 7-N shown in FIG. 2. As shown in FIG. 10, one hook-shaped portion of the manipulation tab 21 is projected from the side surface of the housing 29. Also, inside the housing 29, the other hook-shaped portion of the manipulation tab 21 is formed with a convex portion 43, which is inserted into an elongated hole 44 formed at the rear end of a push-out member 40. Furthermore, an axis 41 is formed in the inner surface of the housing 29 to rotatably support the push-out member 40. The manipulation tab 21, the push-out member 40 and the axis 41 are provided in pairs symmetrically in the opposite sides of the housing 29 as illustrated in FIG. 10. When the user depresses the manipulation tab 21, the rear end of the push-out member 40 is depressed by the convex portion 43 thereof. As a result, the push-out member 40 rotates with the axis 41 as a fulcrum to upwardly flip the tip of the push-out member 40.

As shown in FIG. 2, the manipulation tab 21 is located at the lower end of the guide slot 19 in advance of inserting the memory cartridge 13. When the user inserts the memory cartridge 13 in the housing 29 through the insertion slot 23 formed in the upper surface of the housing 29, the tip of the push-out member 40 is then depressed while the memory cartridge 13 is connected to a connector 42 which is provided inside the housing 29.

On the other hand, with the memory cartridge 13 being inserted, the manipulation tab 21 is located at the upper end of the guide slot 19. Accordingly, if the user depresses the manipulation tab 21, the tip of the push-out member 40 is flipped up by the mechanism as discussed above. By this configuration, the memory cartridge 13 is then detached from the connector 42 and flipped up.

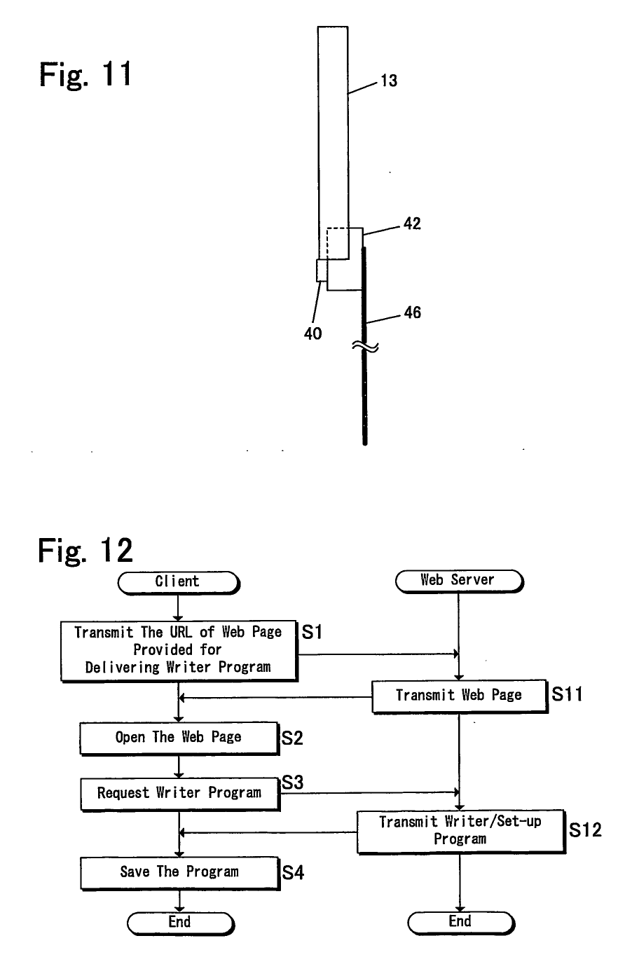

FIG. 11 is a view for explaining the mechanism of detaching the memory cartridge 13 from the writer 7-N of FIG. 10. FIG. 11 is a view partially showing the inner part of the writer 7-N as seen from the side surface. As shown in FIG. 11, the tip of the push-out member 40 comes in contact with the lower end of the memory cartridge 13 connected to the connector 42. Then, it is possible to push up the memory cartridge 13. Meanwhile, the connector 42 is connected to a circuit board 46. The MPU 70, the bus 71 and the interface 73 shown in FIG. 6 are implemented on this circuit board 46.

In the case of the karaoke data delivery system according to the present embodiment, the client terminal (the user terminal 5-N or the writing service terminal 9-M) has to obtain a writer program from the Web server 1. This point will be explained with reference to a flowchart, FIG. 6 and FIG. 7.

FIG. 12 is a flowchart showing the process flow of downloading the writer program from the Web server 1 to the user terminal 5-N shown in FIG. 1. As shown in FIG. 12, in step S1, the processor 53 of the user terminal 5-N invokes a browser program stored in the auxiliary storage device 55. Namely, the browser program is run by the processor 53 of the user terminal 5-N to launch a browser. Then, the user terminal 5-N (the browser) accepts the input from the user through the input device 27, and transmits the URL (uniform resource locator) of a web page provided for delivering the writer program to the Web server 1 through the communication device 54 and the Internet 11.

In step S11, the WEB server 1 transmits, to the user terminal 5-N, the web page data as requested by the user terminal 5-N.

In step S2, the user terminal 5-N (the browser) displays the web page from which the writer program can be obtained on the display device 25 by parsing the web page data transmitted by the Web server 1. In step S3, after receiving the input from the user through the input device 27, the user terminal 5-N (the browser) sends a transmission request for the writer program to the Web server 1.

In step S12, the WEB server 1 transmits, to the user terminal 5-N, the writer program as requested by the user terminal 5-N together with the set-up program thereof.

In step S4, the processor 53 of the user terminal 5-N stores the writer program and the set-up program thereof as received in the auxiliary storage device 55.

Incidentally, the process flow of downloading the writer program from the Web server 1 to the writing service terminal 9-M is similar to the process flow of downloading the writer program from the Web server 1 to the user terminal 5-N. In this case, the processor 94 of the writing service terminal 9-M invokes the browser program stored in the auxiliary storage device 99. Then, the browser program is run by the processor 94 of the writing service terminal 9-M to launch a browser. Also, the processor 94 stores the writer program and the writer program thereof as obtained from the Web server 1 in the auxiliary storage device 99.

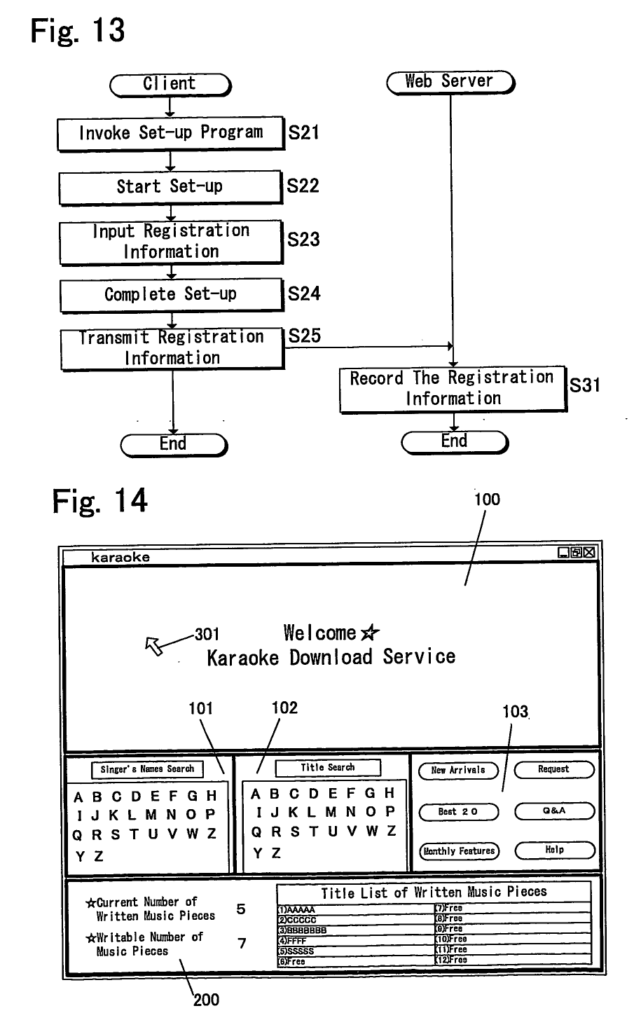

FIG. 13 is a flowchart showing the process flow in which the user terminal 5-N shown in FIG. 1 sets up the writer program as received from the Web server 1.

As shown in FIG. 13, in step S21, the processor 53 of the user terminal 5-N invokes the set-up program of the writer program. In this case, the browser program is run by the processor 53 of the user terminal 5-N to provide a set-up mechanism.

In step S22, the user terminal 5-N (the set-up mechanism) initiates the set-up process. In step S23, the user terminal 5-N (the set-up mechanism) displays an input screen of registration information on the display device 25.

After receiving registration information from the user through the input device 27, the user terminal 5-N (the set-up mechanism) continues the set-up process. Incidentally, the registration information includes the identification information (ID) of the writer 7-N, the name, email address, telephone number, residence, sex of the user, and so forth.

When the writer program is completely set up in step S24, the user terminal 5-N (the set-up mechanism) displays this fact on the display device 25. In step S25, the user terminal 5-N (the set-up mechanism) transmits the registration information as input by the user to the Web server 1.

In step S31, the WEB server 1 saves the registration information as transmitted by the user terminal 5-N.

Incidentally, the process flow of setting up the writer program by the writing service terminal 9-M is similar to the process flow of setting up the writer program by the user terminal 5-N. In this case, the processor 94 of the writing service terminal 9-M invokes the set-up program stored in the auxiliary storage device 99. Then, the browser program is run by the processor 94 of the writing service terminal 9-M to provide a set-up mechanism.

Relating now to FIG. 6, the processor 53 of the user terminal 5-N invokes the writer program (refer to FIG. 13) stored in the auxiliary storage device 55 to form a writer control mechanism. Also, the processor 53 invokes the browser program stored in the auxiliary storage device 55 to launch the browser. Incidentally, the writer control mechanism and the browser can operate independent from each other (in parallel) by multitask.

Next, the method of acquiring karaoke data in the karaoke data delivery system in accordance with the present embodiment will be explained with reference to screen views.

FIG. 14 is a view showing an example of the web page displayed on the display device 25 of the user terminal 5-N shown in FIG. 2. As shown in FIG. 14, the web page for downloading karaoke data is displayed on the display device 25 by the browser. More specifically speaking, this web page is composed of frames 100 to 103. The frame 101 is provided for searching the names of singers for a desired music piece. The frame 102 is provided for searching music titles for a desired music piece. The frame 103 is provided for displaying link buttons.

On the other hand, the frame 200 is displayed on the display device 25 by the writer control mechanism. The information displayed in this frame 200 contains the number of music pieces which have been written in the memory cartridge 13, the music titles thereof which have been written in the memory cartridge 13, and the number of music pieces which can be further written to the memory cartridge 13.

When the user selects the first character of the desired singer's name by the input device 27 from the frame 101 which is provide for searching for a singer's name, the list of the singer's names having the first character as their initial is displayed.

FIG. 15 is a view showing an example of the screen for searching the singer's names for a desired music piece. When the first character of a singer's name is selected in the frame 101 which is provide for searching for a singer's name as shown in FIG. 14, the screen shown in FIG. 15 is displayed on the display device 25. More specifically speaking, as shown in FIG. 15, the frames 101, 102, 104, 105 and 106 are displayed on the display device 25 by the browser. In the frame 104, the list of the singer's names having the character selected in the screen of FIG. 14 as the initial.

Then, when the user selects a desired singer's name from among the singer's names displayed in the frame 104 by the input device 27, the browser displays the music pieces of the singer as selected in the frame 105.

Furthermore, when the user selects a desired music title from among the music titles displayed in the frame 105 by the input device 27 and repeating the selection if desired, the writer control mechanism displays the music title(s) as selected in the frame 201. Still further, when the user presses a write button displayed in the frame 106 by the input device 27, the karaoke data corresponding to the music piece(s) as selected is written to the OTPROM 17 of the memory cartridge 13. The writer control mechanism then sequentially displays the music title of the karaoke data whose write operation is completed in the frame 202. Also, the writer control mechanism updates the content of the frame 200.

On the other hand, when the user selects the first character of a desired music title by the input device 27 from the frame 102 of FIG. 14 which is provide for searching music titles, the list of the music titles having the first character as their initial is displayed.

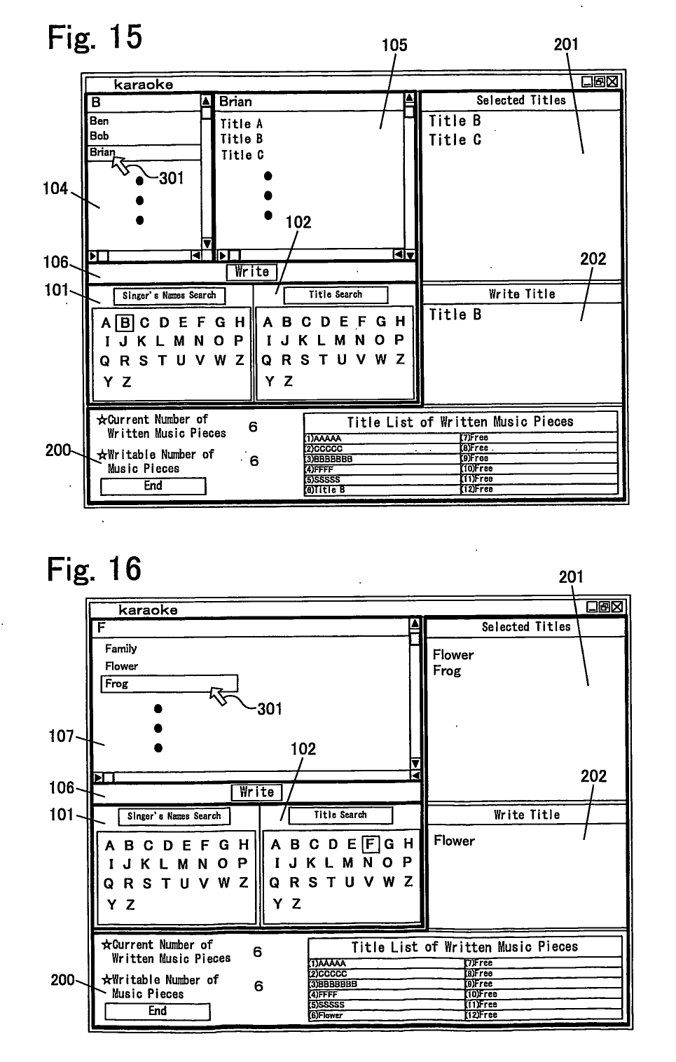

FIG. 16 is a view showing an example of the screen for searching the music titles for the desired music title. When the first character of a music title is selected in the frame 102 which is provide for searching music titles as shown in FIG. 14, the screen shown in FIG. 16 is displayed on the display device 25. More specifically speaking, as illustrated in FIG. 16, the browser displays the frames 101, 102, 106 and 107 on the display device 25. In the frame 107, the list of the music titles having the character selected in the screen of FIG. 14 as the initial.

Then, when the user selects a desired music title from among the music titles displayed in the frame 107 by the input device 27, the writer control mechanism displays the music title(s) as selected in the frame 201. Still further, when the user presses a write button displayed in the frame 106 by the input device 27, the karaoke data corresponding to the music piece as selected is written to the OTPROM 17 of the memory cartridge 13. The writer control mechanism then sequentially displays the music title of the karaoke data whose write operation is completed in the frame 202. Also, the writer control mechanism updates the content of the frame 200.

In this case, the selection of an item and the pressing of the button are performed by moving the cursor 301 of the mouse 27a to the desired position and clicking the mouse 27a. For example, the selection of a music title is performed by moving the cursor 301 to the screen position where the desired music title is displayed and clicking the mouse 27a. In this case, the screen positions where music titles is displayed functions as title selection buttons.

Meanwhile, the similar screens are displayed in the display device 31 of the writing service terminal 9-M as in FIG. 14 to FIG. 16, and therefore it is possible to write karaoke data to the memory cartridge 13 connected to the connector 35 in the same manner as has been discussed above.

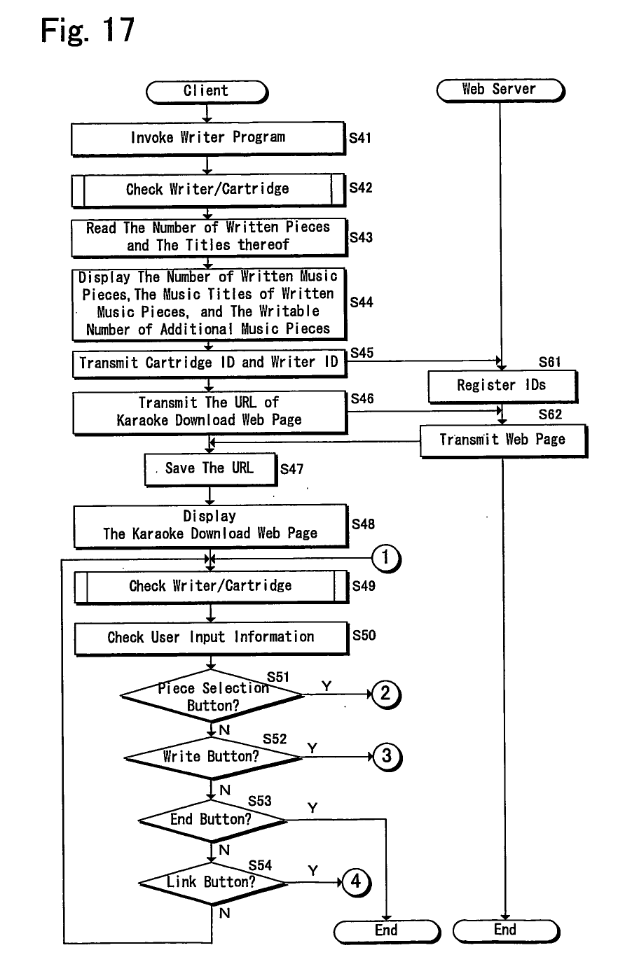

FIG. 17 is a flowchart showing the process flow of downloading and writing karaoke data by the user terminal 5-N shown in FIG. 1. As shown in FIG. 17, the processor 53 of the user terminal 5-N invokes the writer program in step S41. The writer control mechanism is formed by running the writer program by the processor 53. The writer control mechanism then invokes the browser program. The browser is launched by running the browser program by the processor 53. Namely, the user terminal 5-N functions as the browser and the writer control mechanism.

In step S42, the writer control mechanism checks whether or not the writer 7-N is connected to the client terminal 5-N. Also, the writer control mechanism checks whether or not the memory cartridge 13 is inserted into the writer 7-N. Then, if the writer 7-N is connected to the client terminal 5-N and the memory cartridge 13 is inserted into the writer 7-N, the writer control mechanism proceeds to step S43.

In step S43, the writer control mechanism accesses the OTPROM 17 of the memory cartridge 13 and acquires the information about the number of music pieces as already written and the information about the music titles of the written music pieces. In step S44, the writer control mechanism displays the number of the written music pieces, the music titles of the written music pieces, and the number of additional music pieces which can be further written on the display device 25. In step S45, the writer control mechanism transmits the identification information (ID) of the memory cartridge 13 and the identification information (ID) of the writer 7-N to the Web server 1.

In step S61, the WEB server 1 registers the identification information (ID) of the memory cartridge 13 and the identification information (ID) of the writer 7-N as transmitted by the writer control mechanism.

In step S46, the writer control mechanism transmits to the WEB server 1 the URL of a web page (having a write button) for downloading karaoke data.

In step S62, the WEB server 1 transmits the web page data to the user terminal 5-N.

In step S47, the writer control mechanism stores the URL as transmitted (in step S62) in the memory 50. In step S48, the browser parses the web page data received from the WEB server 1, and displays the web page (having a write button). In step S49, the writer control mechanism checks whether or not the writer 7-N is connected to the client terminal 5-N. Also, the writer control mechanism checks whether or not the memory cartridge 13 is inserted into the writer 7-N. Then, if the writer 7-N is connected to the client terminal 5-N and the memory cartridge 13 is inserted into the writer 7-N, the writer control mechanism proceeds to step S50. The process of this step S49 is similar to the process of the step S42.

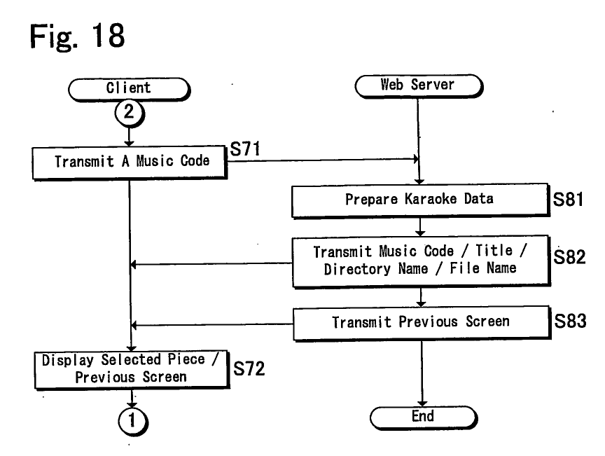

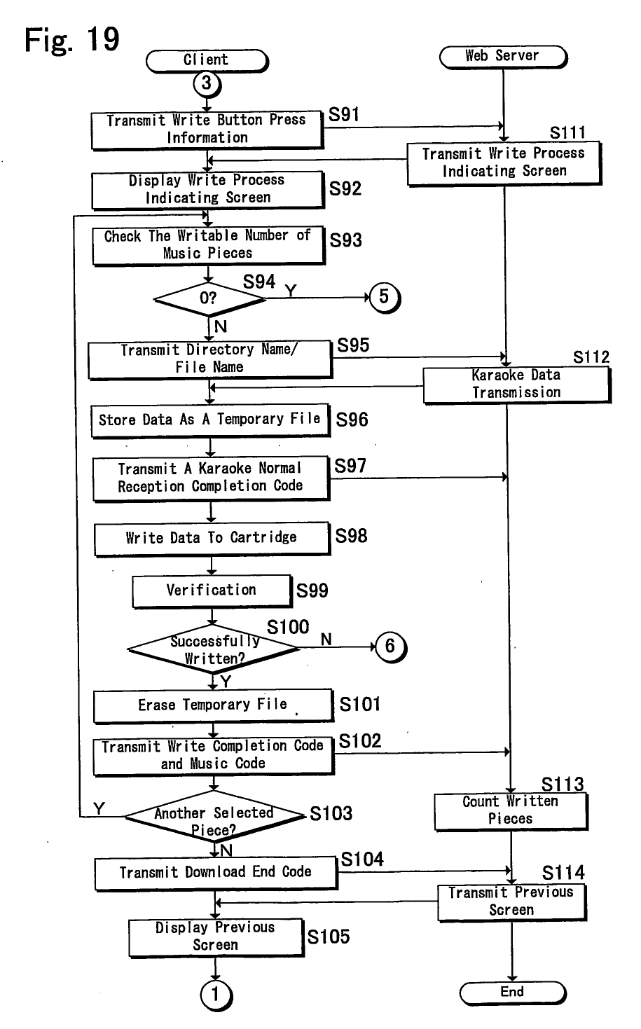

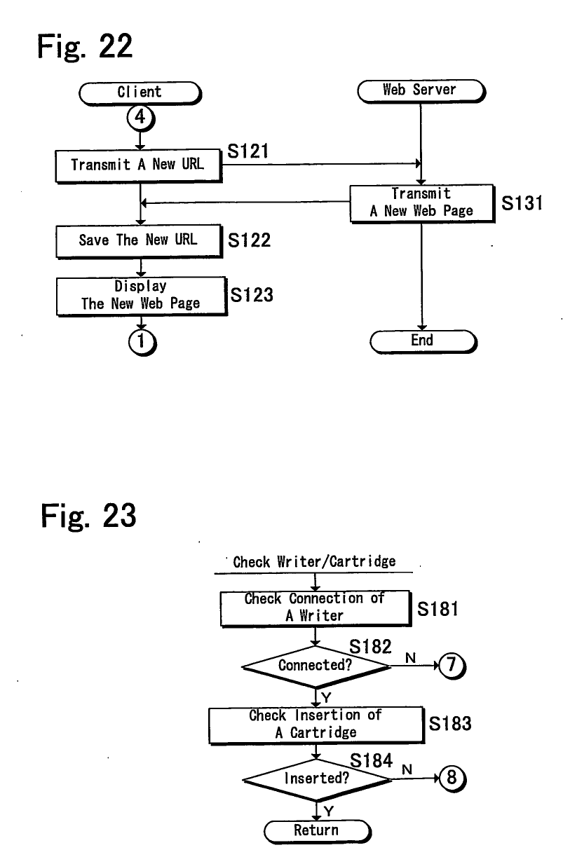

In step S50, the information as input by the user through the input device 27 is checked. As a result of the check in step S50, if it is determined (in step S51) that a title selection button in the screen is pressed by the user through the input device 27, the processing proceeds to the step S71 of FIG. 18; if it is determined (in step S52) that the write button in the screen is pressed by the user through the input device 27, the processing proceeds to the step S91 of FIG. 19; if it is determined (in step S53) that the exit button in the screen is pressed by the user through the input device 27, the processor 53 exits the writer program and the browser program; and if it is determined (in step S54) that a link button in the screen is pressed by the user through the input device 27, the processing proceeds to the step S121 of FIG. 22.

On the other hand, as a result of the check in step S50, if it is determined that no title selection button in the screen is pressed, that the write button in the screen is not pressed, that the exit button in the screen is not pressed, and that any link button in the screen is not pressed (in step S51, step S52, step S53 and step S54), then the processing proceeds to step S49.

FIG. 18 is a flowchart showing the process flow when it is determined that a title selection button is pressed in step S51 of FIG. 17. As shown in FIG. 18, the browser transmits the music code corresponding to the selected music piece to the WEB server 1 in step S71.

In step S81, the WEB server 1 acquires, from database server 3, the karaoke data corresponding to the music code which the browser transmitted. In step S82, the WEB server 1 transmits, to the user terminal 5-N, the music code which the browser transmitted, the information about the music title corresponding to the music code, the information about the name of the directory in which the karaoke data corresponding to the music code is stored, and the information about the file name of the karaoke data. In step S83, the WEB server 1 transmits, to the user terminal 5-N, the previous screen data (the screen data just before the user presses the title selection button).

In step S72, the writer control mechanism displays the music title of the music piece selected by the user on the display device 25. In addition, the browser displays the previous screen again. After step S72, the processing proceeds to step S49 of FIG. 17.

FIG. 19 is a flowchart showing the process flow when it is determined that the write button is pressed in step S52 of FIG. 17. As shown in FIG. 19, in step S91, the browser transmits the information indicating that the write button is pressed to the WEB server 1.

In step S111, the WEB server 1 transmits screen data indicating that the karaoke data is being written to the user terminal 5-N. By way of example, this screen data includes an instruction message to follow until the write operation is completed, and the like information.

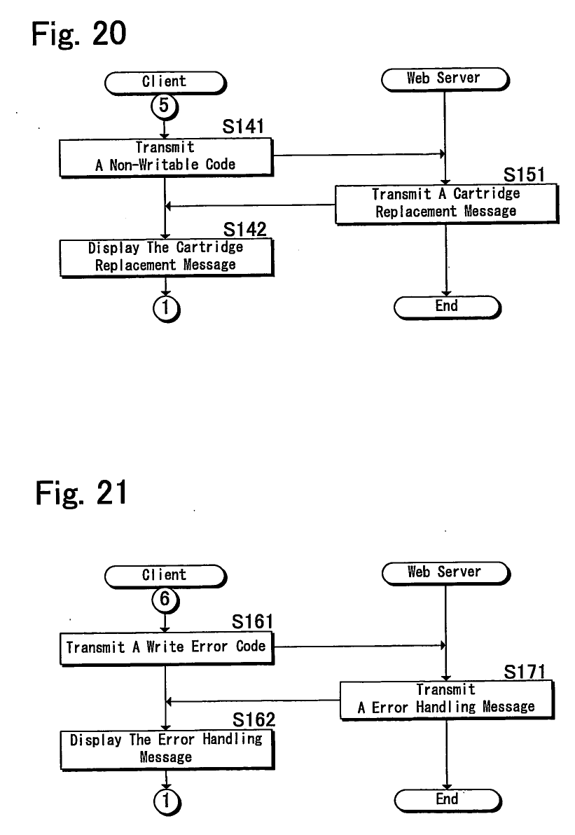

In step S92, the browser displays a screen indicating that the karaoke data is being written on the display device 25. In step S93, the writer control mechanism accesses the OTPROM 17, and acquires the information about the number of additional music pieces which can be further written thereto. As a result (in step S94), if the writable number of additional music pieces is “0” (i.e., there is no free space in the OTPROM 17) the processing proceeds to step S141 of FIG. 20, and if the writable number of music pieces is “1” or more (i.e., there is some free space in the OTPROM 17) the processing proceeds to step S95.

In step S95, the writer control mechanism transmits the information about the directory name and the information about the file name which are transmitted in step S82 to the WEB server 1.

In step S112, the WEB server 1 transmits karaoke data stored in association with that file name to the user terminal 5-N on the basis of the information about the directory name and the information about the file name which are transmitted by the writer control mechanism.

In step S96, the writer control mechanism stores the karaoke data as received to the auxiliary memory 55 as a temporary file. In step S97, the writer control mechanism transmits a normal reception completion code indicating that the karaoke data is received without error to the WEB server 1. In step S98, the writer control mechanism instructs the writer 9-N to write the karaoke data to the OTPROM 17.

In step S99, the writer control mechanism reads the karaoke data written to the OTPROM 17 and performs the verification thereof. As a result of the verification (in step S100), if it is confirmed that the write operation is completed without error, the processing proceeds to step S101, and if it is confirmed that the write operation is erroneously performed, the processing proceeds to step S161 of FIG. 21. In step S101, the writer control mechanism erases the karaoke data stored as a temporary file. In step S102, the writer control mechanism transmits a code indicating that the write operation is completed without error together with music code to the WEB server 1.

In step S113, the WEB server 1 increments a counter for counting up the number of the written music pieces.

In step S103, the writer control mechanism determines whether or not there is a further music title selected by the user. As a result of the determination, if there is a further music title as selected, the processing proceeds to step S93, and if there is no more music title as selected, the processing proceeds to step S104. In step S104, the writer control mechanism transmits a code indicating that the download of the karaoke data is completed to the WEB server 1.

In step S114, the WEB server 1 transmits the previous screen data (the screen data just before pressing the write button) to the user terminal 5-N.

In step S105, the browser displays the previous screen on the display device 25.

FIG. 20 is a flowchart showing the process flow when it is determined that the writable number of additional music pieces is “0” in step S94 of FIG. 19. As shown in FIG. 20, the writer control mechanism transmits a code indicating that it is not possible to write the karaoke data to the OTPROM 17 (i.e., a code indicating that the OTPROM 17 does not have a free space) to the WEB server 1 in step S141.

In step S151, the WEB server 1 transmits screen data displaying the indication prompting the replacement of the memory cartridge 13 to the user terminal 5-N. In step S142, the browser displays the indication prompting the replacement of the memory cartridge 13 on the display device 25. Then, the processing proceeds to step S49 of FIG. 17.

FIG. 21 is a flowchart showing the process flow when it is determined that the write operation is erroneously performed in step S100 of FIG. 19. As shown in FIG. 21, in step S161, the writer control mechanism transmits, to the Web server 1, the code indicating that the operation of writing karaoke data to the OTPROM 17 is erroneously performed.

In step S171, the WEB server 1 transmits screen data for displaying a way of dealing with the error to the user terminal 5-N. In step S162, the browser displays the way of dealing with the error on the display device 25. Then, the processing proceeds to step S49 of FIG. 17.

FIG. 22 is a flowchart showing the process flow when it is determined that a link button is pressed in step S54 of FIG. 17. As shown in FIG. 22, the browser transmits a new-URL corresponding to the link button as pressed to the WEB server 1 in step S121.

In step S131, the WEB server 1 transmits new web page data (there is a write button) corresponding to the new URL as received to the user terminal 5-N.

In step S122, the writer control mechanism stores the new URL to the memory 50. In step S123, the browser displays the new web page (there is a write button) on the display device 25. Then, the processing proceeds to step S49 of FIG. 17.

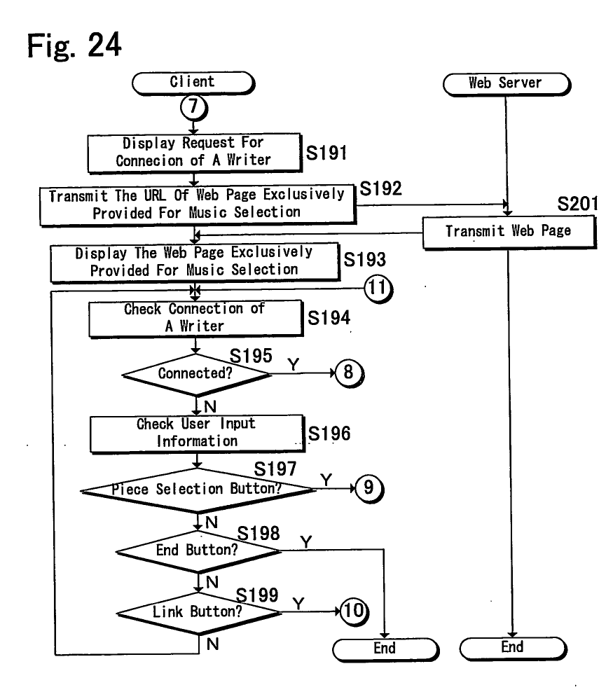

FIG. 23 is a flowchart showing the flow of the writer/cartridge check process in step S42 of FIG. 17. As shown in FIG. 23, the writer control mechanism checks whether or not the writer 7-N is connected to the client terminal 5-N in step S181. In step S182, if the writer 7-N is not connected to the client terminal 5-N, the processing proceeds to step S191 of FIG. 24, and if the writer 7-N is connected to the client terminal 5-N, the processing proceeds to step S183.

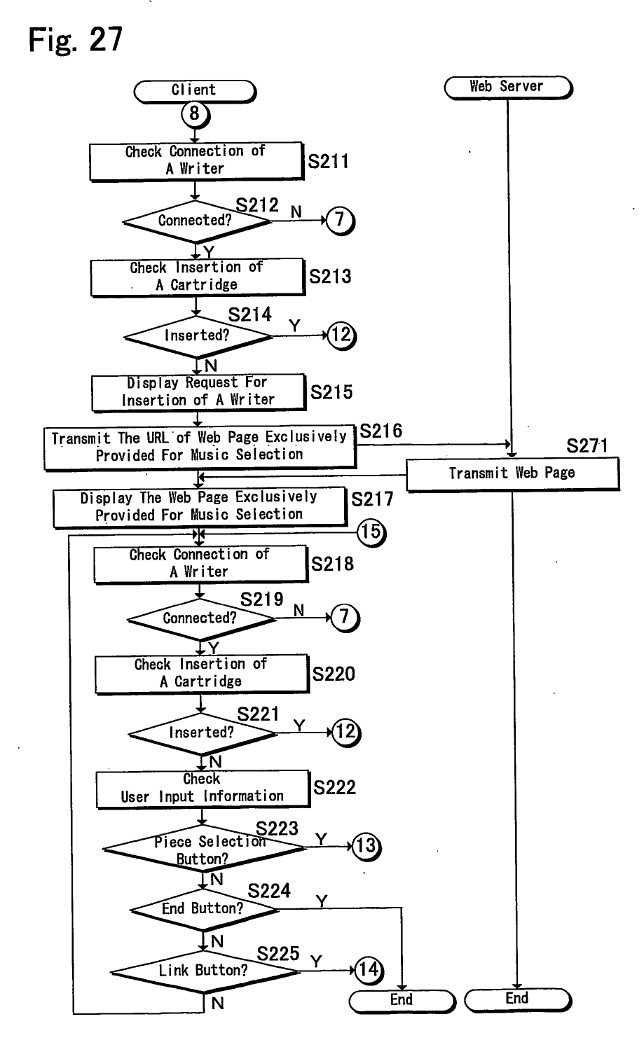

In step S183, the writer control mechanism checks whether or not the memory cartridge 13 is inserted to the writer 7-N. In step S184, if the memory cartridge 13 is not inserted to the writer 7-N, the processing proceeds to step S211 of FIG. 27, and if the memory cartridge 13 is inserted to the writer 7-N, the processing proceeds to step S43 of FIG. 17.

FIG. 24 is a flowchart showing the process flow when it is determined that the writer 7-N is not connected to the user terminal 5-N in step S182 of FIG. 23. As shown in FIG. 24, the writer control mechanism displays on the display device 25 an indication requesting for the writer 7-N to be connected in step S191. In step S192, the writer control mechanism transmits the URL of a web page (there is no write button) exclusively provided for selection of a music piece to the WEB server 1.

In step S201, the WEB server 1 transmits the web page data exclusively provided for selection of a music piece to the user terminal 5-N.

In step S193, the browser parses the web page data as transmitted by the WEB server 1, and displays on the display device 25 the web page (there is no write button) exclusively provided for selection of a music piece. In step S194, the writer control mechanism checks whether or not the writer 7-N is connected to the user terminal 5-N. As a result of the check, in step S195, if the writer 7-N is connected to the user terminal 5-N, the processing proceeds to step S211 of FIG. 27, and if the writer 7-N is not connected to the user terminal 5-N, the processing proceeds to step S196.

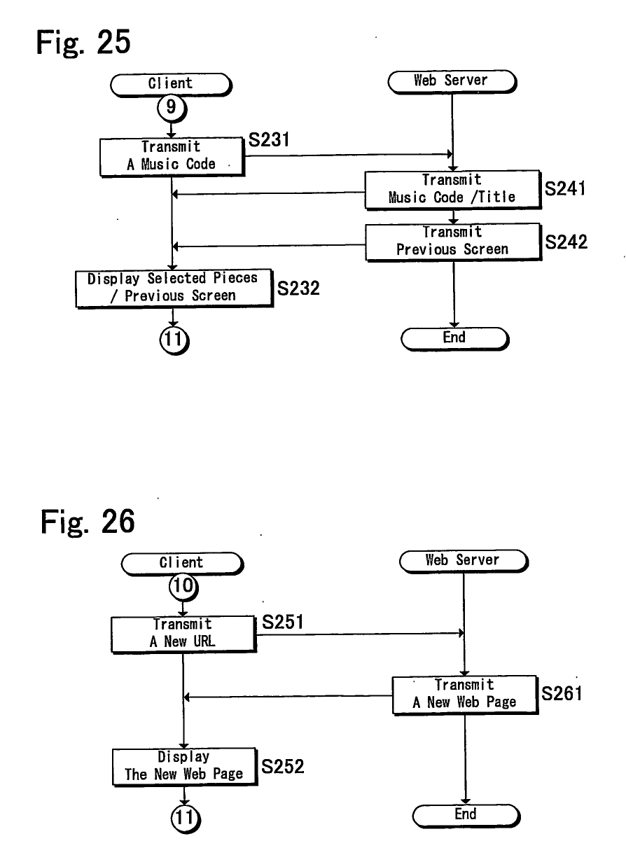

In step S196, the information as input by the user through the input device 27 is checked. As a result of the check in step S196, if it is determined (in step S197) that a title selection button in the screen is pressed by the user through the input device 27, the processing proceeds to the step S231 of FIG. 25; if it is determined (in step S198) that the exit button in the screen is pressed by the user through the input device 27, the processor 53 exits the writer program and the browser program; and if it is determined (in step S199) that a link button in the screen is pressed by the user through the input device 27, the processing proceeds to the step S251 of FIG. 26.

On the other hand, as a result of the check in step S196, if no title selection button in the screen is pressed, if the exit button is not pressed, and if a link button in the screen is not pressed (step S197, step S198 and step S199), then the process returns to step S194.

FIG. 25 is a flowchart showing the process flow when it is determined that a title selection button is pressed in step S197 of FIG. 24. As shown in FIG. 25, the browser transmits the music code corresponding to the selected music piece to the WEB server 1 in step S231.

In step S241, the WEB server 1 transmits, to the user terminal 5-N, the music code as transmitted by the browser and the information about the music title corresponding to the music code. In step S242, the WEB server 1 transmits the previous screen data (the screen data just before pressing the music selection button) to the user terminal 5-N.

In step S232, the writer control mechanism displays the music title as selected by the user on the display device 25. Then, the browser displays the previous screen again. After the process in step S232, the processing proceeds to step S194 of FIG. 24.

FIG. 26 is a flowchart showing the process flow when it is determined that a link button is pressed in step S199 of FIG. 24. As shown in FIG. 26, the browser transmits a new URL corresponding to the link button as pressed to the WEB server 1 in step S251.

In step S261, the WEB server 1 transmits the new web page data (there is no write button) corresponding to the new URL as received to the user terminal 5-N.

In step S252, the browser displays the new web page (there is no write button) on the display device 25. Then, the processing proceeds to step S194 of FIG. 24.

FIG. 27 is a flowchart showing the process flow when it is determined that the memory cartridge 13 is not inserted to the writer 7-N in step S184 of FIG. 23. As shown in FIG. 27, the writer control mechanism checks whether or not the writer 7-N is connected to the user terminal 5-N in step S211. In step S212, if the writer 7-N is not connected to the user terminal 5-N, the processing proceeds to step S191 of FIG. 24, and if the writer 7-N is connected to the user terminal 5-N, the processing proceeds to step S213.

In step S213, the writer control mechanism checks whether or not the cartridge 13 is inserted into the writer 7-N. In step S214, if the cartridge 13 is inserted into the writer 7-N, the processing proceeds to step S281 of FIG. 28, and if it is not inserted thereinto, the processing proceeds to step S215.

In step S215, the writer control mechanism displays on the display device 25 an indication requesting for the memory cartridge 13 to be inserted. In step S216, the writer control mechanism transmits the URL of the web page (there is no write button) exclusively provided for selection of a music piece to the WEB server 1.

In step S271, the WEB server 1 transmits the web page data exclusively provided for selection of a music piece to the user terminal 5-N.

In step S217, the browser parses the web page data as transmitted by the WEB server 1, and displays on the display device 25 the web page (there is no write button) exclusively provided for selection of a music piece. In step S218, the writer control mechanism checks whether or not the writer 7-N is connected to the user terminal 5-N. As a result of the check, in step S219, if the writer 7-N is connected to the user terminal 5-N, the processing proceeds to step S220, and if the writer 7-N is not connected to the user terminal 5-N, the processing proceeds to step S191 of FIG. 24.

In step S220, the writer control mechanism checks whether or not the cartridge 13 is inserted into the writer 7-N. In step S221, if the cartridge 13 is inserted into the writer 7-N, the processing proceeds to step S281 of FIG. 28, and if it is not inserted thereinto, the processing proceeds to step S222.

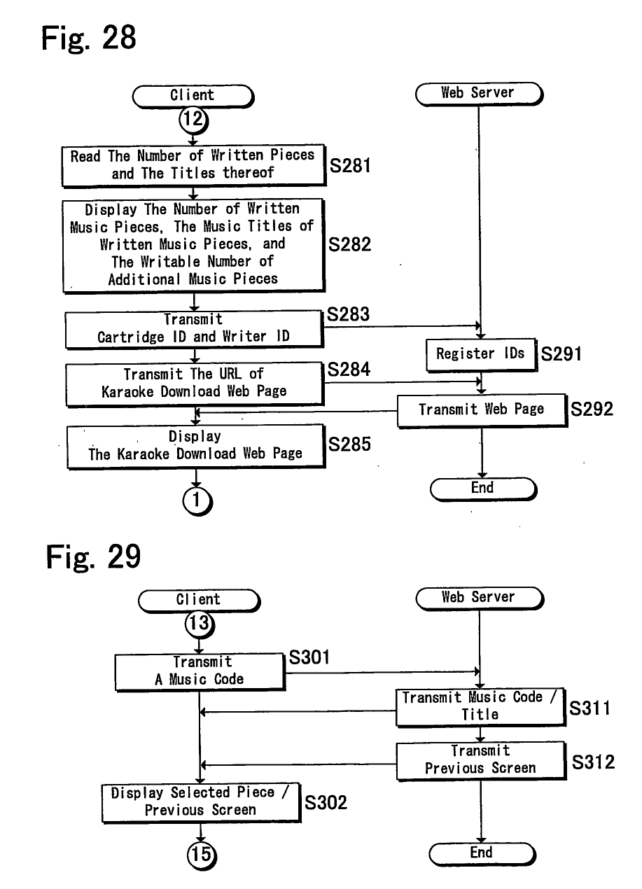

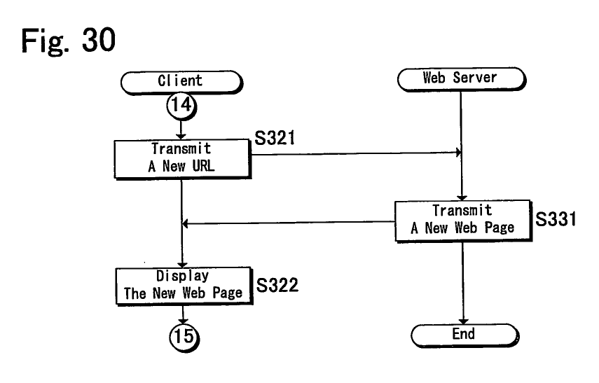

In step S222, the information as input by the user through the input device 27 is checked. As a result of the check in step S222, if it is determined (in step S223) that a title selection button in the screen is pressed by the user through the input device 27, the processing proceeds to the step S301 of FIG. 29; if it is determined (in step S224) that the exit button in the screen is pressed by the user through the input device 27, the processor 53 exits the writer program and the browser program; and if it is determined (in step S225) that a link button in the screen is pressed by the user through the input device 27, the processing proceeds to the step S321 of FIG. 30.

On the other hand, as a result of the check in step S222, if it is determined that no title selection button in the screen is pressed, that the exit button in the screen is not pressed, and that no link button in the screen is pressed (in step S223, step S224, and step S225), then the processing proceeds to step S218.

FIG. 28 is a flowchart showing the process flow when it is determined that the memory cartridge 13 is inserted into step S221 of FIG. 27. As shown in FIG. 28, in step S281, the writer control mechanism accesses the OTPROM 17 of the memory cartridge 13 and acquires the information about the number of music pieces as already written and the information about the music titles of the written music pieces. In step S282, the writer control mechanism displays on the display device 25 the number of the written music pieces, the music titles of the written music pieces, and the number of additional music pieces which can be further written. In step S283, the writer control mechanism transmits the identification information (ID) of the memory cartridge 13 and the identification information (ID) of the writer 7-N to the Web server 1.

In step S291, the WEB server 1 registers the identification information (ID) of the memory cartridge 13 and the identification information (ID) of the writer 7-N as transmitted by the writer control mechanism.

In step S284, the writer control mechanism transmits to the WEB server 1 the URL of the web page (having a write button) for downloading karaoke data.

In step S292, the WEB server 1 transmits the web page data to the user terminal 5-N.

In step S285, the browser parses the web page data received from the WEB server 1, and displays the web page (having a write button). Then, the processing proceeds to step S49 of FIG. 17.

FIG. 29 is a flowchart showing the process flow when it is determined that a title selection button is pressed in step S223 of FIG. 27. As shown in FIG. 29, the browser transmits the music code corresponding to the selected music piece to the WEB server 1 in step S301.

In step S311, the WEB server 1 transmits, to the user terminal 5-N, the information about the music code as transmitted by the browser and the music title corresponding to the music code. In step S312, the WEB server 1 transmits the previous screen data (the screen data just before pressing the music selection button) to the user terminal 5-N.

In step S302, the writer control mechanism displays the music title as selected by the user on the display device 25. Then, the browser displays the previous screen again. After the process in step S302, the processing proceeds to step S218 of FIG. 27.

FIG. 30 is a flowchart showing the process flow when it is determined that a link button is pressed in step S225 of FIG. 27. As shown in FIG. 30, the browser transmits a new URL corresponding to the link button as pressed to the WEB server 1 in step S321.

In step S331, the WEB server 1 transmits the new web page data (there is no write button) corresponding to the new URL as received to the user terminal 5-N. In step S322, the browser displays the new web page (there is no write button) on the display device 25. Then, the processing proceeds to step S218 of FIG. 27.

Incidentally, the process flow of downloading and writing karaoke data by the writing service terminal 9-M shown in FIG. 1 is similar to the process flow of downloading and writing karaoke data by the user terminal 5-N shown in FIG. 17 to FIG. 30. However, since the writing service terminal 9-M writes karaoke data to the OTPROM 17 by the processor 94, rather than by the writer which is separately provided, the check of whether or not the writer is connected to the user terminal is not conducted. Also, while communication is done between the WEB server 1 and the user terminal 5-N in FIG. 17 to FIG. 30, the process of downloading and writing karaoke data by the writing service terminal 9-M is performed by the communication between the Web server 1 and the writing service terminal 9-M.

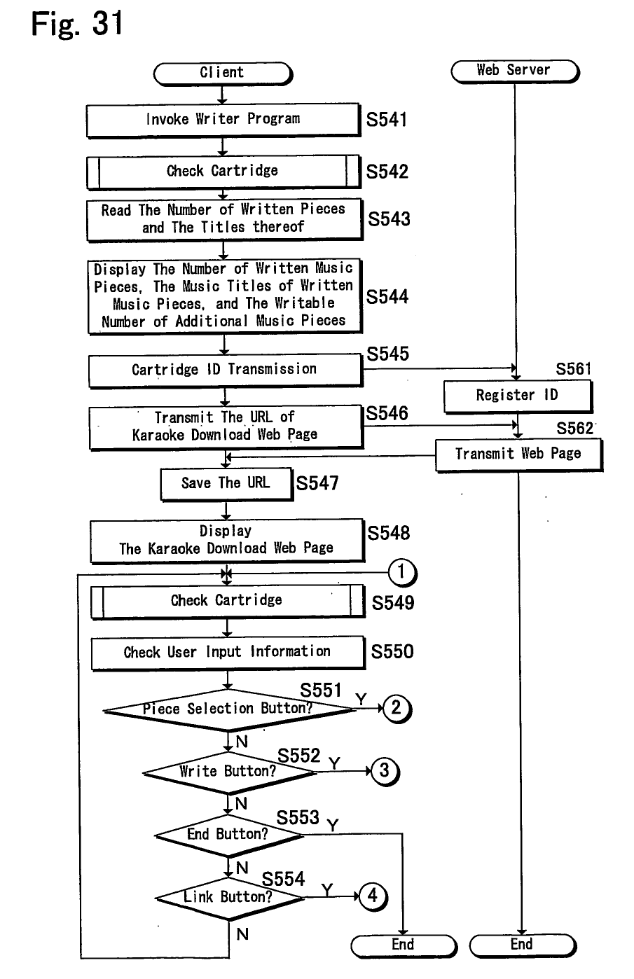

FIG. 31 is a flowchart showing the process flow of downloading and writing karaoke data by the writing service terminal 9-M of FIG. 1. As shown in FIG. 31, the processor 94 of the writing service terminal 9-M invokes the writer program stored in the auxiliary memory 99 in step S541. The writer control mechanism is formed by running the writer program by the processor 94. The writer control mechanism then invokes the browser program which is stored in the auxiliary storage device 99. The browser is launched by running the browser program by the processor 94. Namely, the writing service terminal 9-M functions as the browser and the writer control mechanism. Incidentally, the writer control mechanism and the browser can operate independent from each other (in parallel) by multitask.

In step S542, the writer control mechanism checks whether or not the memory cartridge 13 is inserted into the connector 35 of FIG. 3. Then, if the memory cartridge 13 is inserted into the connector 53, the writer control mechanism proceeds to step S543.

In step S543, the writer control mechanism accesses the OTPROM 17 of the memory cartridge 13 and acquires the information about the number of music pieces as already written and the information about the music titles of the written music pieces. In step S544, the writer control mechanism displays on the display device 31 the number of the written music pieces, the music titles of the written music pieces, and the number of additional music pieces which can be further written. In step S545, the writer control mechanism transmits the identification information (ID) of the memory cartridge 13 to the Web server 1.

In step S561, the WEB server 1 registers the identification information (ID) of the memory cartridge 13 as transmitted by the writer control mechanism.

In step S546, the writer control mechanism transmits to the WEB server 1 the URL of the web page (having a write button) for downloading karaoke data.

In step S562, the WEB server 1 transmits the web page data to the writing service terminal 9-M.

In step S547, the writer control mechanism stores the URL as transmitted (in step S546) in the memory 91. In step S548, the browser parses the web page data received from the WEB server 1, and displays the web page (having a write button). In step S549, the writer control mechanism checks whether or not the memory cartridge 13 is inserted into the connector 35. Then, if the memory cartridge 13 is inserted into the connector 35, the writer control mechanism proceeds to step S550. The process of this step S549 is similar to the process of the step S542.

In step S550, the information as input by the user through the input device 33 is checked. As a result of the check in step S550, if it is determined (in step S551) that a title selection button in the screen is pressed by the user through the input device 33, the processing proceeds to the step S71 of FIG. 18; if it is determined (in step S552) that the write button in the screen is pressed by the user through the input device 33, the processing proceeds to the step S91 of FIG. 19; if it is determined (in step S553) that the exit button in the screen is pressed by the user through the input device 33, the processor 94 exits the writer program and the browser program; and if it is determined (in step S554) that a link button in the screen is pressed by the user through the input device 33, the processing proceeds to the step S121 of FIG. 22.

On the other hand, as a result of the check in step S550, if it is determined that no title selection button in the screen is pressed, that the write button in the screen is not pressed, that the exit button in the screen is not pressed, and that no link button in the screen is pressed (in step S551, step S552, step S553 and step S554), then the processing proceeds to step S549.

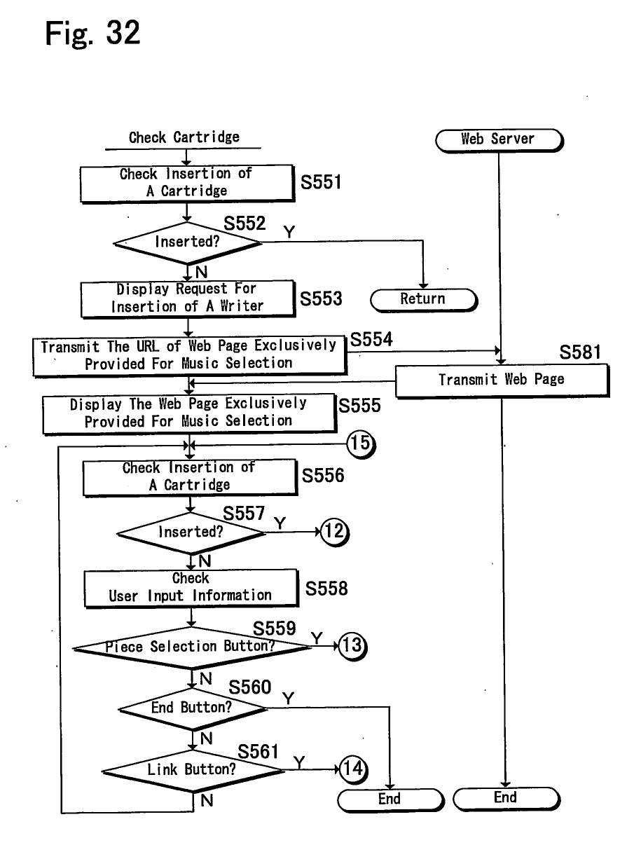

FIG. 32 is a flowchart showing the process flow of the cartridge check process in step S542 of FIG. 31. As shown in FIG. 32, the writer control mechanism checks whether or not the cartridge 13 is inserted into the connector 35 in step S551. In step S552, if the cartridge 13 is inserted into the connector 35, the processing proceeds to step S543 of FIG. 31, and if it is not inserted thereinto, the processing proceeds to step S553.

In step S553, the writer control mechanism displays on the display device 31 an indication requesting for the memory cartridge 13 to be inserted. In step S554, the writer control mechanism transmits to the WEB server 1 the URL of a web page (there is no write button) exclusively provided for selection of a music piece.

In step S581, the WEB server 1 transmits the web page data exclusively provided for selection of a music piece to the writing service terminal 9-M.

In step S555, the browser parses the web page data as transmitted by the WEB server 1, and displays the web page (there is no write button) exclusively provided for selection of a music piece to the display device 31. In step S556, the writer control mechanism checks whether or not the cartridge 13 is inserted into the connector 35. In step S557, if the cartridge 13 is inserted into the connector 35, the processing proceeds to step S281 of FIG. 28, and if it is not inserted thereinto, the processing proceeds to step S558. However, in step S283 of FIG. 28 of this process, the identification information (ID) of the writer is not transmitted. This is because the writer which is separately provided is not used in the writing service terminal 9-M.

In step S558, the information as input by the user through the input device 33 is checked. As a result of the check in step S558, if it is determined (in step S559) that a title selection button in the screen is pressed by the user through the input device 33, the processing proceeds to the step S301 of FIG. 29; if it is determined (in step S560) that the exit button in the screen is pressed by the user through the input device 33, the processor 94 exits the writer program and the browser program; and if it is determined (in step S561) that a link button in the screen is pressed by the user through the input device 33, the processing proceeds to the step S321 of FIG. 30.

On the other hand, as a result of the check in step S558, if it is determined that no title selection button in the screen is pressed, that the exit button in the screen is not pressed, and that no link button in the screen is pressed (in step S559, step S560 and step S561), then the processing proceeds to step S556.

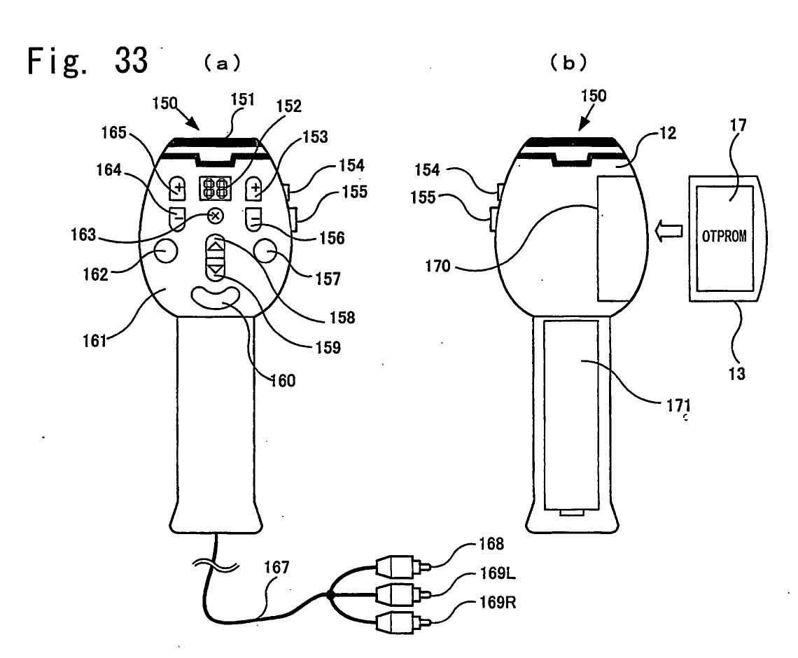

FIG. 33 is an external view showing an example of a microphone type karaoke device (home karaoke device), i.e., a karaoke system equipped within a handy microphone unit, into which the memory cartridge 13 containing karaoke data can be inserted. As shown in FIG. 33(a), the microphone type karaoke device 150 includes a housing (main body) 161 having an upper egg-shaped portion and a lower cylindrical portion and is provided with a microphone 151 at the upper end of the upper egg-shaped portion. A power switch 155 and a reset switch 154 are provided at the upper portion, i.e., the egg-shaped portion of the housing 161. The power switch 155 is a switch for turning on/off a power supply, and the reset switch 154 is provided for resetting the current status including the entry numbers as selected.

Furthermore, the egg-shaped portion of the housing 161 is provided with a two-digit display 152 composed of 7-segment LEDs, tempo control keys 165 and 164 vertically arranged in the left side of the display 152, and BGM volume control keys 153 and 156 vertically arranged in the right side of the display 152. The display 152 is used to display a entry number which is selected by the user. The tempo control keys 165 and 164 are keys used to increase or decrease the playback speed of karaoke, i.e., BGM. The BGM volume control keys 153 and 156 are keys used to increase or decrease the magnitude of playback sound (volume) of karaoke, i.e., BGM.

Title selection and pitch control keys 158 and 159 are provided in the position a little below the center of the egg-shaped portion of the housing 161. These title selection and pitch control keys 158 and 159 are used to increment or decrement the entry number, and also used to tune up or down the pitch frequency, i.e., the pitch level of karaoke in accordance with the voice range of the user.

The egg-shaped portion of the housing 161 is provided also with an echo mode selection key 162 in the left side of the title selection and pitch control keys 158 and 159 and below the tempo control keys 165 and 164. This echo mode selection key 162 is used to selectively set an echo time (delay time) in an echo mode. In this embodiment, an echo mode 1, an echo mode 2 or an echo mode 3 can be selected to set the echo time to be “short”, “intermediate” or “long” respectively.

The egg-shaped portion of the housing 161 is further provided with a voice effect mode selection key 157 in the right side of the title selection and pitch control keys 158 and 159 and below the BGM volume control keys 153 and 156. This voice effect mode selection key 157 is used to set a voice effect mode 1, a voice effect mode 2 or a voice effect mode in this embodiment. The voice effect mode 1 is a mode in which the output voice is processed to have a frequency higher than that of the input voice, while the voice effect mode 2 is a mode in which the output voice is processed to have a frequency lower than that of the input voice. On the other hand, the voice effect mode 3 is a mode in which the frequency of the output voice is continuously and repeatedly varying up and down (swept) to get vibrato.

A cancel key 163 is provided between the display 152 and the title selection and pitch control keys 158 and 159. This cancel key 163 is a key used to cancel the tempo as set with the tempo control keys 165 and 164, the BGM volume as set with the BGM volume control keys 153 and 156, the entry number and the pitch as set with the title selection and pitch control keys 158 and 159, the echo mode as set with the echo mode selection key 162, or the voice effect mode as set with the voice effect mode selection key 157. This cancel key 163 can be used also to stop the music that is being played.

An enter key 160 is provided below the title selection and pitch control keys 158 and 159. This enter key 160 is a key used to enter and make effective the tempo as set with the tempo control keys 165 and 164, the BGM volume as set with the BGM volume control keys 153 and 156, the entry number and the pitch as set with the title selection and pitch control keys 158 and 159, or the voice effect mode as set with the voice effect mode selection key 157.

An AV code 167 is provided leading out from the bottom of the housing 161, i.e., the lower end of the cylindrical portion, and composed of two line-out audio plugs 169L and 169R and one line-out image plug 168. The line-out audio plugs 169L and 169R and the line-out image plug 168 are connected to the AV terminals of a television monitor (not shown in the figure). Accordingly, the image and audio data of this microphone type karaoke device 150 is output to the television monitor.

As shown in FIG. 33(b), a cartridge connector 170 is provided in the rear surface of the housing 161, and the memory cartridge 13 (refer to FIG. 2) is removably inserted into this cartridge connector 170. Meanwhile, the microphone type karaoke device 150 is a battery-operated device 171, and therefore a battery box is provided in the cylindrical lower portion of the housing 161 as shown in FIG. 33(b).

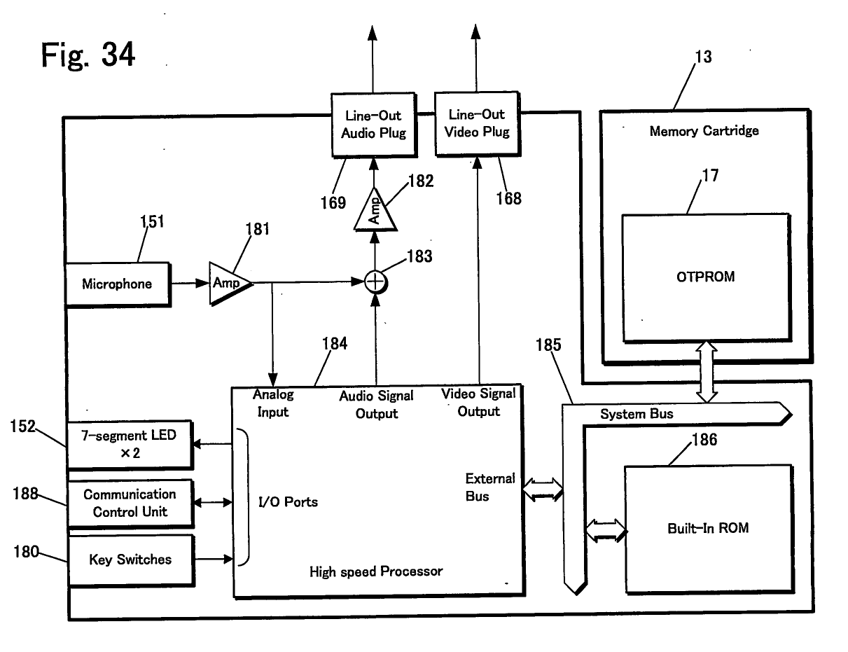

FIG. 34 is a view showing the electric configuration of the microphone type karaoke device 150 of FIG. 33. As shown in FIG. 34, the microphone type karaoke device 150 includes a processor 184 installed inside the housing 161.

Although not shown in the figure, the processor 184 includes various processors such as a CPU, a graphics processor and a DMA processor, and in addition to this, includes an A/D converter for accepting analog signals and an input and output control circuit for receiving input signals such as key manipulation signals and infrared signals and supplying output signals to external devices. The CPU performs necessary operations in accordance with input signals and outputs the results thereof to the graphics processor, the sound processor and/or the like. Accordingly, the graphics processor, the sound processor perform and/or the like perform image processing and sound processing in accordance with the results of the operations.

This processor 184 is connected to a system bus 185, which is connected to a built-in ROM 186 mounted together with the processor 184 on a circuit board (not shown in the figure) inside the housing 161 while the OTPROM 17 of the memory cartridge 13 is connected also to the system bus 185 when inserted. Accordingly, the processor 184 can access the ROM 186 and the OTPROM 17 through the system bus 185 to read image data and music data (music note data) therefrom.

Incidentally, as shown in FIG. 34, the audio signal from the microphone 151 is input to the analog input of the processor 184 through an amplifier 181. The audio data is processed by the sound processing unit of the processor 184, and then the resultant analog audio signal is output to the line-out audio plugs 169 (169L and 169R) through a mixer 183 and the amplifier 182 as shown in FIG. 33. Also, the image data is processed by the graphics processing unit (not shown in the figure) of the processor 184, and then the resultant analog image signal is output through the line-out image plug 168 shown in FIG. 33. Furthermore, display data are output to the display 152 shown in FIG. 33(a) from the output port of the processor 184, while all the switches and keys (generally represented here by a reference numeral 180) are connected to the input port of the processor 184.

This microphone type karaoke device 150 can be used also as the writer 7-N of FIG. 1. In this case, the microphone type karaoke device 150 is connected to the client terminal 5-N with the cable 15. In this case, the processor 184 serves also as the MPU 70 of FIG. 6. This point will be briefly explained. The karaoke data as transmitted from the client terminal 5-N through the cable 15 is input to a communication control unit 188 of the microphone type karaoke device 150. The communication control unit 188 performs processing required of the karaoke data as given, and input it to the input port of the processor 184. The processor 184 writes the karaoke data, as input to the input port, in a blank area aK of the OTPROM 17 connected to the bus 185.

On the other hand, the processor 184 reads the karaoke data written to the OTPROM 17 connected to the bus 185, and outputs it to the communication control unit 188 through the output port. The communication control unit 188 transmits the karaoke data as given to the client terminal 5-N through the cable 15.

Meanwhile, the communication control unit 188 controls the communication between the client terminal 5-N and the microphone type karaoke device 150. When a USB cable is used as the cable 15, the communication control unit 188 serves as an USB controller.

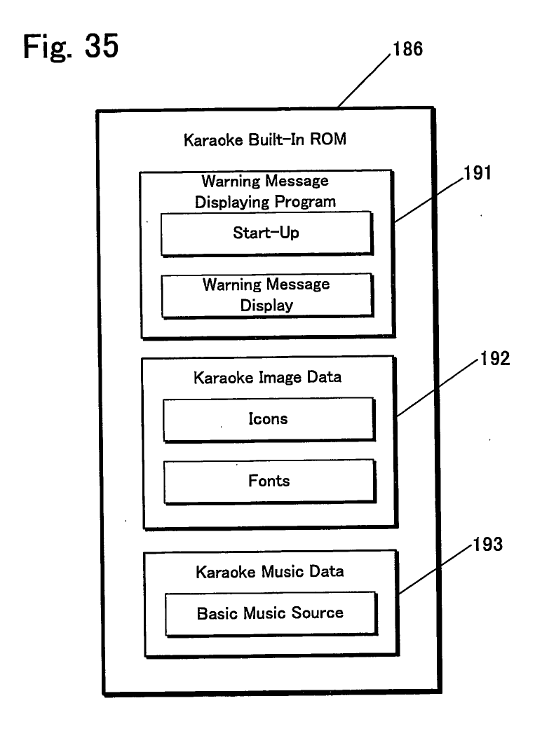

FIG. 35 is a schematic representation of a program and data stored in the ROM 186 of FIG. 34. As shown in FIG. 35, a warning message displaying program 191, karaoke image data 192 and karaoke music data 193 are stored in the built-in ROM 186. The warning message display program 191 is invoked to display a warning message on the television monitor when the power switch 155 is turned on without the memory cartridge 13 to be inserted. The karaoke image data 192 and the karaoke music data 193 are commonly used to any music piece stored in the memory cartridge 13. The karaoke image data 192 includes icon data and font data while the karaoke music data 193 includes sound sourse data.

On the other hand, when the power switch 155 is turned on with the memory cartridge 13 being inserted into the microphone type karaoke device 150, the system program (refer to FIG. 5) stored in the OTPROM 17 is invoked to perform a system initialization processing, a sequence control processing, an image display control processing, an A/D conversion processing, a music processing, a playback control processing and the like. Also, the system program (refer to FIG. 5) performs processing of the background image data, the music title image data, the lyric text data, the score data and common data which are stored in the OTPROM 17.

Incidentally, the user can purchase the memory cartridge 13, for example, at a sales outlet for the microphone type karaoke device 150 or a shop in which the writing service terminal 9-M is placed.

By the way, since the transmission of a bank account or a credit card number is no longer required for downloading karaoke data in the case of the present embodiment, even those feeling insecure about the transmission of such information can make use of the karaoke data delivery service without anxiety. Furthermore, since no charge is incurred when delivering karaoke data, even those who do not have a bank account or a credit card number (for example, minors and children) can make use of the karaoke data delivery service. As has been discussed above, it is possible to deliver data to more people and therefore acquire a broad range of customers.

Also, since the prepaid system is not employed, the memory cartridge 13 contains no prepaid information and therefore user's fraud can be prevented as much as possible.

Furthermore, since no charge is incurred when delivering karaoke data, the process of accounting and charging can be omitted in the Web server 1. Accordingly, while the load on the Web server 1 can be lessened, it is easy to implement security measures.

Furthermore, since no charge is incurred when delivering karaoke data, the user does not have to transmit a bank account or a credit card number. Accordingly, it is possible to prevent such important information from leaking and unauthorized use.

Still further, as compared with online charging, the user is requested to input little information and can acquire desired karaoke data from the Web server 1 by a simple procedure.

Still further, since no charge is incurred when delivering karaoke data, it is possible to reduce the frequency of exchanging signals between the Web server 1 and the client terminal (the user terminal 5-N or the writing service terminal 9-M), dispense with a complicated communication procedure, and therefore deliver karaoke data by a simple procedure.

Still further, the writer unit (the writer 7-N or the writing service terminal 9-M) performs once only writing in an area of the storage areas of the memory cartridge 13 in which data is not written yet. In other words, it is impossible to rewrite other data to the memory cartridge 13. Accordingly, the user has to purchase another one of the memory cartridge 13 anew when there is no free space in the memory cartridge 13. Since no charge is incurred when delivering karaoke data, it is expected that the user downloads desired karaoke data one after another and that the sales volume of the memory cartridge 13 increases. Accordingly, the manufacturer or seller of the memory cartridge 13 can benefit from growing sales.

In addition to this, since karaoke data is not transmitted to the client terminal if the writable number of additional music pieces become “0”, the purchased amount of the memory cartridge 13 furthermore increases to bring strong sales to the manufacturer or seller of the memory cartridge 13.

Furthermore, since predetermined data (a system program, common data, a cartridge ID, and the writable number of additional music pieces) is written in advance (for example, already before shipment from a factory), it is possible to enjoy a karaoke play only by inserting the memory cartridge 13 into the microphone type karaoke device 150 after writing karaoke data as delivered to the memory cartridge 13.

Still further, since karaoke data is written to the memory cartridge 13 in units of the blank area ak (usually, one music piece of karaoke data is written in one blank area aK), it becomes easy to manage the karaoke data as delivered and written to the memory cartridge 13 and to perform the process of reading the karaoke data as written.

Still further, when the write operation to the memory cartridge 13 is completed without error, a write operation completion code is transmitted from the client terminal to the Web server 1. Because of this, the service provider can confirm through the Web server 1 that the karaoke data as delivered is completely written without error. For example, in the case where the data as delivered is music data, picture data and the like subject to copyright, by notifying the Web server 1 of the normal completion of writing data, it is possible to enable the service provider to appropriately calculate copyright fees payable to the copyright holders.

Furthermore, since the karaoke data is erased from the client terminal after completing the writing of karaoke data to the memory cartridge 13 without error, it is possible to appropriately calculate copyright fees payable to the copyright holders for example in the case where the data as delivered is music data, picture data and the like subject to copyright. On the other hand, if karaoke data were left in the client terminal, the treatment of the copyright thereof would become uncertain, and therefore it would be difficult to calculate appropriate copyright fees.

Furthermore, since the client terminal transmits the identification information (ID) of the memory cartridge 13 to the Web server 1, it is possible to take an appropriate action when a falsified memory cartridge is used.

Still further, since the client terminal transmits the user information to the Web server 1, the service provider can acquire various information of the user through the WEB server 1 and reflect the information in the way of providing services.

Still further, the client terminal displays the information about the music pieces already stored in the memory cartridge 13 together with the number of additional music pieces which can be further written to the memory cartridge 13. Because of this, it is possible to substantially lower the possibility of such a disadvantage of the user that the same music piece is redundantly written in separate areas of the memory cartridge 13 resulting in the decrease in the free space of the memory cartridge 13. In addition to this, since the user is informed of the writable number of additional music pieces which can be further written to the memory cartridge 13, it is possible to improve convenience when selecting music pieces to be downloaded.

On the other hand, the user terminal 5-N and the writer 7-N are separately provided and connected to each other by the cable 15. Because of this, in the case where a widespread type terminal can be used as the user terminal 5-N, a person possessing such a widespread type terminal connectable to the writer 7-N can enjoy the karaoke data delivery service from the Web server 1 only by purchasing the writer 7-N without need for purchasing both the user terminal 5-N and the writer 7-N. Also, in the case where a widespread type terminal can be used as the user terminal 5-N, a person who does not possess a terminal connectable to the writer 7-N can enjoy the karaoke data delivery service only by purchasing the writer 7-N and making use of such a widespread type terminal of somebody connectable to the writer 7-N as the user terminal 5-N.

Furthermore, if the writer 7-N is not connected, the user terminal 5-N displays an indication requesting for the writer 7-N to be connected, and if the memory cartridge 13 is not inserted into the writer 7-N, the user terminal 5-N displays an indication requesting for the memory cartridge 13 to be inserted. In this way, the user can be given appropriate attention to enable smooth delivery of karaoke data.

Furthermore, since the processor 94 of the writing service terminal 9-M functions as the writer 7-N, i.e., since the writing service terminal 9-M and the writer are integrally implemented, the connecting work of the writer can be dispensed with to improve the convenience of the user. In addition, the writer can be prevented from being lost or stolen.

Furthermore, if the memory cartridge 13 is not inserted into the connector 35, the writing service terminal 9-M displays an indication requesting for the insertion. Because of this, the user can be given appropriate attention to enable smooth delivery of karaoke data.

Also, the microphone type karaoke device 150 itself can be used also as a writer. Because of this, it is possible to write the karaoke data to the memory cartridge 13 by the microphone type karaoke device 150 and then enjoy karaoke by reading the karaoke data by the same microphone type karaoke device 150. As discussed above, the convenience of the user is improved since writing and using karaoke data can be done by the same device.

Furthermore, the user can use the delivery service of karaoke data with ease and security by selecting his favorite music pieces from among various types of music. In other words, while users tend to like to get only favorite music pieces, their desire can be satisfied. Incidentally, if the memory cartridge 13 were provided with a plurality of music pieces stored in advance, it would be unlikely that all the music pieces as stored would meet user's preferences. In this case, the satisfaction level of the user purchasing such a memory cartridge 13 would not always be high.

Furthermore, the Web server 1 delivers karaoke data to be downloaded in units of the blank area ak (usually, one music piece of karaoke data for one blank area aK) of the memory cartridge 13. Accordingly, since karaoke data is written to the memory cartridge 13 in units of the blank area ak, it becomes easy to manage the karaoke data as delivered and written to the memory cartridge 13 and to perform the process of reading the karaoke data as written.

### Embodiment 2

The overall configuration of the karaoke data delivery system in accordance with the embodiment 2 of the present invention is similar to that as illustrated in FIG. 1. Also, the user terminal 5-N, the writer 7-N and the writing service terminal 9-M are similar to the user terminal 5-N and the writer 7-N of FIG. 6 and the writing service terminal 9-M of FIG. 7. Furthermore, also in the embodiment 2, it is possible to write karaoke data to the memory cartridge 13 by the microphone type karaoke device of FIG. 33 to FIG. 35 in the same manner as in the embodiment 1.

In the case of the embodiment 2, the download process and set-up process of the writing program for downloading and writing karaoke data to the memory cartridge 13 are similar to those of FIG. 12 and FIG. 13. Also, the communication protocol of the embodiment 2 is substantially similar to that of FIG. 8.

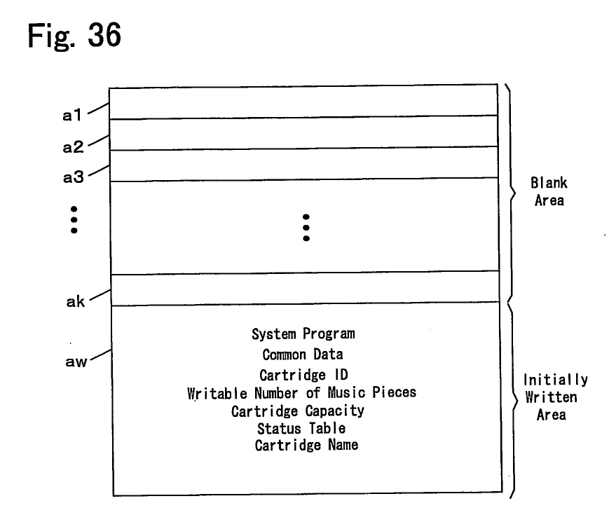

FIG. 36 is an illustrative view for explaining the memory map of the OTPROM 17 in accordance with the embodiment 2. As shown in FIG. 36, the OTPROM 17 includes blank areas a1 to ak (k is a natural number) and an initially written area aw in advance of usage. In the following description, the term “blank area aK” is used to generally represent the blank areas a1 to ak. The blank area aK is an area in which no data is written yet before the user purchases the OTPROM 17 (before shipment from a factory).

Usually, one music piece of karaoke data is written in one blank area aK. However, it is possible to write one music piece of karaoke data over a predetermined number of the blank areas ak. Karaoke data is written in units of the blank area ak in this manner. In addition, because of the use of the OTPROM 17, karaoke data is written only in unused blank area(s) ak. That is, once karaoke data is written in a blank area aK, the same blank area aK cannot be used again for writing karaoke data. In other words, it is possible to write data only once.

In the initially written area aw, a system program, common data, the identification information (ID) of the memory cartridge 13, the number of music pieces which can be written thereto, a status table, the capacity of the cartridge and the name of that memory cartridge 13 are already written before the user purchases the OTPROM 17 (before shipment). The system program, the common data, the ID of the memory cartridge 13 and the information of the number of music pieces which can be written thereto are similar as described in FIG. 4.

The name of the cartridge is used to judge the type of the memory cartridge 13. The memory cartridge 13 may be of a type provided for karaoke, a type provided for game, or a type for another purpose. The cartridge name of the cartridge 13 is stored for distinguishing these types from one another. In the case of the present embodiment, the memory cartridge 13 is of the type provided for karaoke and given, for example, “MK” as the name of the cartridge.

The status table includes a plurality of state flags provided for the respective blank areas ak. Each state flag indicates the write status of the corresponding blank area aK. The write state takes one of four states, i.e., a “unused (free)” state, a “during write” state, a “normally written” state and an “erroneously written” state.

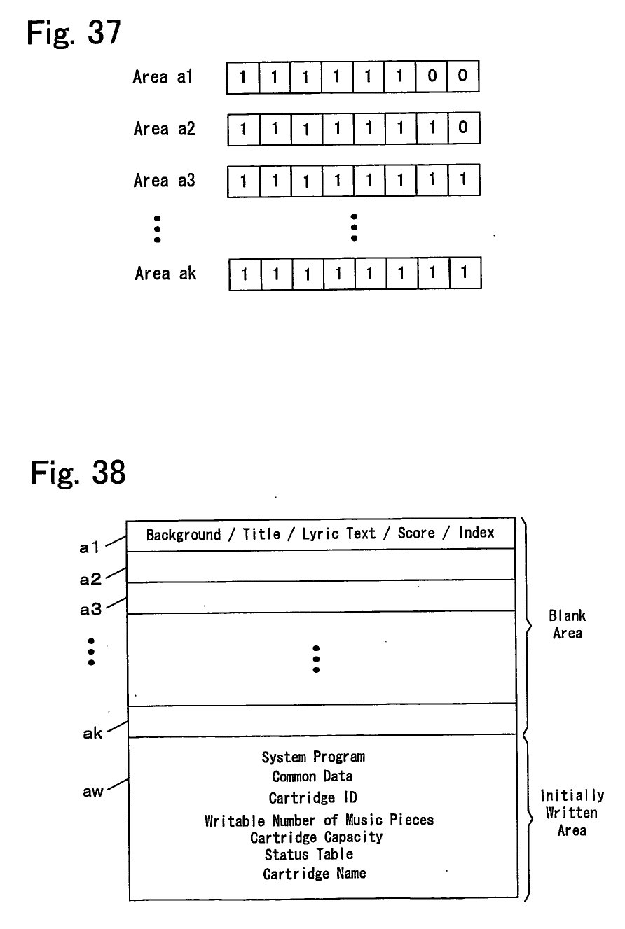

FIG. 37 is a view showing an example of the status table of FIG. 36. As illustrated in FIG. 37, a state flag of 8 bits is provided for each blank area aK. The “unused” state is indicated by “11111111”, the “during write” state by “11111110”, the “normally written” state by “11111100”, and the “erroneously written” state by “00000000”. In the example of FIG. 37, the write state of the blank area a1 is “normally written”, and the write state of the blank area a2 is “during write”, and the write state of the blank areas a3-aK are “unused”.

FIG. 38 is an illustrative view for explaining the state of OTPROM 17 of FIG. 2 after writing in accordance with the embodiment 2. In the example of FIG. 38, the karaoke data and the index information are written in the blank area a1. This karaoke data contains background image data, music title image data, lyric text data, and score data. The index information includes the storage location information of the background image data, the storage location information of the music title image data, the storage location information of the lyric text data, and the storage location information of the score data and the like which are written in the blank area a1. As has been discussed above, karaoke data is written in the blank area ak together with the index information of the karaoke data.

Needless to say, while the term “blank area” is used in the description of the present embodiment, the area is no longer blank once karaoke data is written therein.

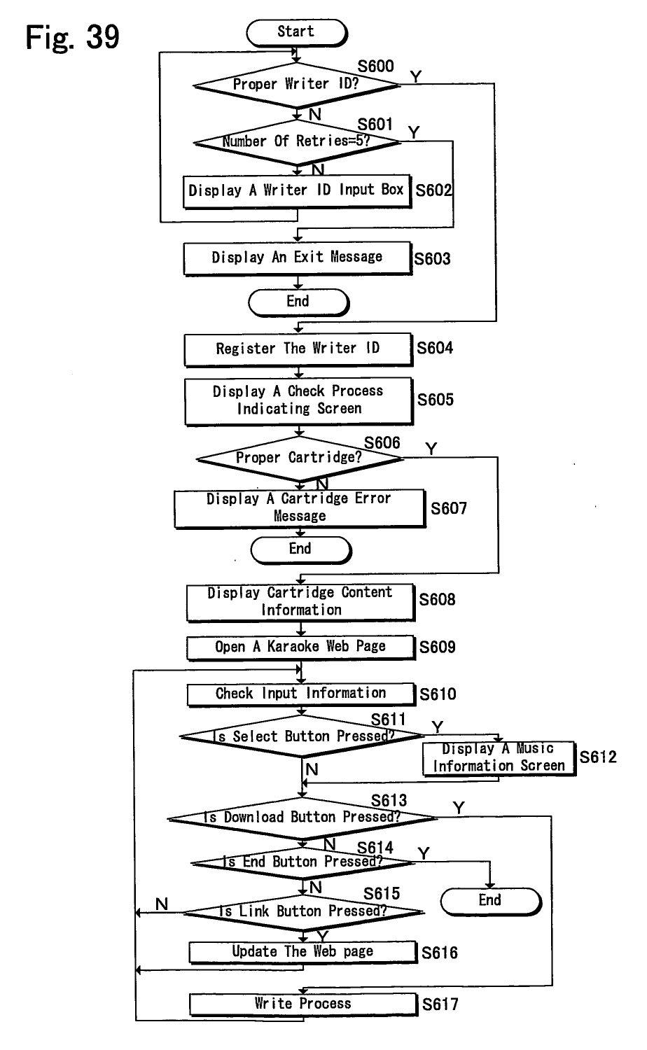

Next, the general outline of the process by the user terminal 5-N will be explained. FIG. 39 is a flowchart showing the general outline of the process by the user terminal 5-N in accordance with the embodiment 2 of the present invention. As shown in FIG. 39, the user terminal 5-N checks in step S600 whether or not the identification information (ID) of the writer 7-N is correct. If correct the processing proceeds to step S604, and if not correct the processing proceeds to step S601.

The user terminal 5-N counts the number of times that the ID of the writer 7-N is entered in step S601, and if the number is five the processing proceeds to step S603 in which the processing is terminated by displaying an entry process termination message. On the other hand, if the number of times is smaller than five, the user terminal 5-N performs step S602 in which an entry screen for entering the ID of the writer 7-N is displayed on the display device 25, and then the processing proceeds to step S600.

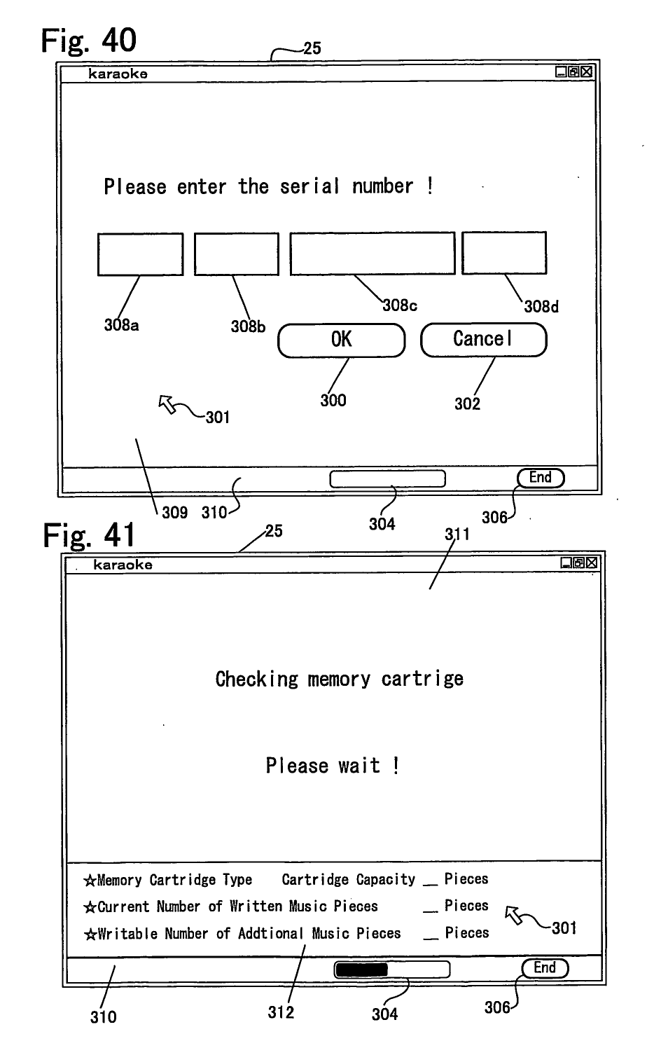

FIG. 40 is a view showing an example of the entry screen of the ID of the writer 7-N in accordance with the embodiment 2. As shown in FIG. 40, the cursor 301, an ID entry screen 309 and a gage section 310 are displayed on the display unit 25. The ID entry screen 309 includes ID entry boxes 308a to 308d for entering an ID, an OK button 300 to be pressed after entering an ID and a cancel button 302 for canceling the input. The gage section 310 includes a gage 304 indicative of the progress of the process and an exit button 306.

The user manipulates the mouse 27a to move the cursor 301 to one of the ID entry boxes 308a to 308d. Then, the ID of the writer 7-N is sequentially entered by clicking the mouse 27a to determine the input position, and inputting the characters of the ID with the keyboard 27b. After entering the ID, the user moves the cursor 301 to the OK button 300 by manipulating the mouse 27a and enters the input data by clicking the mouse 27a. On the other hand, if canceling the input is desired, the cursor 301 is moved to the cancel button 302 followed by clicking the mouse 27a. The ID entry screen 309 and the gage section 310 are closed by moving the cursor 301 to the exit button 306 and clicking the mouse 27a.

Returning to FIG. 39, the user terminal 5-N stores the ID of the writer 7-N in the auxiliary memory 55 in step S604. In step S605, the user terminal 5-N displays a check process indicating screen of the memory cartridge 13 on the display unit 25. The user terminal 5-N checks whether or not the memory cartridge 13 is proper in step S606, and if not proper the processing proceeds to step S607 in which an error message is displayed on the display unit 25, followed by terminating the process. On the other hand, if the memory cartridge 13 is proper, the user terminal 5-N performs step S608 in which the information about the data stored in the memory cartridge 13 are displayed on the display device 25.

FIG. 41 is a view showing an example of the check process indicating screen of the memory cartridge 13 in accordance with the embodiment 2. As shown in FIG. 41, the cursor 301, a cartridge stored data information indicating section 312, the check process indicating screen 311 of the memory cartridge 13 and the gage section 310 are displayed on the display unit 25.

In order to notify the user that the memory cartridge 13 is being checked, the check process indicating screen 311 is used to display a message indicative of the state. The gage 304 is used to indicate the progress of checking the memory cartridge 13. After completing the check of the memory cartridge 13, the type of the memory cartridge 13 (for example, the type capable of storing 28 music pieces, the type capable of storing 12 music pieces, and so forth), the current number of music pieces which have been written to the memory cartridge 13, the writable number of additional music pieces which can be further written to the memory cartridge 13, and a cartridge information table 314 to be described below are displayed in the cartridge stored data information indicating section 312 (in step S608).

Returning to FIG. 39, in step S609, the user terminal 5-N displays the web page for downloading karaoke data on the display device 25.

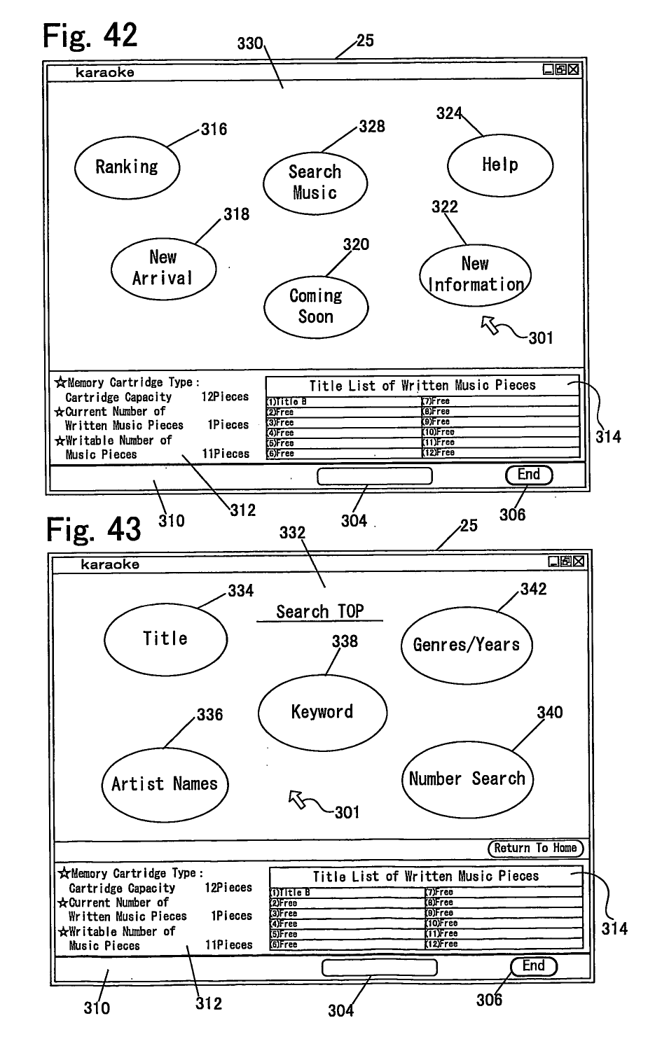

FIG. 42 is a view showing an example of the web page for downloading karaoke data in accordance with the embodiment 2. As shown in FIG. 42, the user terminal 5-N displays the cursor 301, a karaoke web page 330, the cartridge stored data information indicating section 312, and the gage section 310 on the display device 25.

The karaoke web page 330 includes a ranking button 316, a new arrival button 318, a coming soon button 320, a new information button 322, a help button 324 and a music search button 328. If the user manipulates the mouse 27a to move the cursor 301 to the music search button 328 and clicks the mouse 27a, a search top page 332 (to be described below) is opened for search a variety of categories for desired music pieces.

If the user presses the ranking button 316 by the similar manipulation, a Web page (not shown in the figure) is opened to display a ranking list of music pieces. Also, if the user presses the new arrival button 318 by the similar manipulation, a Web page (not shown in the figure) is opened to display a list of new music pieces. Furthermore, if the user presses the coming soon button 320 by the similar manipulation, a Web page (not shown in the figure) is opened to display a list of music pieces scheduled for release. Still further, if the user presses the new information button 322 by the similar manipulation, a Web page (not shown in the figure) is opened to display a variety of information for users. Still further, if the user presses the help button 324 by the similar manipulation, a Web page (not shown in the figure) is opened to display the information for assisting the user in manipulating the system.

Incidentally, in the case of the example of FIG. 42, the cartridge stored data information indicating section 312 displays the indication that the type of the memory cartridge 13 as inserted is the type capable of storing 12 music pieces, the indication that one music piece has been written in the memory cartridge 13 as inserted, the indication that the writable number of additional music pieces which can be further written to the memory cartridge 13 is 11, and the cartridge information table 314. The cartridge information table 314 contains the list of the music pieces which have been written.

FIG. 43 is a view showing an example of the search top page 332 in accordance with the embodiment 2. As shown in FIG. 43, the cursor 301, the search top page 332, the cartridge stored data information indicating section 312 and the gage section 310 are displayed on display unit 25. The search top page 332 includes a music title button 334, an artist name button 336, a keyword button 338, a number button 340 and genre/year button 342.

If the user manipulates the mouse 27a to move the cursor 301 to the music title button 334 and clicks the mouse 27a, a music title search page 344 (to be described below) is opened for search music titles for desired music pieces. If the user presses the artist name button 336 by the similar manipulation, an artist name search page 355 (to be described below) is opened for searching artist names for desired music pieces. If the user presses the keyword button 338 by the similar manipulation, a keyword search page (not shown in the figure) is opened for searching keywords for desired music pieces. If the user presses the genre/year button 342 by the similar manipulation, a genre/year search page (not shown in the figure) is opened for searching genres and years for desired music pieces. If the user presses the number button 340 by the similar manipulation, a number search page (not shown in the figure) is opened for searching the numbers assigned to the respective music pieces for desired music pieces.

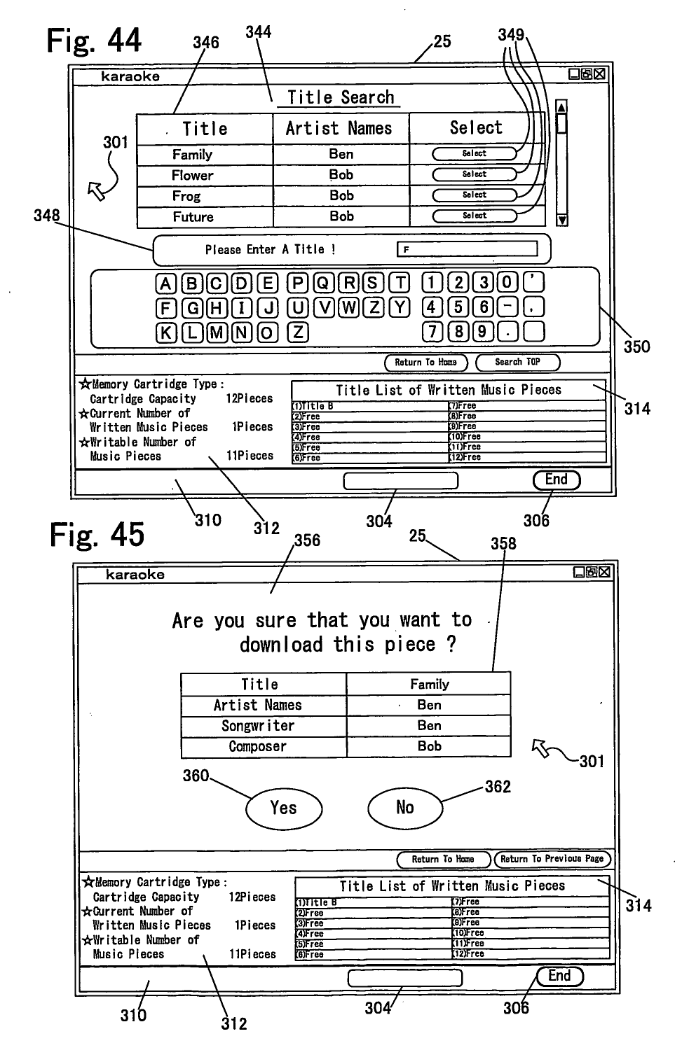

FIG. 44 is a view showing an example of the music title search page 344 in accordance with the embodiment 2. As shown in FIG. 44, the cursor 301, the music title search page 344, the cartridge stored data information indicating section 312 and the gage section 310 are displayed on the display unit 25. The music title search page 344 contains a music title entry box 348 to which a music title is entered by the user, a character selection array 350 consisting of one set of characters, and a music title table 346 are displayed.

If the user manipulates the mouse 27a to move the cursor 301 to a desired character of the character selection array 350 and clicks the mouse on the desired character, the desired character is input to the music title entry box 348. Alternatively, characters can be input to the music title entry box 348 with the keyboard 27b. When a character or a character string is input to the music title entry box 348, the music titles including the character or the character string are displayed in the music title table 346. The music title table 346 contains music titles, artist names and selection buttons 349.

If the user manipulates the mouse 27a to move the cursor 301 to the selection button 349 corresponding to a desired music piece and clicks the mouse on the selection button, a download page 356 (to be described below) is opened.

FIG. 45 is a view showing an example of the download page 356 in accordance with the embodiment 2. As shown in FIG. 45, the cursor 301, the download page 356, the cartridge stored data information indicating section 312 and the gage section 310 are displayed on the display unit 25. The download page 356 contains a selected piece information indicating section 358, an “YES” button 360 and a “NO” button 362.

If the user manipulates the mouse 27a to move the cursor 301 to the “YES” button 360 and clicks the mouse 27a, the karaoke data corresponding to the selected piece is downloaded to the user terminal 5-N and written to the memory cartridge 13 by the writer 7-N. Incidentally, when the “YES” button 360 is pressed, a write process indicating screen 313 (to be described below) is opened. Conversely, when the “NO” button 362 is pressed, the previous screen (the music title search page 344 in this example) is opened again.

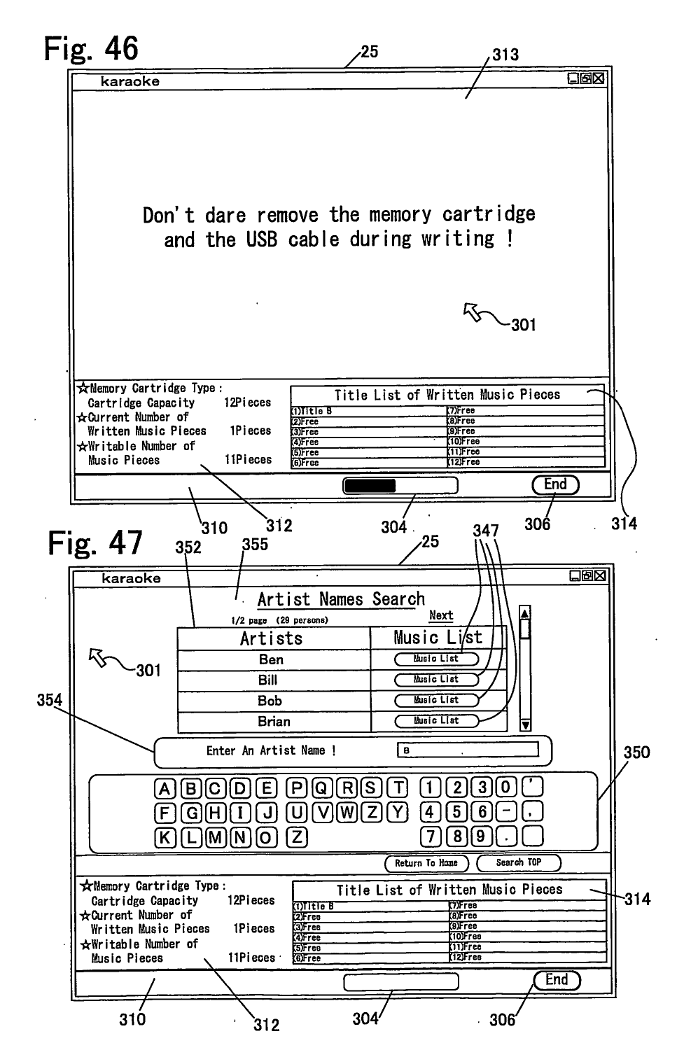

FIG. 46 is a view showing an example of the write process indicating screen in accordance with the embodiment 2. As shown in FIG. 46, the cursor 301, the write process indicating screen 313, the cartridge stored data information indicating section 312 and the gage section 310 are displayed on the display unit 25. In order to notify the user that the karaoke data is being written to the memory cartridge 13, the cartridge stored data information indicating section 313 is used to display a suggestive message indicative of the state. The progress of downloading and writing is displayed in the gage 304.

Returning to FIG. 43, if the user presses the artist name button 336, an artist name search page 355 (to be described below) is opened.

FIG. 47 is a view showing an example of the artist name search page 355 in accordance with the embodiment 2. As shown in FIG. 47, the cursor 301, the artist name search page 355, the cartridge stored data information indicating section 312 and the gage section 310 are displayed on the display unit 25. The artist name search page 355 includes an artist name table 352, an artist name entry box 354 and a character selection array 350.

If the user manipulates the mouse 27a to move the cursor 301 to a desired character of the character selection array 350 and clicks the mouse on the desired character, the desired character is input to the artist name entry box 354. Alternatively, characters can be input to the artist name entry box 354 with the keyboard 27b. When a character or a character string is input to the artist name entry box 354, the artist names including the character or the character string are displayed in the artist name table 352. The artist name table 352 contains includes the list of the artist names and title list buttons 347 corresponding thereto.

If the user manipulates the mouse 27a to move the cursor 301 to the title list button 347 corresponding to a preferred artist name and clicks the mouse on the title list button 347, the list of music titles of the artist (not shown in the figure) is opened. In the list of music titles, a selection button (not shown in the figure) is displayed corresponding to each music title. This selection button is similar to the selection button 349 of FIG. 44, and is pressed to display the download page 356.

Returning to FIG. 39, in step S610, the user terminal 5-N checks the input information from the user. In step S611, if a selection button 349 is pressed, the processing proceeds to step S612, otherwise proceeds to step S613. In step S612, the user terminal 5-N displays the download page 356 on the display unit 25, and the processing proceeds to step S613. Then, in step S613, if the download button, that is the “YES” button 360 of FIG. 45, is pressed, the processing proceeds to step S617, otherwise proceeds to step S614. Then, in step S614, if the end button 306 is pressed, the processing is terminated, otherwise proceeds to step S615.

Then, in step S615, if a link button is pressed, the processing proceeds to step S616, otherwise proceeds to step S610. In step S616, the user terminal 5-N displays the WEB page corresponding to the link button as pressed on the display unit 25, and the processing proceeds to step S610.

For example, a link button may be one of the ranking button 316, the new arrival button 318, the coming soon button 320, the new information button 322, the help button 324, the music search button 328, the music title button 334, the artist name button 336, the keyword button 338, the genre/year button 342, the number button 340, the selection button 349, the title list button 347 and the like.

By the way, in step S617, the user terminal 5-N downloads karaoke data from WEB server 1. Then, the user terminal 5-N outputs a karaoke data writing command to the writer 7-N. In response to this, the writer 7-N writes the karaoke data from the user terminal 5-N to the memory cartridge 13. After the write operation is completed, the processing proceeds to step S610.

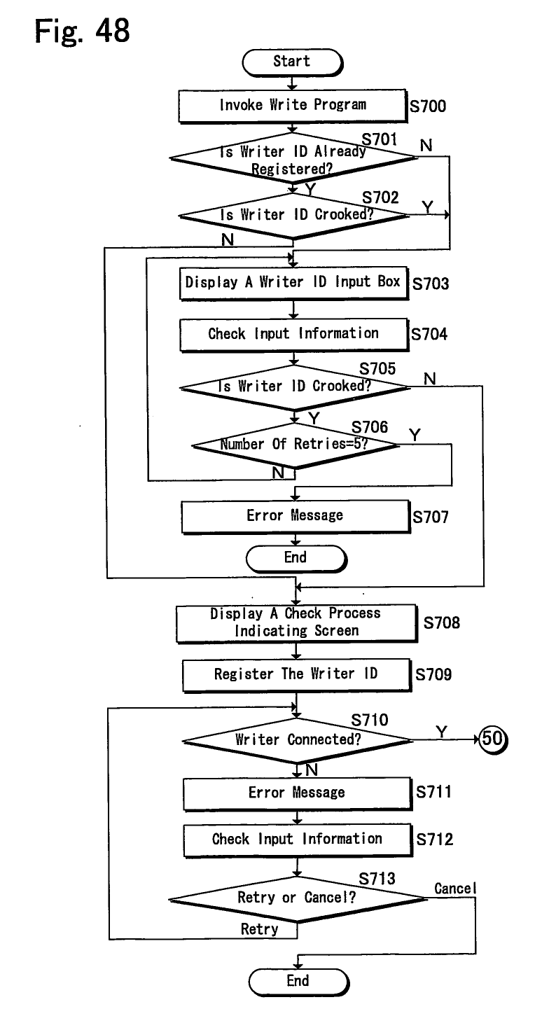

Next, the general outline of the process by the user terminal 5-N will be explained. FIG. 48 is a flowchart showing part of the process by the user terminal 5-N (mainly the process of checking the writer 7-N) in accordance with the embodiment 2 of the present invention. As shown in FIG. 48, the processor 53 of the user terminal 5-N invokes the write program in step S700. A writer control mechanism is formed by running the writer program by the processor 53. Namely, the user terminal 5-N functions as the writer control mechanism.

In step S701, the writer control mechanism accesses the auxiliary memory 55 to check whether or not the ID of the writer 7-N has been registered, and if registered the processing proceeds to step S702, otherwise proceeds to step 703. In step S702, the writer control mechanism checks whether or not the ID of the writer 7-N as registered is crooked, and if it is crooked the processing proceeds to step S703, otherwise (if proper) proceeds step S708.

In step S703, the writer control mechanism displays the ID entry screen 309 of the ID of the writer 7-N on the display unit 25. In step S704, the writer control mechanism checks the input ID as entered. In step S705, the writer control mechanism checks whether or not the ID is crooked. If it is not crooked (if proper) the processing proceeds to step S708, and if crooked the processing proceeds step S706.

In step S706, the writer control mechanism checks the number of times that the ID is input, and if the number reaches five the processing proceeds to step S707 in which the processing is terminated by displaying an error message. On the other hand, if less than five times the processing proceeds to step S703.

In step S708, the writer control mechanism displays the screen 311 indicating that the memory cartridge 13 is being checked on the display unit 25. In addition, the gage section 310 and the cartridge stored data information indicating section 312 are displayed on the display unit 25. However, since the contents of the memory cartridge 13 is unknown at this point, there is no specific information displayed in the cartridge stored data information indicating section 312 (refer to FIG. 41). In step S709, the writer control mechanism records (registers) the ID of the writer 7-N to the auxiliary memory 55.

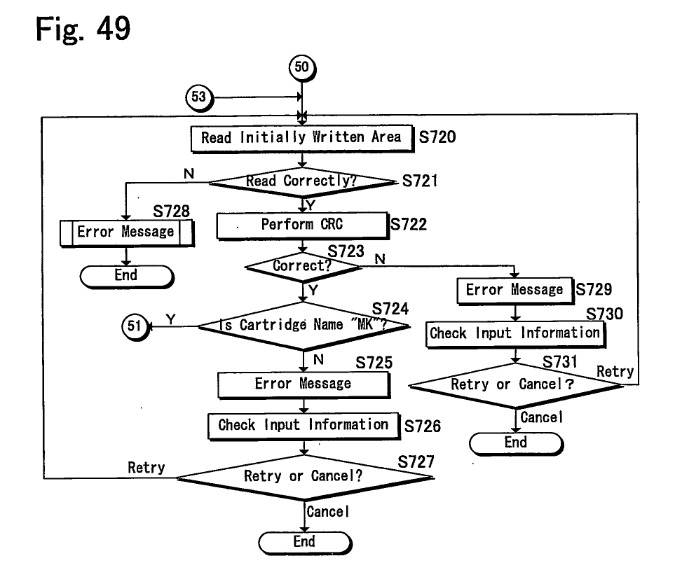

In step S710, the writer control mechanism checks whether or not the writer 7-N is connected to the user terminal 5-N, and if it is connected the processing proceeds to step S720 of FIG. 49, otherwise proceeds to step S711. In step S711, the writer control mechanism displays an error message indicating no writer connected and prompting to connect the writer 7-N, and the processing proceeds to step S712.

In step S712, the writer control mechanism checks the input information from the user. In step S713, the writer control mechanism performs step S710 if the input information indicates retry, otherwise terminates the processing if the input information indicating cancellation.

FIG. 49 is a flowchart showing the first half of the cartridge check process by the user terminal 5-N in accordance with the embodiment 2. As illustrated in FIG. 49, after step S710 of FIG. 48, the writer control mechanism accesses the writer 7-N in step S720, reads the information from the initially written area aw of the memory cartridge 13 as connected, and stores the information in the memory 50.

The writer control mechanism checks whether or not the information of the initially written area aw has been read without error in step S721, and if erroneously read the processing proceeds to step S728 in which an error message is displayed. Conversely, if the information has been read without error, the processing proceeds to step S722. In step S722, the writer control mechanism performs the CRC (cyclic redundancy check) for the information read from the initially written area aw. As a result, if the redundant bits are correct, the processing proceeds to step S724 otherwise proceeds to step S729.

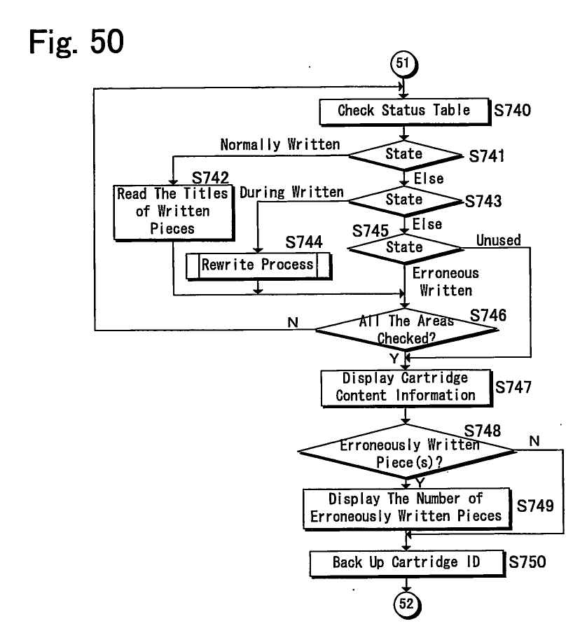

The writer control mechanism checks whether or not the name of the memory cartridge 13 is “MK” in step S724, and if “MK” the processing proceeds to step 740 of FIG. 50 to be described below, otherwise proceeds to step S725. Meanwhile, as discussed above, the name “MK” indicates that the memory cartridge 13 is provided for karaoke.

In step S725, in order to notify the user that the memory cartridge 13 as inserted is not provided for karaoke, the writer control mechanism displays a message indicative of the fact on the display device 25. In step S726, the writer control mechanism checks the input information from the user. In step S727, the writer control mechanism performs step S720 if the input information indicates retry, and terminates the processing if the input information indicating cancellation.

On the other hand, in order to notify the user that information cannot be read from the memory cartridge 13, the writer control mechanism displays a message indicative of the fact on the display device 25 in step S729. In step S730, the writer control mechanism checks the input information from the user. In step S731, the writer control mechanism performs step S720 if the input information indicates retry, and terminates the processing if the input information indicating cancellation.

FIG. 50 is a flowchart showing the latter half of the cartridge check process by the user terminal 5-N in accordance with the embodiment 2. In step S740, the writer control mechanism checks the status table (FIG. 36 and FIG. 38) contained in the information of the initially written area aw as read. More specifically speaking, the state flag (refer to FIG. 37) is checked.

If the writer control mechanism confirms that the state flag indicates the “normally written” state (step S741) the processing proceeds to step S742; if the state flag indicates the “during write” state (step S743) the processing proceeds to step S744; if the state flag indicates the “unused” state (step S745) the processing proceeds to step S747; and if the state flag indicates the “erroneously written” state (step S745) the processing proceeds to step S746. In step S746, the writer control mechanism determines whether or not the check of the state flags corresponding to all the blank areas a1-ak is completed, and if not completed the processing proceeds to step S740, otherwise proceeds to step S747. Incidentally, in the case of the present embodiment, karaoke data is written in the blank area ak in increasing order of the number thereof.

By the way, in step S742, the writer control mechanism accesses the writer 7-N, read the information about the music titles (refer to FIG. 38) which are properly written in the blank area ak of the memory cartridge 13 as inserted, and stores the information to the memory 50. Processing then proceeds to step S746. On the other hand, in step S744, the writer control mechanism has the writer 7-N write again the data which has been written halfway in the blank area ak, and then the processing proceeds to step S746.

When the check of the state flags corresponding to all the blank areas ak is finished, or when an unused blank area aK is detected, the writer control mechanism displays, in step S747, the stored data information of the memory cartridge 13 (the memory cartridge type, the number of the written music pieces, the number of additional music pieces which can be further written and the cartridge information table 314) in the cartridge stored data information indicating section 312 on the display unit 25 (refer to FIG. 42). In step S748, if the writer control mechanism confirms that there is a blank area ak in which data is erroneously written, the processing proceeds to step S749, otherwise proceeds to step S750. In step S749, the writer control mechanism displays the number of music pieces as erroneously written in the cartridge stored data information indicating section 312.

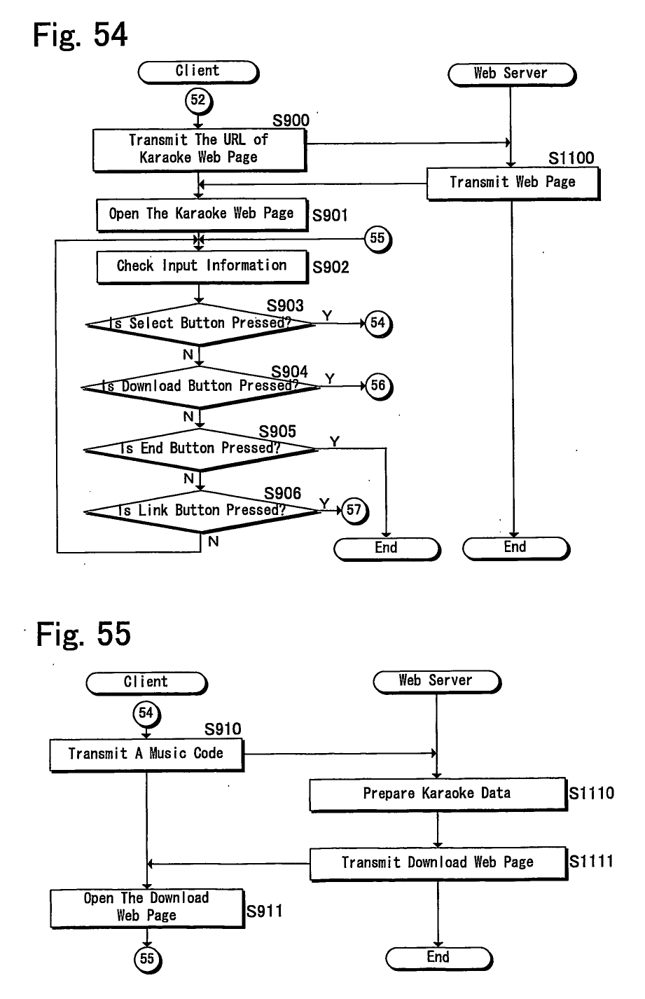

In step S750, the writer control mechanism saves the ID of the memory cartridge 13 stored in the memory 50 in a predetermined location of the auxiliary memory 55, and the processing proceeds to step S900 of FIG. 54 to be described below.

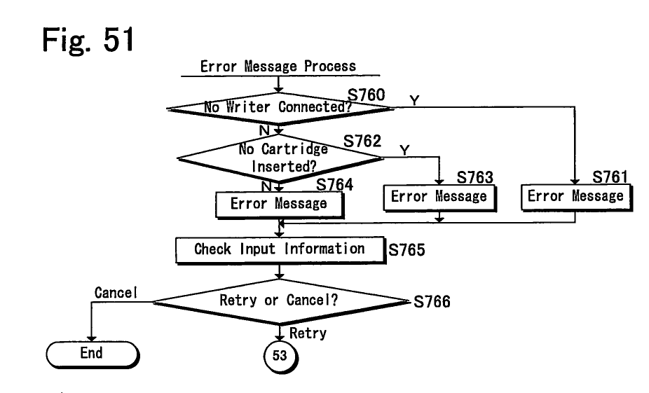

FIG. 51 is a flowchart showing the process flow of displaying an error message in step S728 of FIG. 49. As shown in FIG. 51, the writer control mechanism checks whether or not the writer 7-N is connected to the user terminal 5-N in step S760. If it is not connected the processing proceeds to step S761, and if it is connected the processing proceeds to step S762. In order to notify the user that the writer 7-N is not connected, the writer control mechanism displays a message indicative of the fact on the display device 25 in step S761, and then the processing proceeds to step S765.

On the other hand, the writer control mechanism checks whether or not the memory cartridge 13 is inserted into the writer 7-N in step S762. If it is not inserted the processing proceeds to step S763, and if it is inserted the processing proceeds to step S764. In order to notify the user that the memory cartridge 13 is inserted, the writer control mechanism displays a message indicative of the fact on the display device 25 in step S763, and then the processing proceeds to step S765.

On the other hand, in step S764, in order to notify the user that the information of the memory cartridge 13 cannot be read, the writer control mechanism displays a message indicative of the fact on the display device 25, and then the processing proceeds to step S765.

In step S765, the writer control mechanism checks the input information from the user. In step S766, if the writer control mechanism confirms that the input information indicates retry the processing proceeds to step S720 of FIG. 49; and if the input information indicating cancel the processing is terminated.

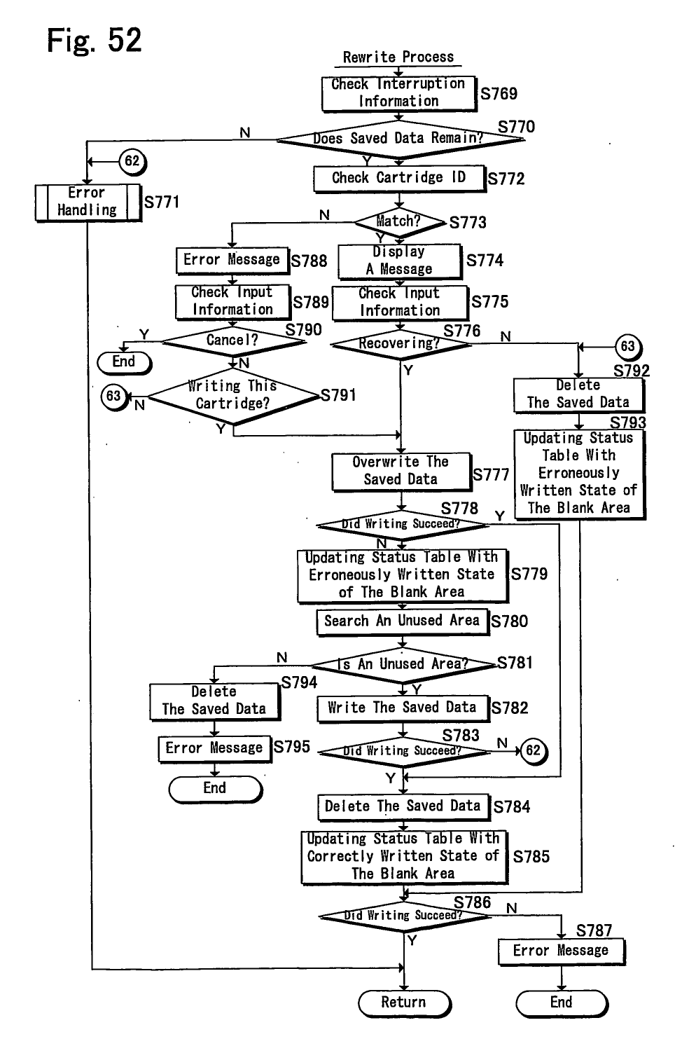

FIG. 52 is a flowchart showing the process flow of the retry writing process in step S744 of FIG. 50. In step S769, the writer control mechanism accesses the auxiliary memory 55, and checks interruption information. The interruption information is a flag which indicates “true” if there is any saved karaoke data relating to an interrupted write operation in the auxiliary storage device 55, otherwise indicates “false”. The interruption of the write operation occurs, for example, in the case where the memory cartridge 13 is removed from the writer 7-N during the write operation or in the case where the cable 15 is extracted from the user terminal 5-N or the writer 7-N.

In step S770, the writer control mechanism performs step S772 if there is any saved karaoke data relating to an interrupted write operation in the auxiliary storage device 55, otherwise performs step S771. In step S771, the writer control mechanism performs an error handling process, and returns the control.

On the other hand, in step S772, the writer control mechanism compares the ID of the memory cartridge 13 stored in the predetermined location of the auxiliary storage device 55 with the ID of the memory cartridge 13 saved in the memory 50. This comparison is performed with the following assumption.

That is, while the user terminal 5-1 is writing the karaoke data corresponding to a music title A to the memory cartridge 13 having an ID of “0”, the memory cartridge 13 is removed from the writer 7-1 to leave the corresponding blank area ak in the “during write” state. Thereafter, the writer program is terminated. In this case, the ID of “0” is saved in the predetermined location of the auxiliary storage device 55 of the user terminal 5-1 in step S750 of FIG. 50.

On the other hand, while another user terminal 5-2 is writing the karaoke data corresponding to a music title B to another memory cartridge 13 having an ID of “1”, this memory cartridge 13 is removed from the writer 7-2 to leave the corresponding blank area ak in the “during write” state. Thereafter, the writer program is terminated. In this case, the ID of “1” is saved in the predetermined location of the auxiliary storage device 55 of the user terminal 5-2 in step S750 of FIG. 50.

In this situation, the user inserts the memory cartridge 13 having the ID of “1” into the writer 7-1 connected to the user terminal 5-1. Then, as can be seen from FIG. 50, since step S744 is done before step S750, in step S772 of FIG. 52, the comparison is performed in such a situation between the ID “1” of the memory cartridge currently inserted into the writer 7-1 (i.e., having incomplete data of the music title B because of interruption of the write operation) and the ID “0” of the memory cartridge previously inserted into the writer 7-1 (i.e., having incomplete data of the music title A because of interruption of the write operation).

The process of step S772 is introduced taking into consideration the above situation.

Next, if these IDs match in step S773, the writer control mechanism performs step S774, otherwise performs step S788.

In step S774, the writer control mechanism displays on the display device 25 a message that the memory cartridge 13 contains incomplete karaoke data written halfway, together with a button for confirming intention of restoring the data. In step S775, the writer control mechanism checks the input information from the user. In step S776, the writer control mechanism performs step S777 if input information indicates the intention of restoring, and performs step S792 if input information indicates the intention of not restoring.

In step S777, the writer control mechanism overwrites karaoke data stored in the writer 7-N on the blank area ak where the previous write operation is interrupted. In step S778, the writer control mechanism checks whether or not the write operation is completed without error. If completed without error, the processing proceeds to step S784, otherwise proceeds to step S779.

In step S779, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “erroneously written” state.

In step S780, the writer control mechanism searches for an unused blank area aK. If there is no unused blank area aK in step S781, the writer control mechanism performs step S794. Then, in step S794, the writer control mechanism erases the karaoke data stored in the auxiliary memory 55, followed by performing step S795 for displaying a message that there is no free space for writing on the display unit 25, and then terminates the processing.

On the other hand, if there is an unused blank area aK in step S781, the writer control mechanism performs step S782. In step S782, the writer control mechanism has the writer 7-N write the karaoke data stored in the auxiliary memory 55 on the unused blank area aK. The writer control mechanism then checks in step S783 whether or not the write operation to the memory cartridge 13 is completed without error. If the write operation is erroneously performed, the processing proceeds to step S771. Conversely, if the write operation completed without error, the processing proceeds to step S784.

In step S784, the writer control mechanism erases the karaoke data saved in the auxiliary memory 55. In step S785, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “normally written” state. In step S786, the writer control mechanism checks whether or not the status table of the memory cartridge 13 is updated without error, returns the control if updated without error, and performs step S787 if erroneously updated for displaying a message that write operation cannot be performed to the memory cartridge 13 followed by terminating the processing.

By the way, if the input information indicates the intention of not restoring in step S776, the processing proceeds to step S792. In step S792, the writer control mechanism erases the karaoke data stored in the auxiliary memory 55. In step S793, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “erroneously written” state. Thereafter, the processing proceeds to step S786.

On the other hand, in step S788, the writer control mechanism displays an error message on the display unit 25. For example, this error message is such that “there is an incomplete music piece B written halfway, but it can not be restored because it is different from the music piece A as saved during write operation. The music piece A can be written to this cartridge by clicking “YES”. Alternatively, the music piece A can be written to the cartridge to which the music piece A was previously written halfway by clicking “CANCEL” and restarting the writer program. The karaoke data of the music piece A is erased after clicking “NO”.

In step S789, the writer control mechanism checks the input information from the user. The writer control mechanism terminates the process if the input information indicates “CANCEL” in step S790, otherwise the processing proceeds to step S791. The writer control mechanism performs step S777 if the input information indicates “YES” in step S791, and performs step S792 if the input information indicates “NO”.

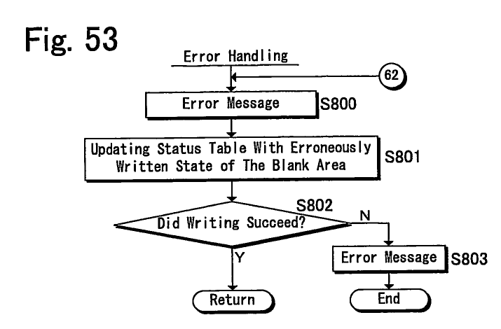

FIG. 53 is a flowchart showing the process flow of the error handling of step S771 of FIG. 52. As shown in FIG. 53, in step S800, the writer control mechanism displays on the display unit 25 a message that the memory cartridge 13 contains incomplete karaoke data written halfway and that the karaoke data cannot be restored. However, after confirming “NO” in step S783 of FIG. 52, the writer control mechanism displays a message that the write operation is impossible on the display unit 25 in step S800.

In step S801, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “erroneously written” state. In step S802, the writer control mechanism checks whether or not the status table of the memory cartridge 13 is updated without error, returns the control if updated without error, and performs step S803 if erroneously updated for displaying a message that write operation cannot be performed to the memory cartridge 13 followed by terminating the processing.

FIG. 54 is a flowchart showing the process flow of the write control process by the user terminal 5-N in accordance with the embodiment 2. As shown in FIG. 54, after step S748 or step S749 of FIG. 50, the writer control mechanism invokes a browser program in step S900. The browser is launched by running the browser program by the processor 53. Namely, the user terminal 5-N functions as the browser and the writer control mechanism. Incidentally, the writer control mechanism and the browser can operate independent from each other (in parallel) by multitask. Then, the browser transmits the URL of the karaoke web page 330 to WEB server 1.

In response to this, in step S1100, the WEB server 1 transmits the karaoke web page 330. Then, in step S901, the browser displays the karaoke web page 330 on the display unit 25 (refer to FIG. 42). In step S902, the writer control mechanism and the browser check the input information from the user.

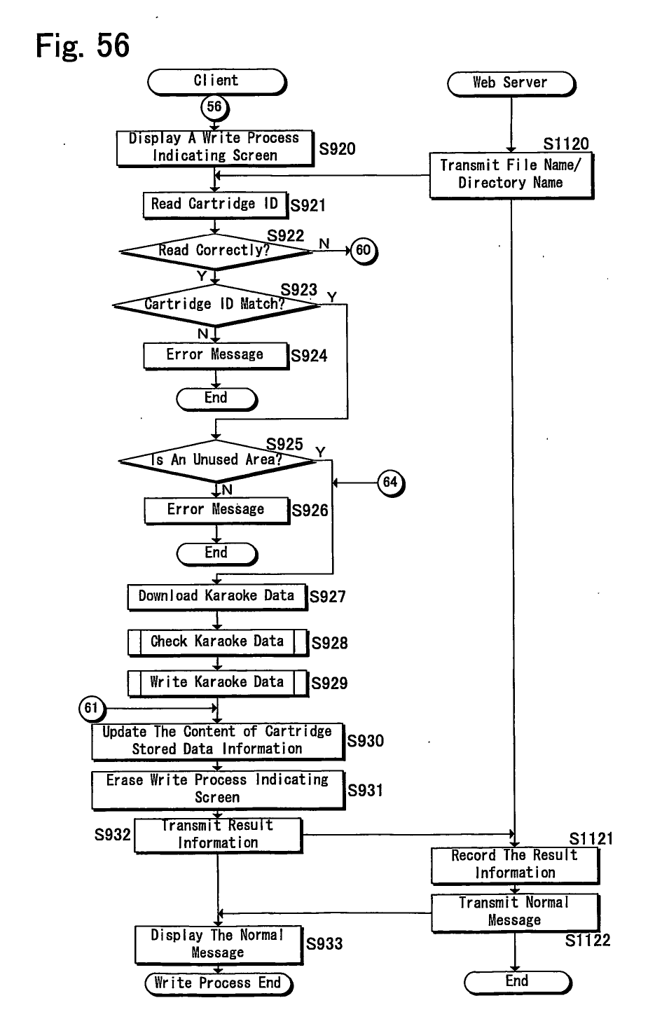

If a selection button 349 is pressed in step S903, the browser performs step S910 of FIG. 55 to be described below. If the “YES” button (download button) 360 is pressed in step S904 to start download, the browser performs step S920 of FIG. 56 to be described below. If the exit button 306 is pressed in step S905, the browser terminates the processing. If a link button is pressed in step S906, the browser performs step S1000 of FIG. 61 to be described below. If neither button is pressed, the processing proceeds to step S902.

FIG. 55 is a flowchart showing the process flow after a selection button 349 is pressed in step S903 of FIG. 54. As shown in FIG. 55, the browser transmits the music code corresponding to the selection button 349 as pressed to WEB server 1 in step S910. Then, in step S1110, the WEB server 1 acquires the karaoke data corresponding to the music code received from the database server 3, and saves the karaoke data in the auxiliary memory. In step S911, the WEB server 1 transmits the download page 356. Then, in step S911, the browser displays the download page 356 on the display unit 25 (refer to FIG. 45). Thereafter, the processing proceeds to step S902 of FIG. 54.

FIG. 56 is a flowchart showing the process flow after the “YES” button (download button) 360 is pressed in step S904 of FIG. 54. As shown in FIG. 56, the writer control mechanism displays the write process indicating screen 313 on the display unit 25 in step S920 (refer to FIG. 46). In other words, the writer control mechanism overlays the write process indicating screen 313 on the screen which browser displays. On the other hand, when the “YES” button (download button) 360 is pressed, the Web server 1 transmits in step S1120 the file name and directory name of the karaoke data prepared in step S1110 of FIG. 55 to the user terminal 5-N.

In step S921, the writer control mechanism accesses the writer 7-N to read the ID of the memory cartridge 13. In step S922, the writer control mechanism determines whether or not the ID is read without error. If erroneously read, the processing proceeds to step S1010 of FIG. 64 to be described below, and if read without error, the processing proceeds to step S923.

In step S923, the writer control mechanism compares the ID of the memory cartridge 13 stored in the memory 50 and contained in the information of the initially written area aw and the ID of the memory cartridge 13 as read in step S921 in order to determine the match therebetween. If they match, the processing proceeds to step S925, and if they do not match, the processing proceeds to step S924 for displaying a message that the memory cartridge 13 is replaced during operation on the display unit 25 followed by terminating the processing.

In step S925, the writer control mechanism checks whether or not there is an unused blank area aK by referring to the status table stored in the memory 50 and contained in the information of the initially written area aw. If there is an unused blank area aK, the processing proceeds to step S927, and if there is no unused blank area aK, the processing proceeds to step S926 for displaying a message that the maximum writable number of music pieces have been already written to the memory cartridge 13 and there is no free space on the display unit 25 followed by terminating the processing.

In step S927, the writer control mechanism downloads karaoke data from WEB server 1 on the basis of the file name and the directory name transmitted by WEB server 1 in step S1120. In step S928, the writer control mechanism checks the karaoke data as downloaded, and if it is proper, the processing proceeds to step S929.

In step S929, the writer control mechanism has the writer 7-N write the karaoke data as downloaded to the memory cartridge 13.

In step S930, the writer control mechanism updates the content of the cartridge stored data information indicating section 312. In step S931, the writer control mechanism erases the write process indicating screen 313. As a result, the screen displayed by the browser appears in the position where the write process indicating screen 313 is displayed.

In step S932, the writer control mechanism transmits the result information (the music code of the karaoke data as written, the ID of the memory cartridge 13 to which the karaoke is written, and a code indicating that the write operation is completed without error) to WEB server 1. In step S1121, the Web server 1 records the result information. By this configuration, it is possible to register which music piece is written and how many times the music piece is written without error, and therefore to calculate appropriate copyright fees.

In step S1122, the WEB server 1 transmits a normal message indicating that the write operation is completed without error to the user terminal 5-N. Then, in step S933, the browser displays the normal message on the display unit 25.

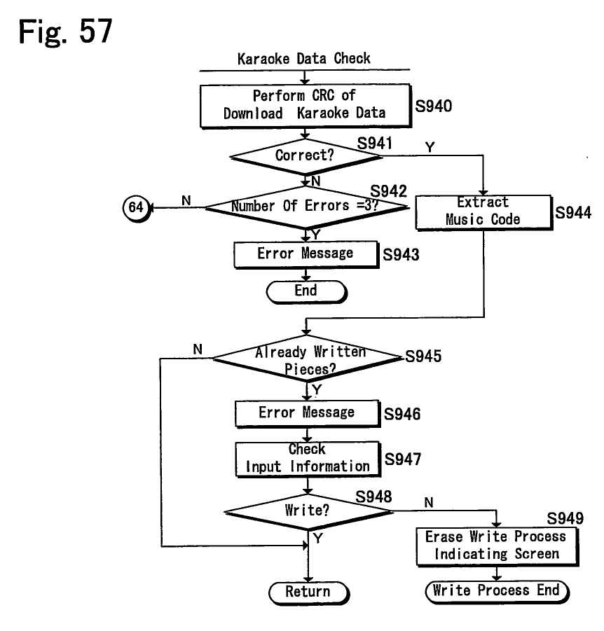

FIG. 57 is a flowchart showing the process flow of the karaoke data check process of step S928 of FIG. 56. As shown in FIG. 57, the writer control mechanism performs the CRC for the downloaded karaoke data in step S940. If the redundant bits are correct in step S941, the writer control mechanism performs step S944 to extract a music code from the karaoke data, and then performs step S945. On the other hand, if the redundant bits are incorrect, the processing proceeds to step S942. The writer control mechanism counts the number of errors in step S942, and if the number of errors is “3” the processing proceeds to step S943 for displaying a message that the karaoke data cannot be used on the display device 25, followed by terminating the processing. On the other hand, if the number of errors is smaller than “3”, the processing proceeds to step S927 of FIG. 56.

By the way, in step S945, the writer control mechanism determines whether or not the karaoke data is already written to the memory cartridge 13 with reference to the music code as extracted. If not written yet the control is returned. Conversely, if already written, the processing proceeds to step S946.

In step S946, the writer control mechanism displays on the display unit 25 a message that the karaoke data as downloaded is already written together with a button for confirming whether or not the karaoke data is to be written again. In step S947, the writer control mechanism checks the input information from the user. If the input information indicates in step S948 that the karaoke data is to be written again, the control is returned, otherwise the processing proceeds to step S949. In step S949, the writer control mechanism erases the write process indicating screen 313 to exit the write process. As a result, the screen displayed by the browser appears in the position where the write process indicating screen 313 is displayed.

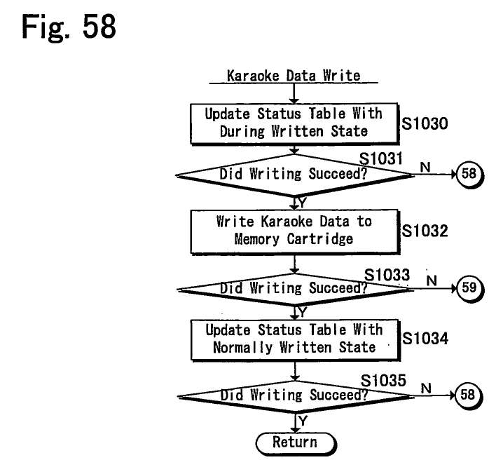

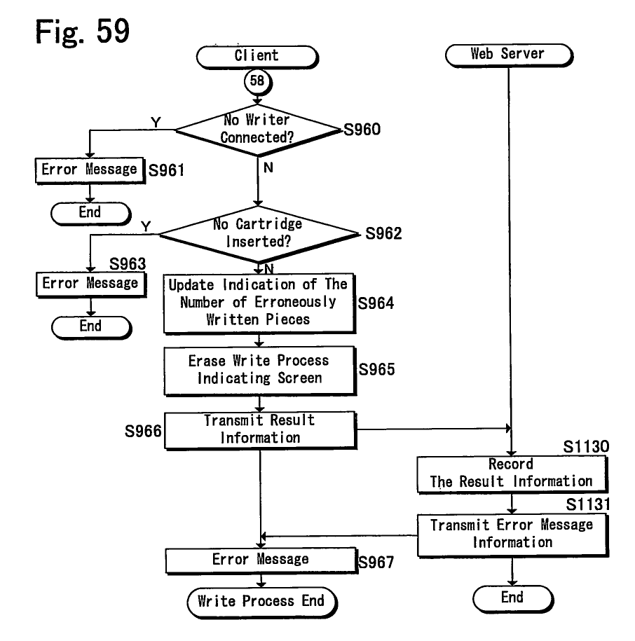

FIG. 58 is a flowchart showing an example of the karaoke data writing process of step S929 of FIG. 56. As shown in FIG. 58, in step S1030, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to “11111110” indicative of the “during written” state. In step S1031, the writer control mechanism checks whether or not the status table of the memory cartridge 13 is updated without error, performs step S960 of FIG. 59 to be described below if erroneously updated, and performs step S1032 if updated without error.

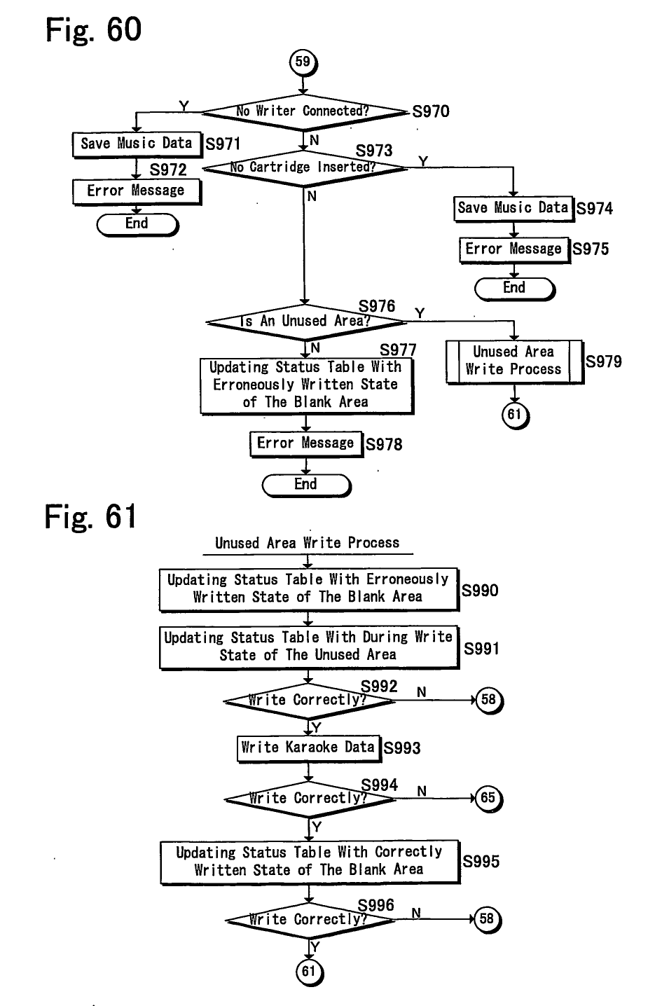

In step S1032, the writer control mechanism has the writer 7-N write the karaoke data as downloaded in an unused blank area aK. The writer control mechanism then checks in step S1033 whether or not the write operation to the memory cartridge 13 is completed without error, and if the write operation is erroneously performed the processing proceeds to step S970 of FIG. 60 to be described below, otherwise proceeds to step S1034.

In step S1034, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to “11111100” indicative of the “normally written” state.

The writer control mechanism then checks in step S1035 whether or not the write operation to the memory cartridge 13 is completed without error. If the write operation is erroneously performed, the processing proceeds to step S960 of FIG. 59 to be described below, and if completed without error, the control is returned.

FIG. 59 is a flowchart showing the process flow after it is determined that the write operation is erroneously performed in step S1031 and step S1035 of FIG. 58. As shown in FIG. 59, the writer control mechanism checks whether or not the writer 7-N is connected to the user terminal 5-N in step S960. If it is not connected the processing proceeds to step S961 for displaying a message indicating that the writer 7-N is not connected on the display device 25. On the other hand, if it is connected the processing proceeds to step S962.

In step S962, the writer control mechanism checks whether or not the memory cartridge 13 is inserted into the writer 7-N. If it is not inserted the processing proceeds to step S963, and if it is connected the display device 25 displays a message indicating that the memory cartridge 13 is not connected, followed by terminating the processing. On the other hand, if it is inserted the processing proceeds to step S964.

In step S964, the writer control mechanism updates the indication of the number of music pieces which are erroneously written. In step S965, the writer control mechanism erases the write process indicating screen 313. As a result, the screen displayed by the browser appears in the position where the write process indicating screen 313 is displayed.

In step S966, the writer control mechanism transmits the result information (the music code of the karaoke data as downloaded, the ID of the memory cartridge 13 as erroneously written, and a code indicating that the write operation is erroneously performed) to WEB server 1.

Then, in step S1130, the WEB server 1 records the result information. In step S1131, the WEB server 1 transmits error message information indicating that the write operation cannot be performed to the user terminal 5-N. Then, in step S967, the browser displays the error message on the display unit 25.

FIG. 60 is a flowchart showing the process flow after it is determined that the write operation is erroneously performed in step S1033 of FIG. 58. As shown in FIG. 60, the writer control mechanism checks whether or not the writer 7-N is connected to the user terminal 5-N in step S970. If it is not connected, the processing proceeds to step S971 in which the karaoke data as downloaded is saved in the auxiliary storage device 55 and then proceeds to step S972 in which a message indicating that the writer 7-N is not connected is displayed on the display device 25, followed by terminating the processing. On the other hand, if it is connected, the processing proceeds to step S973.

In step S973, the writer control mechanism checks whether or not the memory cartridge 13 is inserted into the writer 7-N. If it is not inserted, the processing proceeds to step S974 in which the karaoke data as downloaded is saved in the auxiliary memory 55 and then proceeds to step S975 in which a message indicating that the memory cartridge 13 is not inserted is displayed on the display device 25, followed by terminating the processing. On the other hand, if it is inserted, the processing proceeds to step S976.

In step S976, the writer control mechanism searches for an unused blank area aK. If there is an unused blank area aK, the processing proceeds to step S979 in which the karaoke data as downloaded is written in the unused blank area ak and then proceeds to step S930 of FIG. 56. On the other hand, if there is not an unused blank area aK, the processing proceeds to step S977.

In step S977, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “erroneously written” state. In step S978, the writer control mechanism displays a message that the maximum writable number of music pieces have been already written to the memory cartridge 13 and there is no free space on the display unit 25 followed by terminating the processing.

FIG. 61 is a flowchart showing the process flow of writing data in an unused area in step S979 of FIG. 60. As shown in FIG. 61, in step S990, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “erroneously written” state.

In step S991, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the unused blank area ak to the “during written” state.

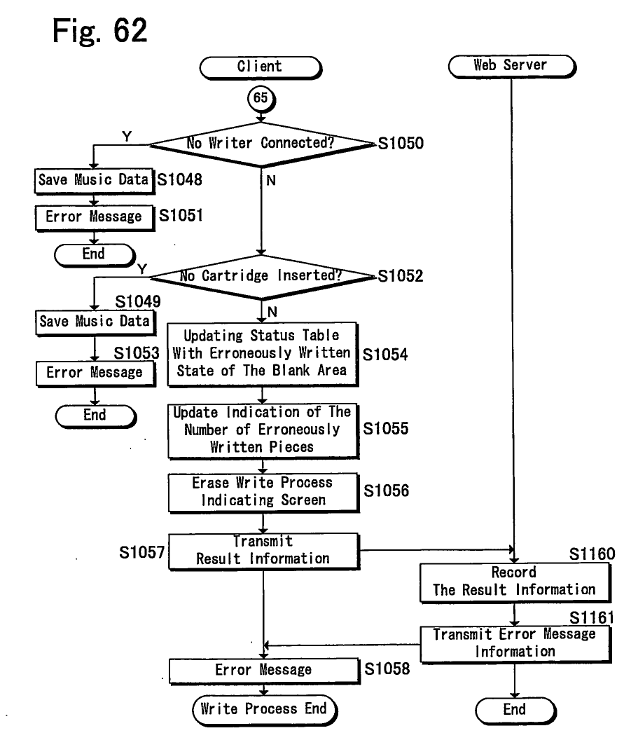

In step S992, the writer control mechanism checks whether or not the status table of the memory cartridge 13 is updated without error, performs step S960 of FIG. 59 if erroneously updated, and performs step S993 if updated without error. In step S993, the writer control mechanism has the writer 7-N write the karaoke data in an unused blank area aK. In step S994, the writer control mechanism checks whether or not the write operation is completed without error. If the write operation is erroneously performed the processing proceeds to step S1050 of FIG. 62 to be described below, and if completed without error, the processing proceeds to step S995.

In step S995, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the value indicative of the “normally written” state. In step S996, the writer control mechanism checks whether or not the status table of the memory cartridge 13 is updated without error, performs step S960 of FIG. 59 if erroneously updated, and performs step S930 of FIG. 56 if updated without error.

FIG. 62 is a flowchart showing the process flow after it is determined that the write operation is erroneously performed in step S994 of FIG. 61. As shown in FIG. 62, the writer control mechanism checks whether or not the writer 7-N is connected to the user terminal 5-N in step S1050. If it is not connected, the processing proceeds to step S1048 in which the karaoke data as downloaded is saved in the auxiliary storage device 55 and then proceeds to step S1051 in which a message indicating that the writer 7-N is not connected is displayed on the display device 25, followed by terminating the processing. On the other hand, if it is connected, the processing proceeds to step S1052.

In step S1052, the writer control mechanism checks whether or not the memory cartridge 13 is inserted into the writer 7-N. If it is not inserted, the processing proceeds to step S1049 in which the karaoke data as downloaded is saved in the auxiliary memory 55 and then proceeds to step S1053 in which a message indicating that the memory cartridge 13 is not inserted is displayed on the display device 25, followed by terminating the processing. On the other hand, if it is inserted, the processing proceeds to step S1054.

In step S1054, the writer control mechanism updates the status table contained in the information of the initially written area aw as stored in the memory 50, and furthermore has the writer 5-N overwrite the status table as updated on the status table of the initially written area aw. More specifically speaking, the status table is updated by setting the state flag corresponding to the blank area ak in question to the “erroneously written” state.

In step S1055, the writer control mechanism updates the indication of the number of music pieces which are erroneously written. In step S1056, the writer control mechanism erases the write process indicating screen 313. As a result, the screen displayed by the browser appears in the position where the write process indicating screen 313 is displayed.

In step S1057, the writer control mechanism transmits the result information (the music code of the karaoke data as downloaded, the ID of the memory cartridge 13 as erroneously written, and a code indicating that the write operation is erroneously performed) to WEB server 1.

Then, in step S1160, the WEB server 1 records the result information. In step S1161, the WEB server 1 transmits error message information indicating that the write operation cannot be performed to the user terminal 5-N. Then, in step S1058, the browser displays the error message on the display unit 25.

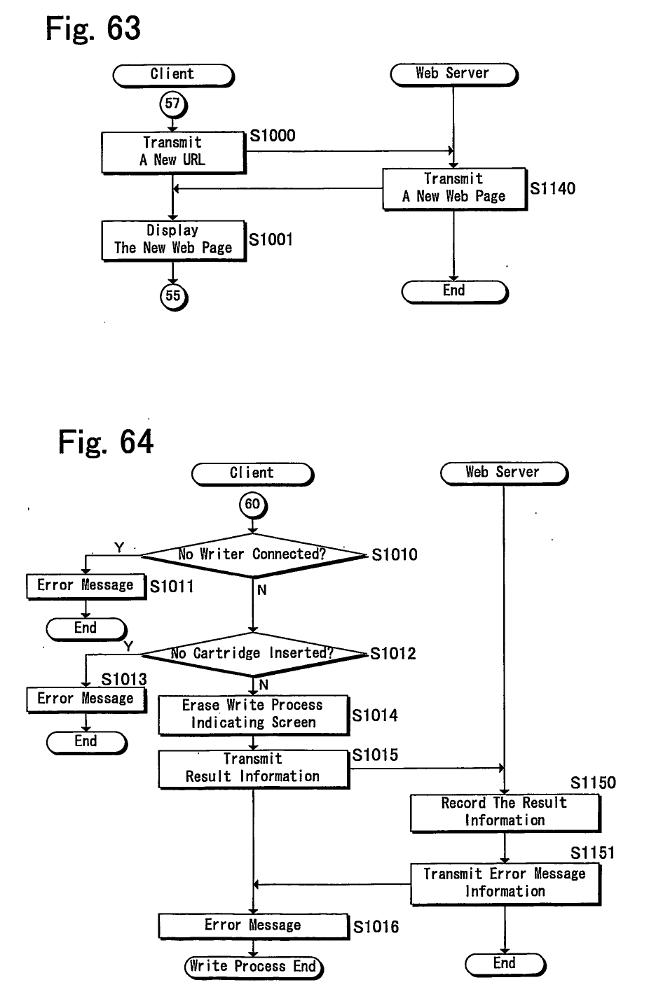

FIG. 63 is a flowchart showing the process flow after a link button is pressed in step S906 of FIG. 54. As shown in FIG. 63, in step S1000, the browser transmits the URL corresponding to the link button as pressed to the WEB server 1. In response to this, in step S1140, the WEB server 1 transmits the WEB page corresponding to the received URL to the user terminal 5-N. Then, in step S1001, the browser displays the WEB page transmitted by WEB server 1 on the display unit 25, and the processing proceeds to step S902 of FIG. 54.

FIG. 64 is a flowchart showing the process flow after it is determined that the read operation is erroneously performed in step S922 of FIG. 56. As shown in FIG. 64, the writer control mechanism checks whether or not the writer 7-N is connected to the user terminal 5-N in step S1010. If it is not connected, the processing proceeds to step S1011 in which a message indicating that the writer 7-N is not connected is displayed on the display device 25, followed by terminating the processing. On the other hand, if it is connected the processing proceeds to step S1012.

In step S1012, the writer control mechanism checks whether or not the memory cartridge 13 is inserted into the writer 7-N. If it is not inserted, the processing proceeds to step S1013 in which a message indicating that the memory cartridge 13 is not inserted is displayed on the display device 25, followed by terminating the processing. On the other hand, if it is inserted, the processing proceeds to step S1014.

In step S1014, the writer control mechanism erases the write process indicating screen 313. As a result, the screen displayed by the browser appears in the position where the write process indicating screen 313 is displayed.

In step S1015, the writer control mechanism transmits the result information (the music code of the karaoke data corresponding to the selection button 349 as pressed, the ID of the memory cartridge 13 contained in the information of the initially written area stored in the memory 50, and a code indicating that the write operation is completed without error) to WEB server 1.

In step S1150, the WEB server 1 records the result information. In step S1151, the WEB server 1 transmits error message information indicating that the read operation is erroneously performed to the user terminal 5-N. Then, in step S1016, the browser displays the error message on the display unit 25.

In this case, the process flow in the writing service terminal 9-M is similar to the process flow as illustrated in FIG. 39 and FIG. 48 to FIG. 64. However, the writer 7-N is not involved in the process of the writing service terminal 9-M, and therefore the process relating to the writer 7-N is not performed.

By the way, in the case of the present embodiment as discussed above, the built-in memory of the memory cartridge 13 is the OTPROM 17 that can only be written once. This is same as in the embodiment 1. Accordingly, also in the karaoke data delivery system of the present embodiment, there are the same advantages as in the karaoke data delivery system of the embodiment 1.

Incidentally, the present invention is not limited to the above embodiments, and a variety of variations and modifications may be effected without departing from the spirit and scope thereof, as described in the following exemplary modifications.

(1) The user terminal 5-N can be configured to notify the Web server 1 of the situation that the writer 7-N is not connected thereto. Also, the user terminal 5-N and/or the writing service terminal 9-M can be configured to notify the Web server 1 of the situation that the memory cartridge 13 is not inserted.

By this configuration, the Web server 1 can be informed of the situation that the writer 7-N is not connected and that the memory cartridge 13 is not inserted, and take an appropriate procedure to deal therewith. For example, the Web server 1 can be configured not to deliver karaoke data in such a situation.

(2) The client terminal can be configured to display on the display device 25 or 31 a message that the karaoke data which is about to be written to the memory cartridge 13 matches karaoke data which has already been written to the memory cartridge 13 when such a match occurs. By this configuration, since the user is directly informed that he is about to redundantly write the same karaoke data as already written, it is possible to provide a more user-friendly service.

(3) While the writer 7-N is connected to the user terminal 5-N by the cable 15 in the case of the above embodiments, wireless connection can be used instead.

(4) While the Web server 1 delivers karaoke data as an example of data for delivery in accordance with the above embodiments, the data type is not limited thereto. For example, data for delivery may be game data (game programs, game image data, game music data and the like), image data such as movies, music data such as hit music, programs, and a variety of other data types.

Accordingly, the user can use the data delivery service with ease and security by selecting his favorite data from among a variety of data. In other words, while users tend to like to get only favorite data, their desire can be satisfied.

(5) The WEB server 1 is described as an exemplary server in the case of the above embodiments. However, the server is not limited to the Web server 1 and therefore an FTP (file transfer protocol) server can be used for the same purpose.

(6) In FIG. 34, the processor 184 can be configured to perform the function of the communication control unit 188.

(7) While the OTPROM 17 is used as a recordable medium in the case of the above embodiments, the recordable medium is not limited to this. The present invention can be implemented if a recordable medium which can only be written once is used, or if some once only restriction can be established on the recordable medium (if rewriting can be inhibited) by suitably designing the writing mechanism (for example, the writer 7-N or the writing service terminal 9-M).

(8) The communication procedure as discussed above is only illustrative but not limited to this.

(9) Some processes in the client terminal side can be taken by the Web server 1 instead, and conversely some processes in the Web server side can be taken by the client terminal instead. That is, the respective processes such as the generation of a display image can arbitrarily be allocated therebetween by the system designer.

(10) While the user terminal 5-N and the writing service terminal 9-M are described as exemplary client terminals, the client terminals are not limited thereto. For example, the client terminal may be a mobile telephone, a PDA (personal digital assistant), and another information communication device. Also, as long as equipped with a data communication facility, a household appliance such as a television may serve as the client terminal.

(11) While any appropriate processor can be used as the high speed processor 184 of FIG. 34, it is preferred to use the high speed processor (trade name: XaviX) in relation to which the applicant has been filed patent applications. The details of this high speed processor are disclosed, for example, in Jpn. unexamined patent publication No. 10-307790 and U.S. Pat. No. 6,070,205 corresponding thereto.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. A data delivery system comprising:
a server that delivers data through a network;
a client terminal that receives said data as delivered; and
a writer unit that writes said data received by said client terminal to a recordable medium,
wherein said writer unit writes said data in an area of storage areas of said recordable medium, in which data is not written, under a once only restriction.

2. The data delivery system as claimed in claim 1 wherein said writer unit writes said data in the area of the storage areas of said recordable medium in which data is not written yet in units of a predetermined size under the once only restriction.

3. The data delivery system as claimed in claim 1 wherein said client terminal transmits predetermined information to said server when the write operation to said recordable medium is successfully completed.

4. The data delivery system as claimed in claim 1 wherein said server transmits said data to said client terminal when information about said recordable medium indicates a free space having a size larger than that of said data as requested for delivery.

5. The data delivery system as claimed in claim 1 wherein said client terminal erases said data which is temporarily saved for writing when the write operation to said recordable medium is successfully completed.

6. The data delivery system as claimed in claim 1 wherein said client terminal transmits identification information of said recordable medium to said server.

7. The data delivery system as claimed in claim 1 wherein said client terminal displays information about the data already written to said recordable medium and a maximum size of data which can be written to a free space of said recordable medium.

8. The data delivery system as claimed in claim 1 wherein said client terminal displays a message that the data which is about to be written to said recordable medium matches data which has already been written to said recordable medium when such a match occurs.

9. The data delivery system as claimed in claim 1 wherein said client terminal and said writer unit are separately provided and connected to each other by a wired or wireless link.

10. The data delivery system as claimed in claim 9 wherein said client terminal displays a first predetermined indication when said writer unit is not connected to said client terminal and a second predetermined indication when said recordable medium is not connected to said writer unit.

11. The data delivery system as claimed in claim 9 wherein said writer unit is implemented within a microphone type karaoke device.

12. The data delivery system as claimed in claim 1 wherein said client terminal and said writer unit are integrally provided.

13. The data delivery system as claimed in claim 12 wherein when said recordable medium is not connected to said writer unit said client terminal displays a predetermined indication.

14. The data delivery system as claimed in claim 1 wherein said data requested by said client terminal to said server is music data.

15. The data delivery system as claimed in claim 1 wherein said data requested by said client terminal to said server is music data, and wherein said client terminal displays information about music pieces already written to said recordable medium and a number of music pieces which can be written to a free space of said recordable medium.

16. The data delivery system as claimed in claim 1 wherein said data requested by said client terminal to said server is music data and image data of karaoke.

17. The data delivery system as claimed in claim 1 wherein said data requested by said client terminal to said server is game data.

18. The data delivery system as claimed in claim 1 wherein said recordable medium is a recordable medium to which data can only be written once in an area in which no data is written yet.

19. The data delivery system as claimed in claim 1 wherein data for use in processing the data that is delivered and written to said recordable medium is initially written to said recordable medium.

20. A data acquisition device comprising:
a client terminal that receives data delivered by a server through a network;
a writer unit that writes said data received by said client terminal to a recordable medium,
wherein said writer unit writes said data in an area of storage areas of said recordable medium, in which data is not written, under a once only restriction.

21. A writing device that writes data delivered by a server through a network to a recordable medium, said writing device comprising:
a receptacle device that receives said recordable medium; and
a writer unit that writes said data in an area of storage areas of said recordable medium in which data is not written under a once only restriction.

22. (canceled)

23. A data acquisition method comprising:
a step of receiving data delivered by a server through a network; and
a step of writing said data as received to a recordable medium, wherein said writing step is performed under a once only restriction in an area of storage areas of said recordable medium in which data is not written yet.

24. A recordable medium to which the data delivered by the server through the network is written by the writing device as set forth in claim 21,
wherein a storage space of said recordable medium is divided into a predetermined number of storage areas, and
wherein the data is written under a once only restriction in a free area from among said predetermined number of storage areas.

25. A server that delivers data to be written to the recordable medium through a network,
wherein said data is delivered in units of a predetermined storage area of said recordable medium.

26. The content delivery system as claimed in claim 29, wherein said content is karaoke data, and said content using system is a karaoke playback system which plays back the karaoke data.

27. The content delivery system as claimed in claim 26 wherein said writer unit is implemented within said karaoke playback system, and said second proprietary interface serves also as said third proprietary interface.

28. (canceled)

29. A content delivery system comprising:
a memory cartridge having a first proprietary interface for accessing data contained therein;
a content using system which is distributed to a user of said content and provided with a second proprietary interface compatible with and connectable to said first proprietary interface of said memory cartridge for reading content therefrom and using the content;
a content server connected to the Internet and providing a content delivery service on the Internet; and
a writer having a data communication facility for downloading content from said content server through the Internet, provided with a third proprietary interface compatible with and connectable to said first proprietary interface, and configured to write the content to said memory cartridge.
